(19) United States
(12) Patent Application Publication
(10) Pub. No.: US 2026/0269927 A1
(43) Pub. Date: Sep. 10, 2026

(54) MESSAGE FORWARDING USING FLEXIBLE RELAY NODES

(71) Applicant: Fraunhofer-Gesellschaft zur Foerderung der angewandten Forschung e.V., Muenchen (DE)

(72) Inventors: Paul Simon Holt Leather, Berlin-Schlachtensee (DE); Thomas Haustein, Berlin (DE); Lars Thiele, Berlin (DE); Thomas Heyn, Erlangen (DE); Stefan Lipp, Erlangen (DE); Frank Burkhardt, Erlangen (DE); Julian Popp, Erlangen (DE)

(21) Appl. No.: 19/535,378

(22) Filed: Feb. 10, 2026

Related U.S. Application Data
(63) Continuation of application No. PCT/EP2024/072651, filed on Aug. 9, 2024.

(30) Foreign Application Priority Data
Aug. 10, 2023 (EP) 23190973.0

(51) Int. Cl. H04B 7/155

(52) U.S. Cl. CPC H04B 7/15507

(57) ABSTRACT

A control unit configured for controlling a transmitter device comprising a wireless interface to transmit a wireless signal with the wireless interface and towards a reflector to reflect the wireless signal along a path of the wireless signal, wherein the reflector is a part of a flying device.

### CROSS-REFERENCES TO RELATED APPLICATIONS

This application is a continuation of copending International Application No. PCT/EP2024/072651, filed Aug. 9, 2024, which is incorporated herein by reference in its entirety, and additionally claims priority from European Application No. EP 23 190 973.0, filed Aug. 10, 2023, which is incorporated herein by reference in its entirety.

### BACKGROUND OF THE INVENTION

Embodiments of the present application relate to the field of wireless communication, and more specifically, to relaying signals by selection of a path through a network.

In the following a first aspect underlying the present invention is described.

FIG. 1 is a schematic representation of an example of a terrestrial wireless network 100 including, as is shown in FIG. 1(a), a core network 10₂ and one or more radio access networks RAN₁, RAN₂, . . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station (also basestation), BS, refers to a gNB in 5G networks, an eNB in UMTS/LTE/LTE-A/LTE-A Pro, or just a BS in other mobile communication standards. A user may be a stationary device or a mobile device.

The network 100 may comprise one or more transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

The wireless communication system may also be accessed by mobile or stationary IoT devices which connect to a base station or to a user. The mobile devices or the IoT devices may include physical devices, ground-based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an example of five cells, however, the RANₙ may include more or fewer such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 10₂, e.g., via the S1 interface, via respective backhaul links 114₁ to 114₅, which are schematically represented in FIG. 1(b) by the arrows pointing to “core”. The core network 10₂ may be connected to one or more external networks. Furthermore, some or all of the respective base stations gNB₁ to gNB₅ may connected, e.g., via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI), respectively. For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (STTIs) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the terrestrial wireless networks describe above, non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station cannot provide sidelink resource allocation configuration or assistance for the UEs, and/or
may be connected to the base station that cannot support NR V2X services, e.g., GSM, UMTS, LTE base stations.

When considering two UEs directly communicating with each other over the sidelink, e.g., using the PC5 interface, one of the UEs may also be connected with a BS, and can thus relay information from the BS to the other UE via the sidelink interface. Such relaying can be performed in the same frequency band (in-band-relay) or another frequency band (out-of-band relay) can be used. In the first case, communication on the Uu and on the sidelink may be decoupled using different time slots as in time division duplex, TDD, systems.

FIG. 2a is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2b is a schematic representation of an out-of-coverage scenario in which the UEs directly communicating with each other are either not connected to a base station, although they can be physically within a cell of a wireless communication network, or some or all of the UEs directly communicating with each other are communicating with/connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2b which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2a, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each other, wherein the two UEs are connected to different base stations. The first base station gNB₁ has a coverage area that is schematically represented by the first circle 200₁, wherein the second station gNB₂ has a coverage area that is schematically represented by the second circle 200₂. The UEs directly communicating with each other include a first vehicle 202 and a second vehicle 204, wherein the first vehicle 202 is in the coverage area 2001 of the first base station gNB₁ and connected to the first base station gNB₁ via the Uu interface, wherein the second vehicle 204 is in the coverage area 2002 of the second base station gNB₂ and connected to the second base station gNB₂ via the Uu interface.

A scenario described herein may not only comprise nodes like base stations, UEs, IoT devices, but also transmission reception points, TRPs.

In a wireless communication system by way of non-limiting example such as described above, the relaying of messages in application scenarios prior to the invention being made was limited in range or coverage while at the application level, stringent requirements regarding QoS, latency, data rate and so on are to be met.

To increase a range along which a signal may be transmitted in a wireless communication network, relays may be used.

Known forms of relay communication include but not limited to:
Amplify and forward relays (repeater) (A & F);
Band switched amplify, and forward relays (bsA & F);
Decode and forward relays (D & F);
Digitize, amplify, and forward repeaters with and without decoding capabilities (dA & F); and
Decode, store and forward on demand relays (DS & F).

All these technical relaying concepts have specific features in common and/or have a distinct feature, and are usually deployed in wireless networks as network enhancements configured and controlled by network infrastructure. Such known solution is found to provide for insufficient by the inventor as providing only limited advantage.

There is, thus, a need to improve wireless communications.

It is noted that the information in the above section is only for enhancing the understanding of the background of the invention and therefore it may contain information that does not form conventional technology and is not yet known to a person of ordinary skill in the art.

### SUMMARY

An embodiment may have a control unit configured for controlling a transmitter device comprising a wireless interface to transmit a wireless signal with the wireless interface and towards a relay device to relay the wireless signal along a path of the wireless signal; wherein the relay device is a part of a non-stationary/moving device.

Another embodiment may have a control unit configured for determining at least a segment of an available, e.g., operated or configurable, path in a wireless communication network and for providing information along the path segment about relaying a wireless receive signal received by the relay device as a wireless transmit signal along the path segment.

Another embodiment may have a device, e.g., a base station, comprising a control unit according to one of previous claims, wherein the device is configured for communicating with a first number of first devices being in coverage of the device; and with a second number of second devices being out of coverage of the device by using a relay device to relay a wireless signal between the device and at least one of the second number of second devices and the device.

Another embodiment may have a device, comprising: a wireless interface for wirelessly transmitting a wireless signal; a control unit, configured for processing a schedule information related to a variable position of a relay device for relaying wireless signals; wherein the control unit is configured for controlling the wireless interface to transmit the wireless signal based on the schedule information to cause a relay of the wireless signal at the relay device.

Embodiments of the present invention are described in connection with three aspects, aspect 1 referring to a use of relays in a wireless communication network, in particular to determining possible paths within such a network and to selecting from available paths one or more paths for being used. In aspect 2 reference is made to mapping a signal received in a first domain representation to a signal to be transmitted in a second signal domain representation. In a third aspect the present invention relates to make use of a relay along a path or path segment by instructing the relay device. Such a relay device may include a device of active reception, e.g., including decoding, of a message. Further, the relay may generate and transmit a signal with a same message as the received signal or a message derived therefrom. In one embodiment, the relay device may be or may comprise a reconfigurable intelligent surface, RIS, that may allow for relaying a signal by reflecting an incoming signal as an outgoing or reflected signal. In a variation of the third aspect, a control unit may make use of information about a path segment being provided by a reflector, e.g., as a part of a RIS, mounted to a non-stationary or moving, e.g., flying, device to allow directing the signal to be relayed to the reflector, thereby possibly using the reflector without controlling it.

### BRIEF DESCRIPTION OF THE DRAWINGS

Embodiments of the present invention will be detailed subsequently referring to the appended drawings, in which:

FIG. 1 shows a schematic representation of an example of a wireless communication system related to aspect 1, aspect 2 and aspect 3;

FIG. 2a is a schematic representation of an in-coverage scenario in which UEs directly communicating with each other are connected to a base station related to aspect 1, aspect 2 and aspect 3;

FIG. 2b is a schematic representation of an out-of-coverage scenario in which UEs directly communicating with each other receive no SL resource allocation configuration or assistance from a base station related to aspect 1, aspect 2 and aspect 3;

FIG. 3 is a schematic representation of a partial out-of-coverage scenario in which some of the UEs directly communicating with each other receive no SL resource allocation configuration or assistance from a base station related to aspect 1, aspect 2 and aspect 3;

FIG. 4 is a schematic representation of an in-coverage scenario in which UEs directly communicating with each other are connected to different base stations related to aspect 1, aspect 2 and aspect 3;

FIG. 5 is a schematic representation of a wireless communication system comprising a transceiver, like a base station or a relay, and a plurality of communication devices, like UEs, according to an embodiment related to aspect 1, aspect 2 and aspect 3;

FIG. 6 shows a schematic block diagram of a relay device according to an embodiment of aspect 1;

FIGS. 7a-e show configurations of devices in accordance with embodiments, having a single antenna being used for a reception and a single antenna being use for transmission or a single antenna being used for both reception and transmission through the use of a duplex filter according to an embodiment of aspect 1;

FIG. 7f shows a schematic block diagram of a relay device according to an embodiment of aspect 1; having an antenna array;

FIG. 7g shows a schematic block diagram of a relay device according to an embodiment of aspect 1 comprising a signal processing;

FIG. 8 shows a schematic block diagram of a flexible array in accordance with an embodiment of aspect 1, which may implement some or all of the functionality of relay devices described herein;

FIG. 9a-h show schematic block diagrams of network topologies according to embodiments of aspect 1;

FIG. 9i shows a summarizing table of the topologies of FIGS. 9a-h;

FIG. 10a-d show different conceptual representations of a control plane and a user plane connection between a UE and a gNB via relays according to an embodiment of aspect 1;

FIG. 11a-c present a UE-centric point of view in accordance with embodiments of aspect 1 described herein;

FIG. 12a-c show schematic block diagrams of wireless communication networks according to embodiments of aspect 1;

FIG. 13 a schematic representation of a wireless communication network according to an embodiment of aspect 2 having a relay device;

FIG. 14a-b schematic representations of a wireless communication network to an embodiment of aspect 2 in uplink and downlink to illustrate a FDD/TDD conversion of relayed signals;

FIG. 15a-b schematic representations of a wireless communication network to an embodiment of aspect 2 in uplink and downlink to illustrate a FDD/TDD conversion of relayed signals comprising a restructuring of signals;

FIG. 16a-b schematic representations of a wireless communication network to an embodiment of aspect 2 in uplink and downlink to illustrate a coordinated use of a plurality of relay devices;

FIG. 17a-b schematic representations of a wireless communication network to an embodiment of aspect 2 in uplink and downlink to illustrate a coordinated use of a plurality of relay devices that only forward a part of a received signal;

FIG. 18a-b schematic representations of a wireless communication network to an embodiment of aspect 2 in uplink and downlink to illustrate a coordinated use of a plurality of relay devices that implement spatial streams for forwarding signals;

FIG. 19a-b show schematic block diagrams of a wireless communication network adapted for providing relaying services according to embodiments of the third aspect;

FIG. 20a-e show schematic block diagrams of wireless communication networks for further illustrations of path options according to embodiments of the third aspect;

FIG. 21 shows a schematic flow chart of a method for operating a transceiver, according to an embodiment of the third aspect;

FIG. 22 shows a schematic flow chart of a method for providing selection information according to an embodiment of the third aspect; and

FIG. 23 shows a schematic diagram of a wireless communication according to an embodiment of the third aspect, comprising a reflector mounted to a flying device;

FIG. 24 shows a schematic diagram of a wireless communication according to an embodiment of the third aspect, comprising a reflector for relaying signals between base stations and different remote areas;

FIG. 25 shows a schematic diagram of a reflector device according to an embodiment of the third aspect;

FIG. 26 shows a schematic block diagram illustrating frequency use schemes that may be used in embodiments of the third aspect;

FIG. 27 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

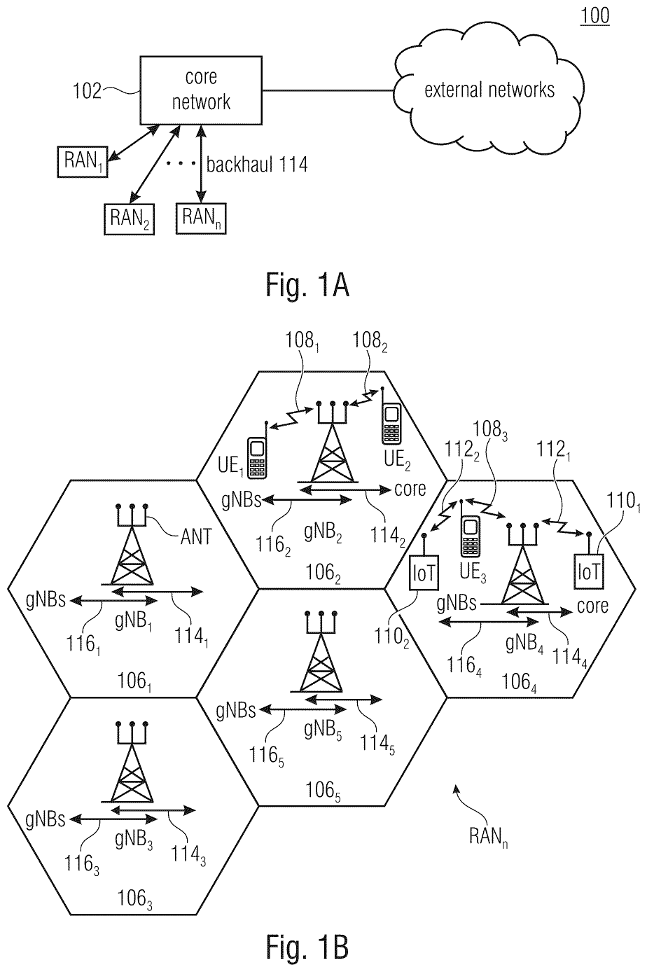

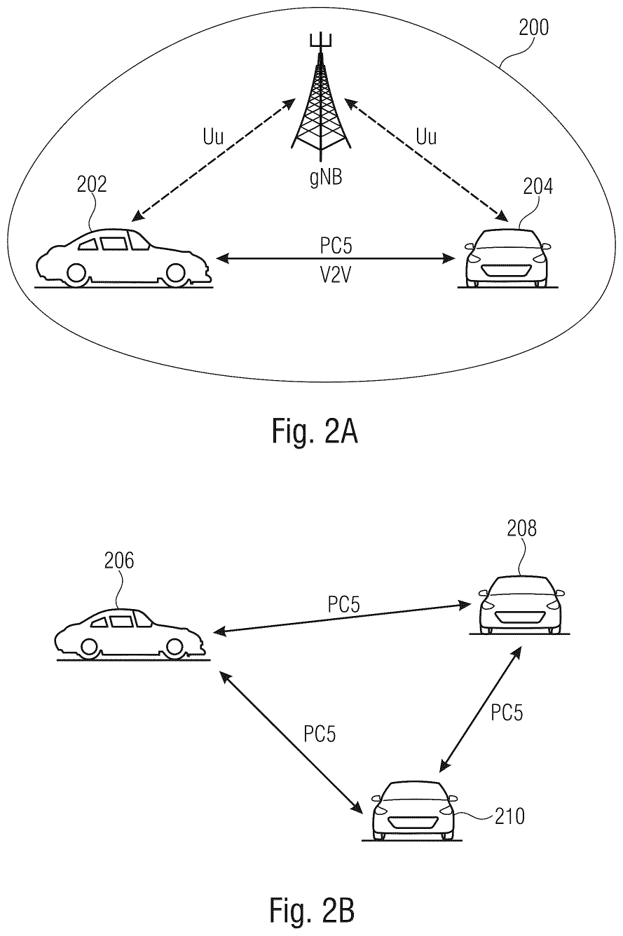

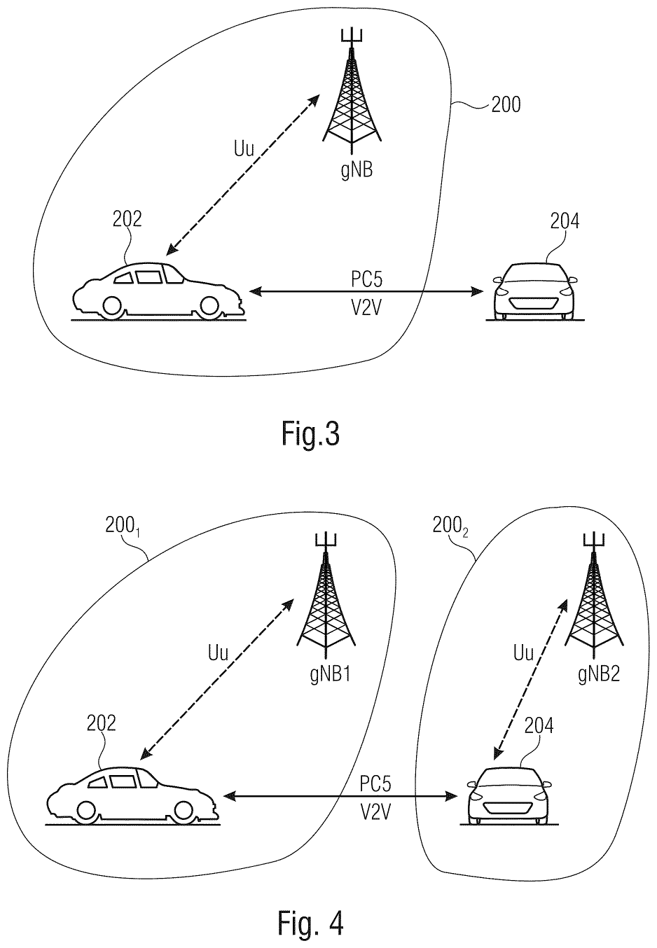

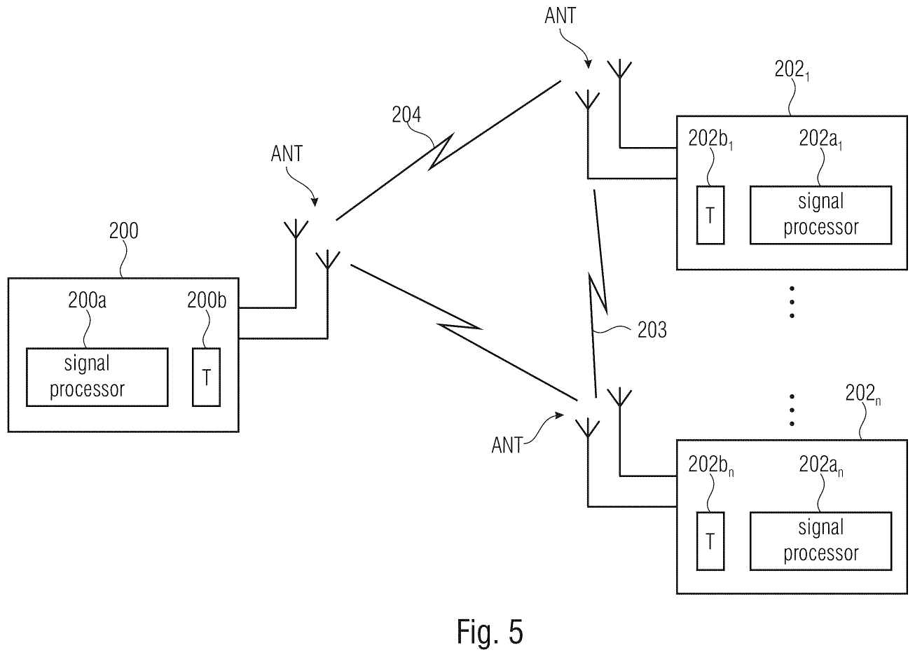

Embodiments of the present invention may be implemented in a wireless communication system or network as depicted in FIGS. 1 to 4 including a transceiver, like a base station, gNB, or relay, and a plurality of communication devices, like user equipment's, UEs. FIG. 5 is a schematic representation of a wireless communication system comprising a transceiver 200, like a base station a transmission reception point, TRP, or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b1 to 202bₙ. The base station 200 and/or the one or more UEs 202 may operate in accordance with the inventive teachings described herein.

The inventors have identified a problem in known relaying strategies that relates to topological and/or deployment immanent deficiencies. Embodiments described herein provide technical means to overcome these by introducing a novel, flexible and effective relaying scheme method.

An overcome topological deficiency can be considered in the following example. A multi-hop relaying string provides wireless connectivity between two ends of a link that otherwise would be out of coverage. However, the end-to-end (E2E) latency requirements and the sensitivity to retransmission delays caused by the standard 5G-NR TDD frame structure and H-ARQ retransmission scheme do not permit multi-hop connections since the 5G-NR design space is constrained to communication links with one hop. To date, latency reduction methods over multiple hops have not been implemented in 3GPP and therefore no solutions have been proposed and standardized.

Currently implemented or standardized solutions in 3GPP focus either on network-controlled repeaters, integrated access and backhaul (IAB) nodes, remote sidelink relays or LTE relays. In common to all of these relay types is: a) that the number of hops shall be limited to one and; b) that the relay scheme (including the one or more relays) is considered to be transparent to the user equipment (UE) at least for IAB, while in sidelink relaying the UEs are aware of the relay and have a sidelink connection to the relay in addition to the E2E.

Thus far, flexible relay configuration—and in particular, that associated with the required performance of a given E2E link—has only been discussed in the context of remote UE relaying in sidelink communication, wherein the relay is configured to relay messages from a UE to the base station if the same (remote) UE cannot communicate with the base station directly or for reliability throughput enhancements.

To frame a problem solved by the embodiments described herein, it is assumed that mission critical messages should be exchanged between at least two nodes, wherein a direct communication between the two nodes is possibly a) not feasible and/or; b) the conditions of the link do not satisfy the requirements of one or more key-performance indicators (KPIs), e.g. data throughput, latency, link reliability, stability, jitter. Other motivation to use a relay for forwarding is, however, not precluded according to the invention.

Furthermore, it is assumed that other nodes are within the communication range of each of the two nodes or in a concatenated multi-hop topology to link the two nodes into a communication chain, thus acting as relays or message forwarders between the two nodes.

Embodiments provide for flexible and configurable combinations of such relay operational modes. Embodiments provide for a relaying device which is adapted on demand to the given application scenario and can be configured to operate in at least one or more of the operational modes listed above or any combination thereof. The configuration and the management of the operational mode can be initiated and/or controlled by the network (gNB), the UE or the relay in a distributed, centralized, hierarchical, assisted and/or autonomous manner. An autonomous control mechanism may include a reporting of suitable relay candidates by one end of the E2E link or intermediaries thus allowing such a candidate to be selected, configured and its operational mode controlled by a designated controlling entity or after a negotiating process between several entities involved in the relaying process and/or benefiting from the relaying process.

Embodiments thereby overcome the inherent limitations in current relaying schemes including but not limited to:
fixed IAB relays and vehicle mounted relays;
layer 3 relays such as Wi-Fi hotspots using smartphones;
sidelink relaying;
network controlled repeaters;
single hop relays specified in 4G-LTE; and
(non)-regenerative relays deployed in space (satellites).

Embodiments provide an end-to-end link-based solution approach, wherein the intended, e.g., determined as optimal, configuration and operation of the relay nodes ensures significant performance improvement of the E2E link.

In the following, several aspects relating to the embodiments of the first aspect are described to specify the concept of a network node with flexible forwarding capabilities (i.e., operational modes). Described herein is a conceptual development of the arrangement of the functional blocks used to create a flexible relay; examples of the organization of such flexible relays within a network topology; and an introduction to the states and timing associated with the discovery, configuration, connection and release of the various network entities. Also the benefits of the embodiments is described.

It is assumed that the network topology providing a background for at least some of the embodiments is of a cellular structure with at least one base station (eNB in 4G LTE, gNB in 5G NR) and at least one mobile terminal (user equipment, UE in 5GNR, “terminal” in ETSI DECT, or “terminal” in IEEE 802.11xx) forming a wireless communication system/network using wireless communication between the base station and the mobile terminal.

Classical relaying in cellular networks is based on the configuration of particular devices as relays. After configuration, these devices can forward messages to a further device in single hop manner.

To allow a more scalable solution, some of the embodiments are directed to include, by the sending device and/or a relay device relaying the message, a header message into data packages/messages to be relayed within the network which contains self-describing instructions and/or parameters allowing suitably-enabled or capable devices in the network to handle and forward such messages in the appropriate manner.

An intelligent relaying method proposed by some embodiments described herein uses a target header to facilitate directed forwarding in a multi-hop network. Knowledge of the intended recipient is beneficial for relay node selection and directional forwarding. Examples of this include the explicit destination per se and the routing table or fields to be used and defined. The method is extendable for multiple hops through the use of tree-type and/or meshed relay network topologies not limited to include hop counters and/or unambiguous packet identifiers which are used to avoid routing loops and/or packet forwarding beyond expiry.

Furthermore, it is assumed that a further node may be introduced to facilitate the forwarding of messages sent into at least one of the bidirectional communication directions (uplink and/or downlink).

The assumed channel duplexing for this invention disclosure is time division duplex (TDD), not excluding frequency division duplex (FDD) or full duplex (FD) channel access for the sharing of downlink/uplink resources.

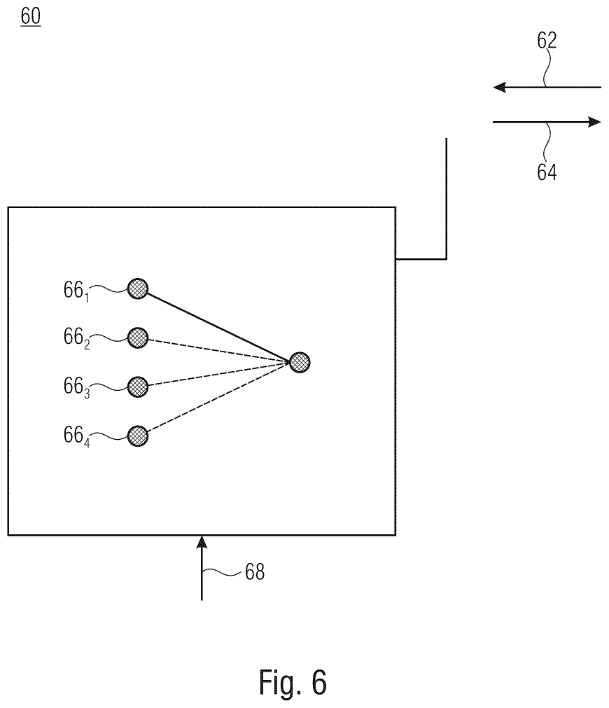

FIG. 6 shows a schematic block diagram of a relay device 60 according to an embodiment. The relay device 60 may be operated in a wireless communication network described herein. The relay device 60 is configured for relaying a wireless receive signal 62 as a wireless transmit signal 64. The relay device 60 is configured for a plurality of at least two relay modes indicated by bullets 661 to 664. The relay device 60 is adapted for changing an operation of the relay device 60 to at least one of the plurality of relay modes responsive to a control signal 68. The control signal 68 may be determined internally, e.g., when internally determining a need to maintain or a change the operation mode. Such an evaluation may be made when evaluating, e.g., capabilities of a node transmitting the wireless receive signal 62 and/or of a node to receive the wireless transmit signal 64. Alternatively or in addition, the relay device may be configured for receiving the control signal from an external device, e.g., a coordinating entity, a node transmitting the wireless receive signal 62 and/or of a node to receive the wireless transmit signal 64. The control signal may be an independent signal but by also be included into a different signal such as the wireless receive signal 62.

The operation modes that the relay device may support may include one or more of the following modes. Embodiments enable comprises a flexible relay in the sense that it is equipped to operate in different operational modes. These modes are not limited to include the following nor any combination thereof:

A & F operational mode: Digitizes signal (ADC) behind Rx antennas followed by receive RF chain, optionally filtering and or precoding (spatial) and forwarding to a transmitter (DAC, Tx-RF chain) and Tx antennas, which are preferably different (and signal wise sufficiently isolated from Rx antennas) transmitting the received signal again within a short time e.g. the guard interval. This allows forwarding with minimum delay, de facto a slightly delayed version of the original message, preferably within or a small portion of the guard interval of, e.g. an OFDM symbol used by the communication protocol. Such an operation mode may correspond to a repeater (digital A & F) functionality performed by the network node.

Band switched amplify, and forwarding operational mode (bsA & F): Digitizes signal (ADC) behind Rx antennas followed by receive RF chain, optionally filtering and or precoding (spatial) and forwarding to a transmitter (DAC, Tx-RF chain and Tx antennas operated at a different band of bandwidth part (BWP), and with antennas preferably different (and signal wise sufficiently isolated from Rx antennas) transmitting the received signal again within a short time e. g., the guard interval. This allows forwarding with minimum delay, de facto a slightly delayed version of the original message, preferably within or a small portion of the guard interval of, e.g. an OFDM symbol used by the communication protocol and an independent redundancy copy of the same message in another frequency band, this increasing spectral redundancy of the message. This scheme allows the next receiver in the multi-hop chain to process a message from the previous transmitter in the chain and the bsA & F relay in parallel using to independent copies of the same message made available on different frequency resources Such an operation mode may correspond to a repeater (digital band switched A & F) functionality performed by the network node. It is to be noted that a band switch may relate to change a frequency range or frequency band, e.g., within a same radio access technology, RAN such as using an RF signal. According to an embodiment, the band may also be switched to change the properties of the signal, e.g., to use a combination of an optical signal and an RF signal for the combination of signals 62 and 64.

Digitise and Forward (D & F) operational mode: Digitizes signal (ADC) behind Rx antennas followed by receive RF chain, optionally filtering, decoding, storing/buffering and/or precoding (spatial) and selectively or in full forwarding the message to a transmitter (DAC, Tx-RF chain and Tx antennas). Tx antennas can be the same or different as receive antennas. The transmission of the message is delayed until time instances (slots) which are defined to be used for the opposite communication direction, in U slots if the message was receive during D slots. This allows forwarding with a well-defined delay depending on the chosen D and/or U slots, thus introducing a deterministic delay of a distinct number of slots into the E2E communication chain, due to its relaying structure. Furthermore, the relaying after decoding can include a different encoding and/or mapping on physical resources in the WCS. Such an operation mode may correspond to a classical decode and forward (C & F) functionality performed by the network node.

Store and Forward (S & F) operational mode: Digitizes signal (ADC) behind Rx antennas followed by receive RF chain, optionally filtering, decoding, storing/buffering and/or precoding (spatial) and selectively or in full forwarding the message to a transmitter (DAC, Tx-RF chain and Tx antennas). Tx antennas can be the same or different as receive antennas. The transmission of the message is delayed to later time instances (slots) and only executed on demand and triggered by a kind of H-ARQ command, requesting a retransmission in case the next receiver in the multi-hop chain was unable to successfully decode the message which was either received by the transmitter before the relay, by the relay itself of as a combination of messages of the two transmitters. Such retransmission from half-way nodes in a multi-hop system allow faster provision of retransmissions and avoid H-ARQ requests to go back to the original source as it happens with higher layer mechanisms like TCP. This allows provision of retransmission of undetected messages with a well-defined delay depending on the chosen D and/or U slots, thus introducing a deterministic delay of a distinct number of slots into the end-to-end (E2E) communication chain, due to its relaying structure Such an operation mode may correspond to a retransmissions using triggered store and forward relay functionality performed by the network node. Such retransmission schemes can exploit feedback information regarding specific redundancy versions being requested. Examples of redundancy versions include but are not limited to:
Incremental redundancy (extra parity bits transmitted);
Bits mapped to specific layers, e.g. MIMO are requested for one or a few of the layers;
Repetition coding with chase combining;
Redundancy provision distributed across multiple relays (each relay is sending different or same parts of the retransmission message, encoding can be the same of different, furthermore, the encoding can be coordinated, e.g. like in network coding);
UE-2-UE communication or UE-2-gNB communication wherein some UEs operate at least partially as relays; and
Transmit/receive in different frequency bands e.g. FR1 and FR2 over multiple relays, i.e. multi-band combining.

Monitoring operational mode: Digitizes signals and monitors and logs KPIs, events related to links to neighbouring nodes and or a further node one or more hops away. Log files can be reported automatically or on demand. The purpose of this mode is to determine, for example, link quality or degradation patterns, that allow further optimization of the partial links and/or the overall E2E link. These could include mechanisms such as MDR but in distributed and self-organized way and time stamped. Such a mode may be provided or executed by the relay device in combination with a relay mode, e.g., to internally determine the control signal 68 and/or to provide information to other nodes as a basis for decisions made there.

Combinations of the different relaying mode described herein may be applied to provide a flexible and efficient solution for improved E2E wireless communication using multi-hop techniques exploiting the different relaying functionalities of the relaying node by adaptively and flexibly configuring such combinations by either end of the E2E link (UE or gNB) or by one of the relaying nodes in between.

For example, a network node may receive a signal from a transmitting node in a first mode of a TDD slot structure, e.g. DDDDFUUUDD (D: Downlink slot, F: Flexible slot, U: Uplink slot) and may transmit in a different second mode of a TDD slot structure.

As an alternative or in combination, the combination of several relaying modes may facilitate an adaptation of multi-hop communication links with even or odd numbers of nodes to shorter E2E latencies, e.g. round-trip times (RTT) even under TDD constraints which is the most common access scheme in 5G-NR while 4G-LTE was predominately deployed with FDD as Duplexing scheme. Such operation may allow to forward or relay a signal in the wireless communication network along a plurality of hops by use of more than a single relay mode, e.g., based on relay devices operating differently.

According to an embodiment, the relay device 60 may operate, as relay modes, at least a subset of:
an amplify and forward mode;
a band switch amplify and forward mode, including a change of signal type such as optical and RF;
a decode and forward mode;
a store and forward mode.

The relay device 60 may be adapted to operate in a wireless communication network; and may be configured for receiving the wireless receive signal from a user equipment of the wireless communication network; and/or for transmitting the wireless transmit signal to a user equipment of the wireless communication network. However, the relay may also transmit the signal to a further relay or receive signals from a further relay. In combination with the capability of the relay modes descried herein, the relay device 60 may be configured, at least in some modes, to operate as a splitter to divide a set of at least one wireless receive signal into a set of wireless transmit signals, the number of transmit signals being larger than the number in the set of wireless receive signals. Alternatively or in addition, the relay device 60 may operate as a combiner to combine a set of at least two wireless receive signals into a set of wireless transmit signals, the number of transmit signals being lower than the number in the set of wireless receive signals. When combining both modes, the number of signals may also stay same.

Embodiments refer to a conceptual and graphical development of the functional blocks used to implement a flexible relay together with an example on how they can be arranged.

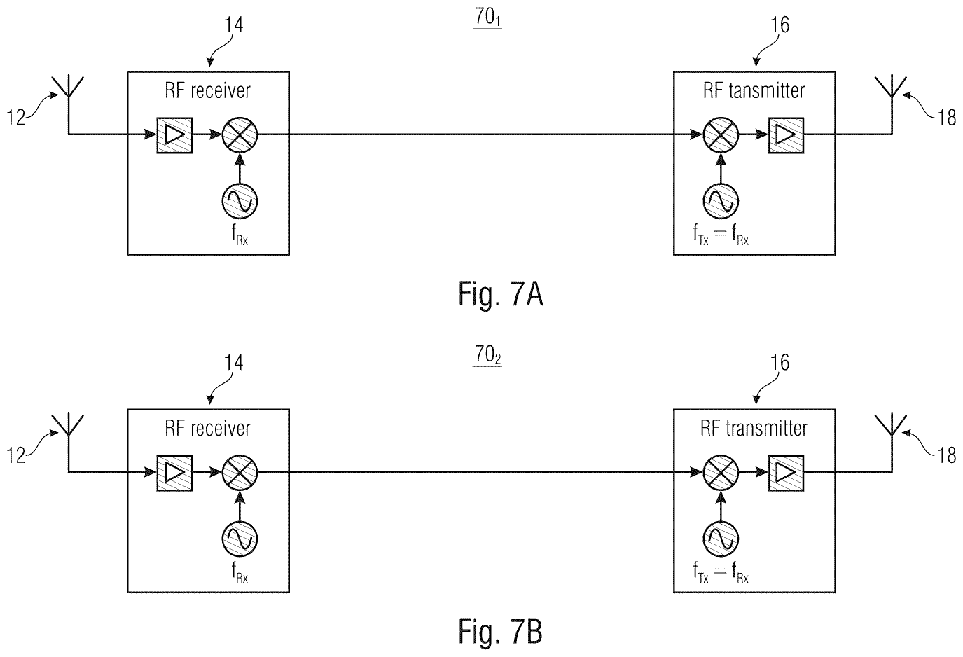

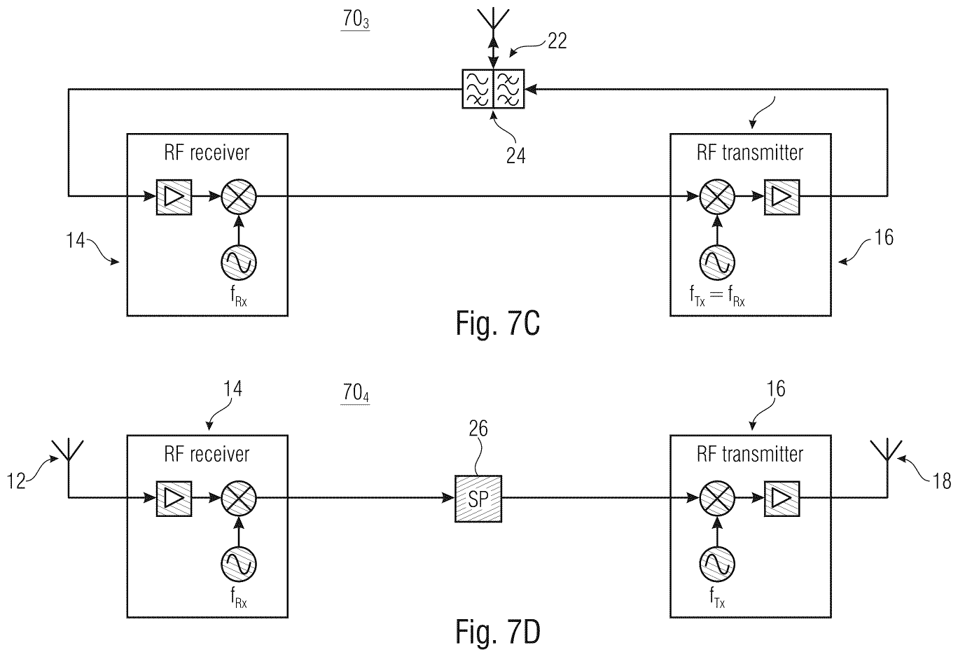

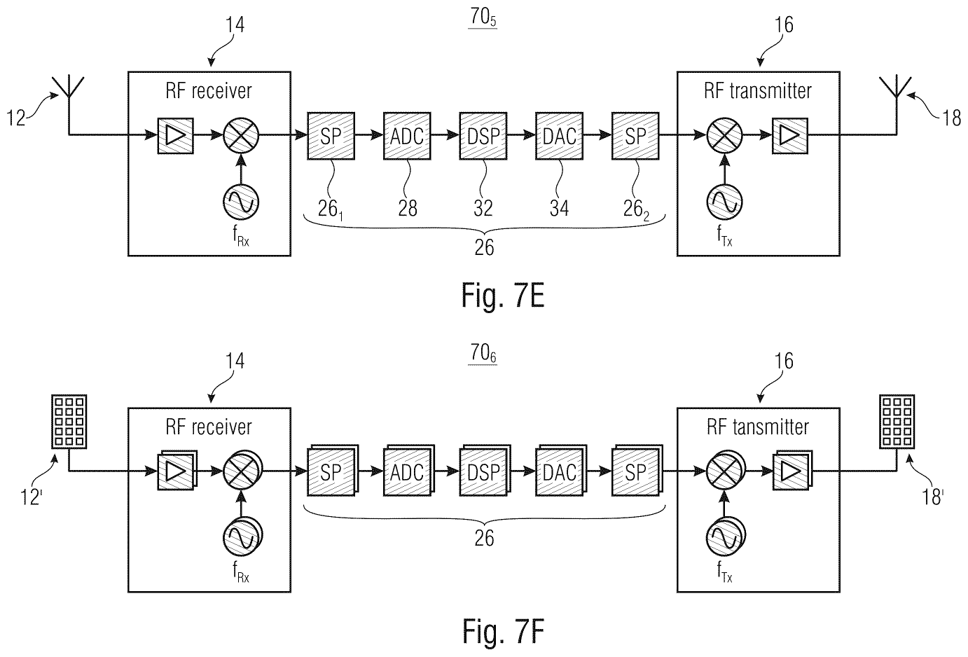

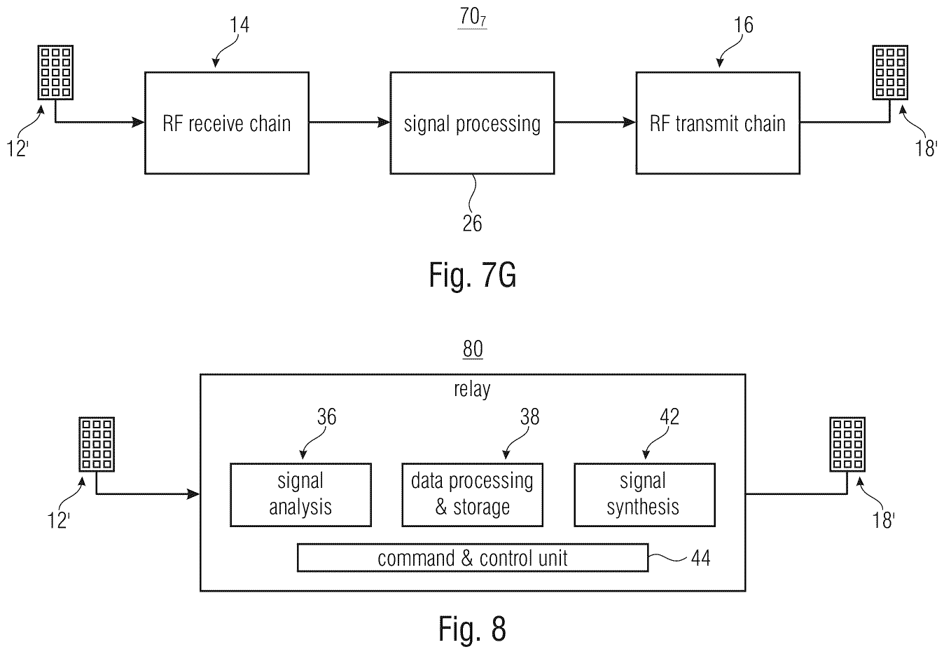

FIG. 7a shows a schematic block diagram of a relay device 70₁ to illustrate the conceptual arrangement of a receiving antenna 12 followed by an RF receiver 14 which is directly or indirectly connected to an RF transmitter 16 followed by a transmitting antenna 18. The RF receiver 14 and the RF transmitter 16 may operate in a same frequency band, e.g., f_{TX}=f_{RX}, and each uses a separate antenna 12, 18 respectively.

In practice, a self-interference shared by the transmitter 16 and which is passed to the receiver 14 can be reduced by careful arrangement of the antennas 12 and 18. For example, spacing them apart and/or arranging them so that the peaks of their radiation patterns are not overlapping significantly, e.g., their beams point into different directions. FIG. 7a illustrates the concept of an amplify and forward relay 70₁ in which the received signal is amplified and forwarded.

FIG. 7b shows a schematic block diagram of a relay device 702, an operation thereof being implementable in the relay device 60 as is the functionality of the relay device 701. When compared to the relay device 701, the RF receiver 14 and the RF transmitter 16 may operate in different frequency bands, i.e., f_{TX}≠f_{RX}.

FIG. 7c shows a schematic block diagram of a relay device 703, an operation thereof may be implemented in the relay device 60. The relay device 703 may use a common or shared antenna 22 connected to the receiver 14 and the transmitter 16 via a duplex filter 24. Signal isolation between the frequency ranges used for reception and transmission may be dependent on the duplex distance between these ranges and the filter characteristics of the duplexer.

FIG. 7d shows a schematic block diagram of a relay device 704 that may be implemented as operation mode in the relay device 60. When compared to FIGS. 7a-c that have shown for reasons of simplifications a direct connection from the output of the RF receiver 14 to the input of the RF transmitter 16, in practice, it may be more realistic to place a signal processing stage 26 between the receiver 14 and the transmitter 16. The signal processing 26 is shown in FIG. 7d that introduces the concept of a signal processing (SP) block being placed between the output of the RF receiver 14 and the input of the RF transmitter 16. In general, the SP block 26 may be used to represent any form of signal processing, analogue, digital or combinations thereof.

FIG. 7e shows a schematic block diagram of a relay device 705, a functionality thereof forming a possible relay mode of the relay device 60. The relay device 705 comprises a combination of inter-RF stages comprised of a first stage of signal processing 261, e.g., in an analogue way, a digitizer 28, an analogue-to-digital-conversion, ADC, a digital signal processing, DSP, block 32, a signal reconstructor in the form of a digital-to-analogue converter, DAC 34 followed by a second stage of analogue signal processing 262. The DSP 32 functions are not limited to include re-synchronization, re-mapping of resource elements, re-modulation of signals, re-interleaving of symbols, re-coding of data, re-direction of packets, data storage, data retrieval and/or data estimation.

FIGS. 7a-7e show a single antenna being used for a reception and a single antenna being use for transmission or a single antenna being used for both reception and transmission through the use of a duplex filter. It is also a possible implementation in accordance with embodiments to provide for a relay comprised of one or more directional antennas which are also directable through the use of mechanical and/or electronic means, for example, using at least one array of antenna elements together with at least one beam forming device. A concept of such a device is shown in FIG. 7f illustrating a block diagram of a relay device 706, a functionality thereof being implementable in the relay device 60. A receive antenna 12′ of the relay device 706 may comprise an antenna array. Alternatively or in addition, the relay device 706 may comprise a transmit antenna 18′ comprising a transmit antenna array. The signal processing 26 may be adapted to operate the multiple antennas of each of the antenna array 12′ and the antenna array 18′.

FIG. 7g shows a schematic block diagram of a relay device 707 representing at least the relay devices 704 to 706. The relay device 707 may comprise a receive antenna 12′ and a transmit antenna array 18′ being connected to RF receive chains of the receiver 14, RF transmit chains of the transmitter 16 respectively which may be connected to each other via signal processing 26.

FIG. 8 shows a schematic block diagram of a flexible array 80 in accordance with an embodiment, which may implement some or all of the functionality of the relay devices 60 and 701 to 707.

The relay device 80 may comprise the receive antenna array 12′ and/or the transmit antenna array 18′, wherein a combined implementation as described in connection with FIG. 7c is not precluded. The relay device 80 may comprise units or functions for signal analysis 36, data processing and/or data storage 38 and signal synthesis 42. These units may be responsive to instructions, commands and/or requests passed to them from a command and control unit 44 of the relay device 80 that may process or even generate a control signal such as control signal 68. The command and control unit 44 may operate autonomously, i.e., it may make decisions based on criteria and/or observations, sequentially, i.e., it may perform certain actions in a certain order, it may operate functionally, i.e., it may form outputs based on inputs, it may operate adaptively, i.e., it may adjust a setting according to observations, it may operate programmatically, i.e., it may receive commands, requests or instructions from another network entity such as a UE, a gNB or from other relays, and any full or partial combinations thereof.

In view of this, embodiments provide for a relay device that may be configured for receiving a control signal indicating a relay mode or a combination of relay modes; and for operating according to the control signal.

A relay device according to an embodiment may comprise an antenna unit configured for beamforming; wherein the relay device is adapted to receive and/or transmit wireless signals using a beamforming technique and using the antenna unit.

A relay device according to an embodiment may comprise an antenna unit and an actuator; wherein the actuator is configured for changing an orientation of the antenna unit to change a direction and/or polarisation of a signal received or transmitted with the antenna unit with reference to a further device.

A relay device according to an embodiment may comprise a control unit or command and control unit 44; configured for controlling an operation of the relay device.

A relay device according to an embodiment may be adapted that the control unit is configured for controlling the relay device:
autonomously;
sequentially;
adaptively;
programmatically; and
any full or partial combinations thereof.

A relay device according to an embodiment may be implemented as a UE, a gNB, an RU, a DU, a CU, an IAB-node such as an IAB-DU or an IAB-MT), a repeater, a relay-node, a RIS or any other node or device which supports reception and transmission of wireless signals.

A relay device according to an embodiment may be configured for receiving a request for relaying a signal from a first device such as a user equipment, UE, or another relay device to a second device such as a basestation or another relay device; wherein the relay device is configured to negotiate a parameter of a first connection between the relay device and the first device with the first device; and/or configured to negotiate a parameter of a second connection between the relay device and the second device with the second device to establish at least a part of a relayed connection between the first device and the second device.

A relay device according to an embodiment may be configured for receiving a connection information from the wireless communication network, e.g., a deciding entity thereof, the connection information indicating a parameter of a connection of the relay device to another device; wherein the relay device is configured for controlling the connection based on the connection information. That is, the relay is possibly not directly connected to the gNB, e.g. another relay could be in-between. The same is true for the relay to be at least one further hop away from the UE.

A relay device according to an embodiment may be configured for providing, to the wireless communication network, at least one of an input, a parameter, a report and a feedback message to provide information to a deciding entity of the wireless communication network for a decision about a parameter of a connection of the relay device.

A relay device according to an embodiment may be configured for signalling to the wireless communication network a configurability information indicating that the relay device will operate according to a connection information received from the wireless communication network that indicates a requested parameter of a connection of the relay device; and/or indicating that the relay device will forward connection information to a device indicated in the connection information.

In the following, some examples of relay-equip network topology concepts are explained. To begin with, attention is drawn to the controlled plane, CP, and user plane, UP, functions of the wireless communication link wherefore it should be noted that UP and CP can at least one of using different RF chains, employing different antenna beams or antenna ports and/or operating in different frequency ranges. For example, CP can be communication via FR1 while UP can be transferred over FR2. This does not exclude both CP and UP being conveyed in the same frequency range nor in the same combination of frequency ranges.

Similarly, the CP and UP can be assigned to FDD and/or TDD operation and combinations thereof. Likewise, the different planes can be transferred using different and/or similar waveforms, numerologies, resource element assignments, modulation and coding schemes, e.g., in view of data rates, spatial layers, polarizations, scheduling and the like.

The mode of operation of the relay may be configured or pre-configured and/or adapted for the same mode or for a different mode when relaying CP or UP.

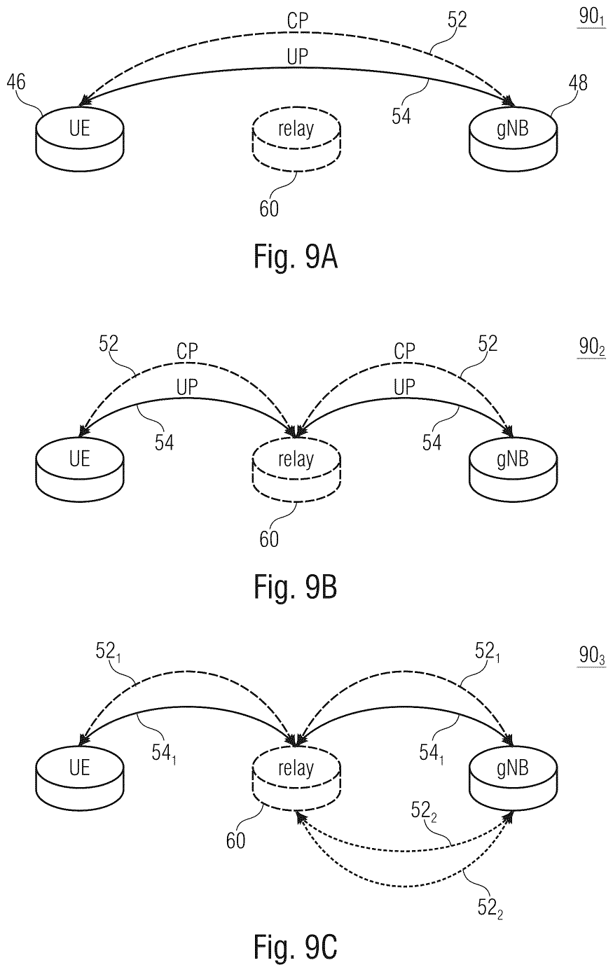

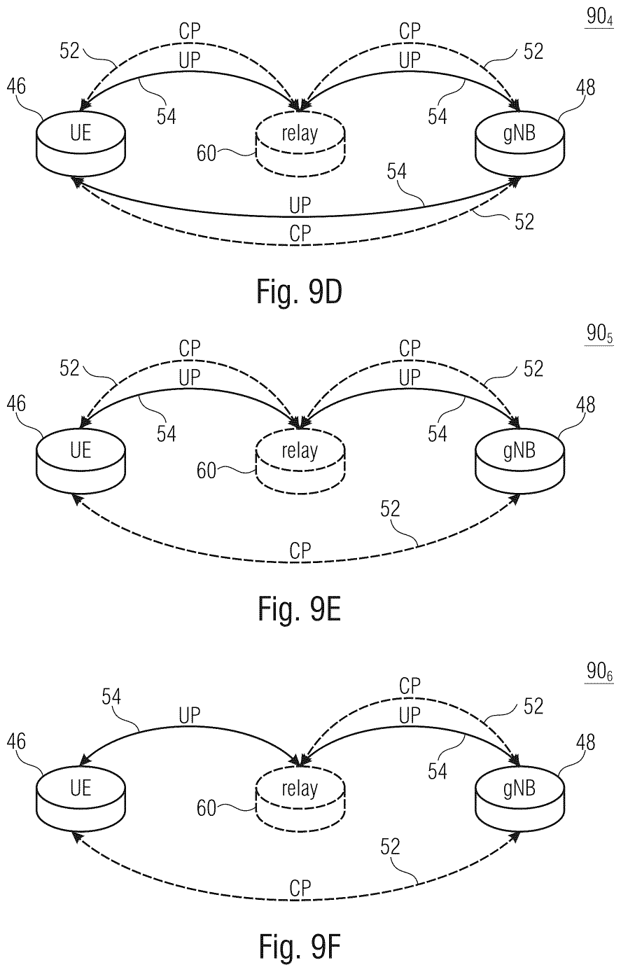

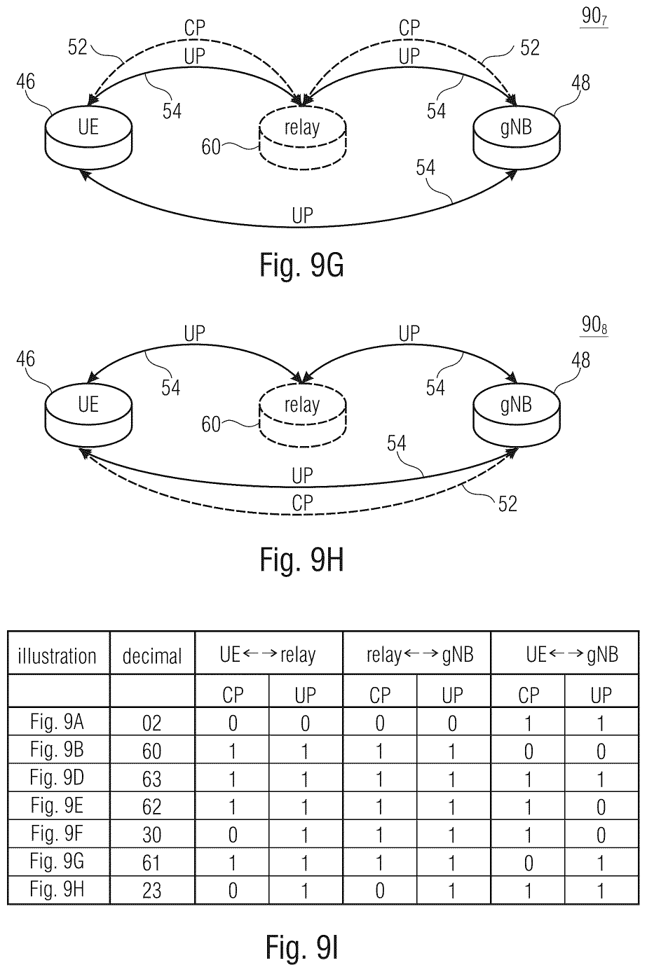

FIG. 9a shows a schematic block diagram of a network topology 901 according to an embodiment in which a UE 46 and a base station, gNB 48, e.g., a UE and a gNB of network 100, are directly connected to allow a connection of CP 52 and UP 54 without using relay device 60 which can also be relay device 80.

FIG. 9b shows a schematic block diagram of a network topology 902 according to an embodiment in which the connection of CP 52 and UP 54 between the UE 46 and the gNB 48 is provided via the relay device 60.

FIG. 9c shows a schematic block diagram of a network topology 903 according to an embodiment in which a duality of the CP and UP is highlighted. A first CP 521 is used for gNB control of the UE 46 and a second CP 522 is used for gNB control of the relay device 60. A first UP 541 is used for the transfer of data between the UE 46 and the gNB 48 and a second UP 542 is used for the transfer of data between the gNB 48 and the relay 60. Although not shown in each figure, such a split may be provided in other embodiments described herein.

FIG. 9d shows a schematic block diagram of a network topology 904 according to an embodiment where the control plane 52 and the user plane 54 connection between the UE 46 and the gNB 48 is enabled directly and via the relay device 60.

FIG. 9e shows a schematic block diagram of a network topology 905 according to an embodiment where the control plane 52 and the user plane 45 connections between the UE 46 and the gNB 48 are provided both directly and via a relay in which however there is no direct UP connection between the UE 46 and the gNB 48.

FIG. 9f shows a schematic block diagram of a network topology according to an embodiment where the CP connection between the gNB 48 and the UE 46 and between the gNB 48 and the relay device 60 is provided. The UP connection from the gNB 48 to the UE 46 is made via the relay device 60.

FIG. 9g shows a schematic block diagram of a network topology 907 according to an embodiment where the CP and UP connection is between the UE 46 and the gNB 48, both directly and via a relay device 60 in which however there is no direct CP connection between the UE 46 and the gNB 48.

FIG. 9h shows a schematic block diagram of a network typology 908 according to an embodiment, where the CP and UP connection between the UE 46 and gNB 48 are both directly and via a relay in which however there is no CP connection via the relay device 60.

FIGS. 9a-h present different scenarios that are summarized in FIG. 9i from which is should be noted that additional connection permutations are possible. The table presented in FIG. 9a uses a binary or Boolean notation to show connections, where a zero/0 represents no connection and a “1” represents a connection, thus allowing a decimal representation of these states.

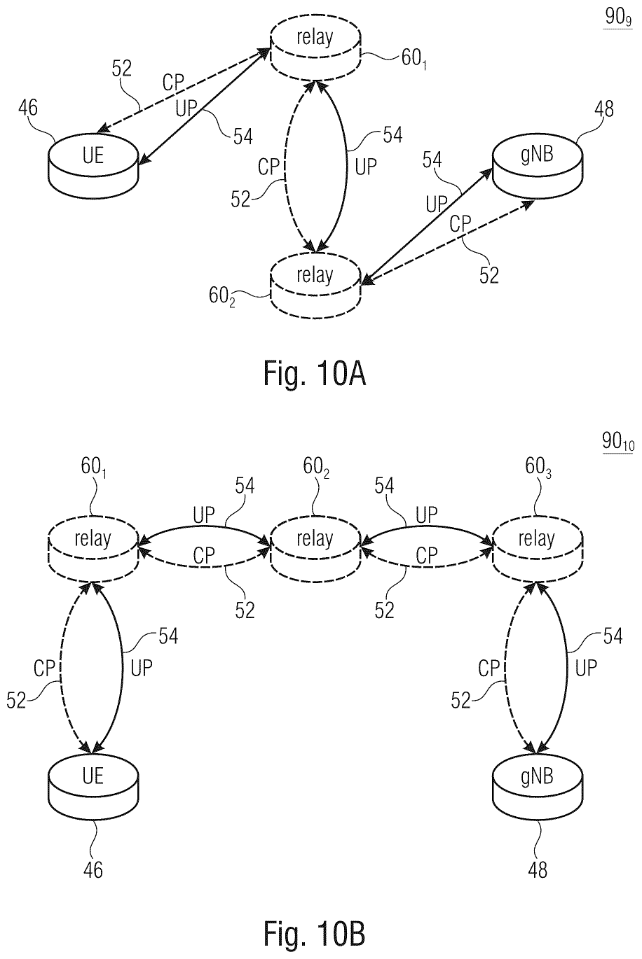

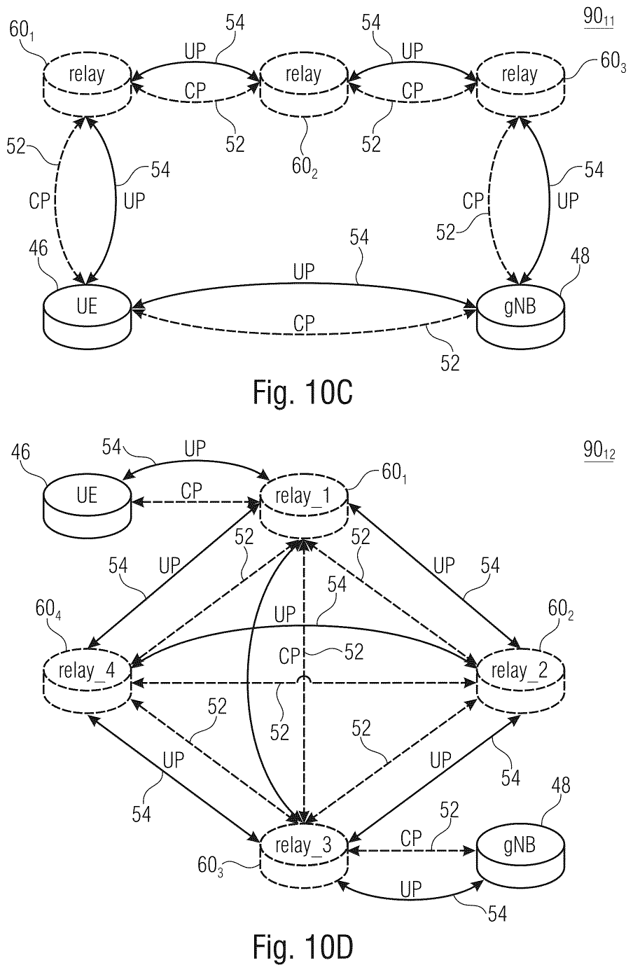

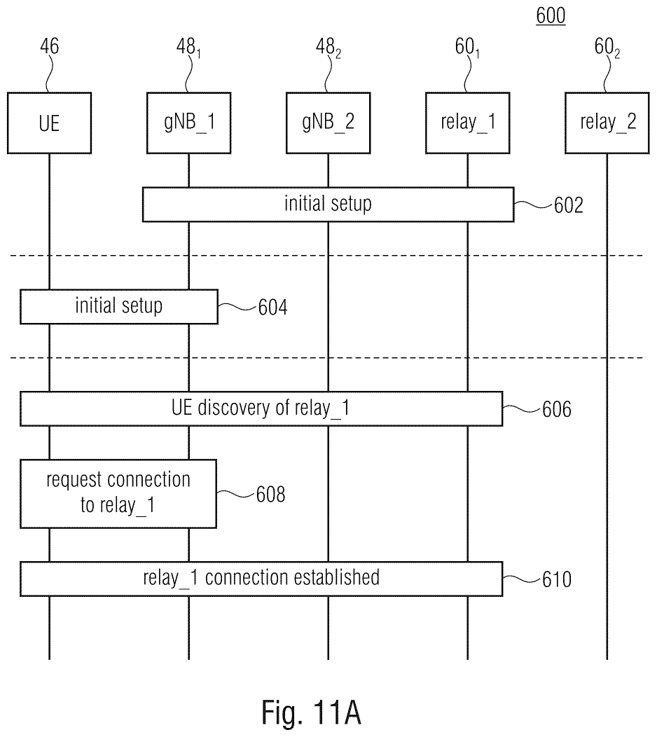

It is to be noted although FIGS. 9a to 9h and therefore FIG. 9i refer to a connection from the UE to a gNB via a relay, the concept of relaying can also be used between UEs operating a sidelink connection and two relays that receive signals from another relay or provide signals to another relay, i.e., to multi-hop relaying. Referring to the multi-hop relaying, FIGS. 10a-c shows schematic block diagrams of network typologies 90₉, 90₁₀ and 90₁₁ according to embodiments without deviating from the interchangeability of the UE 46 and the gNB 48 by other nodes.

In FIG. 10a there is extended the single relay concept to the case of two relays. In FIGS. 10b and 10c, three relays 601 to 603 are used. Again, it should be noted that the figures do not show all of the possible permutations covered by the embodiments.

According to FIG. 10a, there is provided a conceptual representation of the control plane 52 and the user plane 54 connection between a UE 46 and gNB 48 via two relays.

In FIG. 10b there is shown a conceptual representation of the control plane 52 and the user plane 54 connection between a UE 46 and a gNB 48 via three relays.

In FIG. 10c there is shown a conceptual representation of the control plane 52 and the user plane 54 connection between a UE 46 and gNB 48 both directly and via three relays.

FIG. 10d shows a schematic block diagram of a network typology 90₁₂ according to an embodiment. There is shown a conceptual representation of a control plane 52 and user plane 54 connection between a UE 46 and gNB 48 via a mesh comprised of four relays. All possible routes of inter-relay CP and UP connections are shown, while a direct route between the UE and gNB is not shown, this is not excluded according to embodiments. It should also be noted, that the number of relays and number of UE and number of gNBs is selected for illustrating examples according to the present invention. In FIG. 10d it may be seen that based on the mesh structure of the relay 60₁ to 604, there may arise scenarios where one or more relays may operate as a splitter to split one or more signals in a different and in particular higher number of signals and/or as a combiner to combine received signals to a lower number. In combination thereof, signals to be relayed may be re-structured and/or re-generated.

In a mesh network shown in FIG. 10d, the routes used for the connection of data of control plane 52 and data of the user plane 54 to and from the gNB, the UE and the relays may depend on the data being routed.

Embodiments are based on the idea to use a mechanism of proximity services (ProSe) as a means for the UE to discover one or more relays that may be used for signal transmission or reception. Assuming that the relays of the system are using a different frequency so it may forward the relayed information transparently, it becomes possible that multiple relay can cooperate and/or that a relay may receive the same data (CP and/or UP) from different sources, e.g., from tier 1 and also from tier 2.

In connection with embodiments described herein, an identification and/or organization of a use of relays is addressed. Embodiments relate to an identification or recognition of relays as well as the identification of possible routes through a network, such routes may possibly change dynamically.

UE-assisted relay identification and/or relay-assisted UE identification. Embodiments allow to identify, on the UE-side, relay-side and/or gNB-side a recognition of another relay. Embodiments also allow for a relay assisted identification or positioning of UEs to deliver data.

A relay-assisted UE activity identification may relate to an inter-UE CLI report, e.g., to a 3^{rd} party. A digitize-and-store relay can be used to collect information that is collated into the form of a report that is eventually forwarded (on request/schedule/trigger/event/etc.) to basestation.

In the following there are provided details about procedures involved in embodiments and associated signalling to apply the relaying schemes and combinations thereof onto network nodes configured to operate as message relays as described in the problem statement.

To keep the proposed concept and possible implementation options holistic, a network node with relaying functionality can be any node capable of communicating within the framework of the WCS, this includes: UE, gNB, RU, DU, IAB-nodes (IAB-DU, IAB-MT), repeaters, relay-nodes, a reconfigurable intelligent surface, RIS, or any other nodes/devices which support reception and transmission of wireless signals, therefore being equipped with the basic capability of message forwarding (receive and transmit).

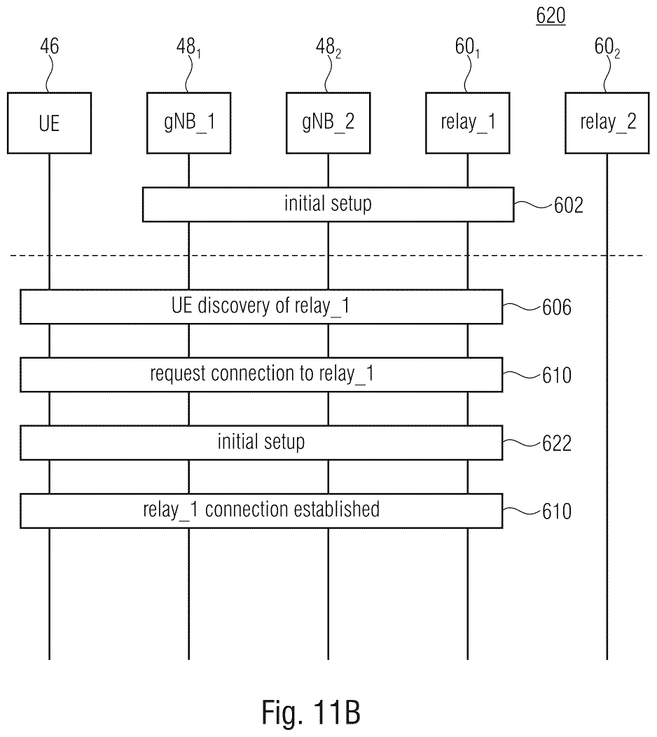

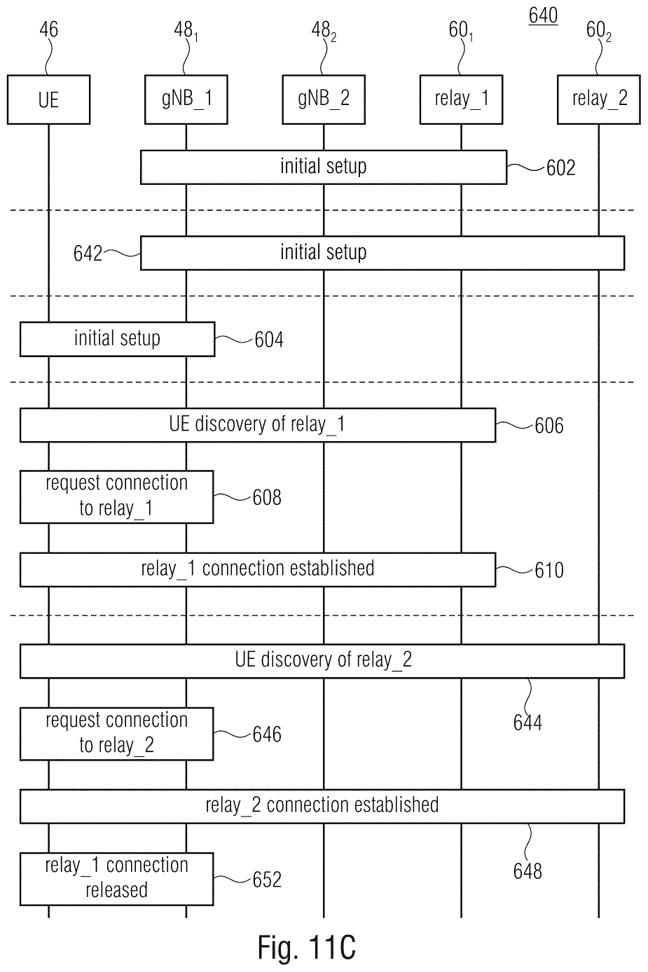

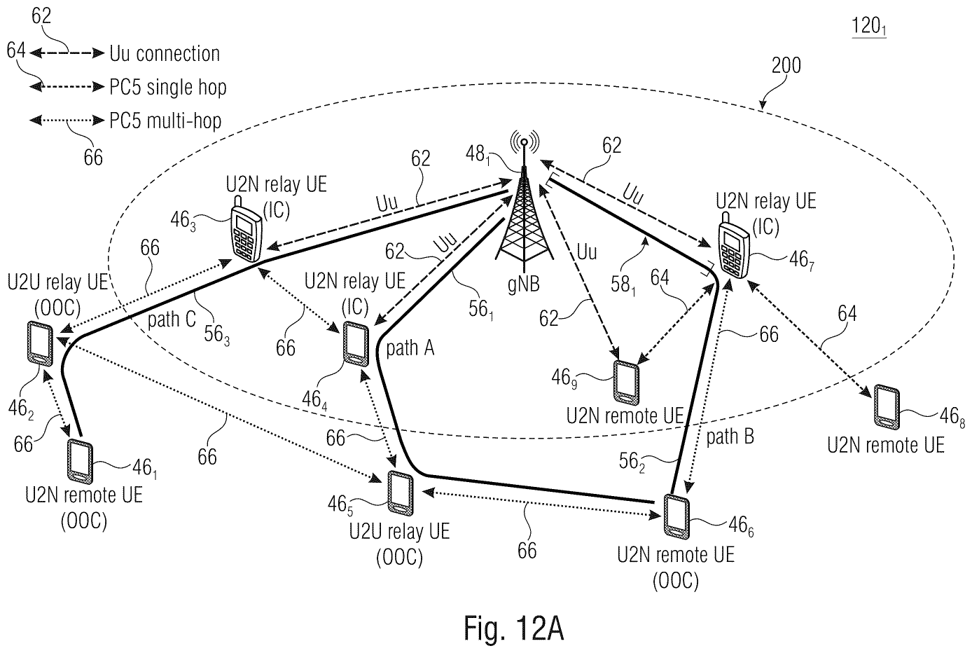

FIG. 11a-c present a UE-centric point of view in the sense that it is the UE that recognises or “sees” the relay rather than the relay being “transparent” to the UE and thus either makes a request for connection to the relay directly to the relay itself or to the gNB. Alternatively, the relays could themselves discover the presence of UEs.

The following concepts should be noted:
the relay is capable of initiating link brokerage with the gNB and/or the UE
“transparent” in appearance can mean
   Transparent before the relay is used
   Transparent when operating with the UE
   “transparency” is a matter of perspective, seen from
      the UE,
      the gNB, or
      the relay and
      depends when the device is discovered, configured, or connected
   “transparency” can also be limited to a specific protocol layer, e.g. PDCP, or the application layer.

FIG. 11a shows a schematic representation of a state configuration chart 600 showing the connection of a UE such as UE 46 and a first relay such as relay device 60 and/or 80 to a first base station, the UE discovery of the relay 60₁, a request to connect to it and the establishment of a connection. In 60₂ an initial setup between the gNB 48₁ and the relay 60₁ is provided. In 604 an initial setup between the UE 46 and gNB 48₁ is provided.

606 comprises a UE discovery of relay 60₁ or vice versa. 608 comprises a request connection of UE 46 to relay 60₁ and 610 comprises an established connection between UE 46 and relay 601.

FIG. 11c shows a simplified state configuration chart 620 according to an embodiment showing the connection of a first relay 60₁ to a first base station 48₁, the UE discovery of the relay 60₁, a request to connect to it and the establishment of a connection. In 60₂ an initial setup between the gNB 48 and the relay 60₁ is provided. In 606 a UE discovery of relay 60₁ is provided as described in connection with FIG. 11a. Based thereon a request connection is provided to relay 60₁ in 610. An initial setup 622 is provided between UE 46 and relay 60₁ and in 610 a connection is established between the UE 46 and the relay 60₁. Whilst in FIG. 11a the relay 60₁ and the UE 46 are independently registered with gNB 48₁ as the UE discovers relay 60₁ and determines that it might offer a potential improved link over gNB 48₁ such that it requests to be connected to relay 60₁, in FIG. 11b the relay 60₁ is independently registered with the gNB 48₁ but the UE 46 is not. When the UE 46 discovers relay 60₁ it requests to be connected to it. As the UE 46 is not yet connected to gNB 48₁, the connection negotiation is made in two legs. One between relay 60₁ and gNB 48₁ and the other between relay 60₁ and the UE 46. FIG. 11c presents a simplified state configuration chart 640 showing the connection of a UE 46 and a first relay 60₁ to a first base station 48₁, the UE discovery of the first relay 60₁, a request to connect to it, the establishment of a connection, the UE discovery of a second relay, a request to connect to it, the establishment of a second connection and the release of the first connection. In 60₂ an initial setup between gNB 48₁ and relay 60₁ is provided. In 642 an initial setup between gNB 48₁ and relay 60₂ is provided. Further, in 604 an initial setup between UE 46 and gNB 48₁ is provided. In 606 a UE discovery of relay 60₁ is provided and allows for a request of the connection to relay 60₁ in 608. In 610 a connection is established between UE 46 and relay 60₁. In 644, the UE 46 discovers relay 60₂ and in 646 the UE 46 requests a connection to relay 60₂ via gNB 48₁. In 648 the relay 46 establishes a connection to relay 602 and in 652 the UE 46 releases the connection to relay 60₁ via signalling with base station 48₁.

Relays 60₁ and 60₂ and the UE 46 are independently registered with gNB 48₁. When the UE 46 discovers relay 60₁ and determines that it might offer a potentially improved link over gNB 48₁, it may request to be connected to relay 60₁. When the UE 46 discovers relay 60₂ and determines that it might offer a potentially improved link over relay 60₁, it may request to be connected to relay 60₂ in addition or as an alternative to the connection provided to relay 60₁.

It is to be noted that relay 60₁ may refer to a first relay or to a first group of relays and that relay 60₂ may refer to a second relay or a second group of relays.

A relay node configuration in accordance with embodiments may include but is not limited to:
A relay mode
   Forwarding delay. This is the time period with which the forwarding of information is delayed. This might be used for:
      Synchronization
      Scheduling
      Interference management
      Network coding e.g. Alamouti coding
   Filtering on/off:
      RF signals
      Baseband signals
      Spatial beamforming
      Selection of antennas, antenna arrays, antenna ports
      Splitting into different MIMO layers
   Frequency conversion. This refers to the transfer of signalling information from one RF band to another RF band—for example, from FR1 to FR2—and within FR1 and FR2—for example from one operating band to another or for the redistribution of component carriers in carrier aggregation or reassignment of bandwidth parts (BWPs). Resampling (both over- and under-sampling). Frequency conversion is also of interest in multiple basestation scenarios that use frequency ranges that not all UEs can support. Here, the relay retransmits information using the appropriate frequency bands for specific UEs.
   k re-transmissions. The relay may be configured to retransmit packets of information (at given times, a given number of times, until an ACK is received).
   Decoding packets and applying different MCS according to the content type. For example, for content that contains time critical information, the relay having recognized this type of content determines that it should be (re-)transmitted in a more reliable manner and thus reduces the MCS (e.g. from 24 to 12).
   Packets and/or data flows may be associated to different traffic classes and priorities
   Amplification
      Closed-loop, such a loop may be controlled via the relay, the gNB and/or the UE
   Multi-operator scenarios for access links and backhaul links
      UE operating in:
         MUSIM single MNO
         MUSIM multiple MNOs
         Dual connectivity with same or different RAT (NSA, LWA)
      Relay operating backhaul link in:
         MUSIM single MNO
         MUSIM multiple MNOs.
         Dual connectivity with same or different RAT (NSA, LWA)
      Based on who owns, installs, operates the relay:
         Includes UE to network relaying (one link is UE-2-UE)
         Touches operation of relay in unlicensed spectrum.
         Relay could be deployed in space (NTN) and provided temporarily or location based to support different MNOs as an enhancement service
         Spectrum used by relay can be different or the same like used by gNBs.
         Relays of different network should be announced to UE by current serving network or a relay information function (RIF), UE can be (pre)-configured about relays in case of Out of Coverage.
         Relays could provide a gNB proxy or mimicking function (cell identification broadcast).
         Relay identifies itself to UEs and other relays in access link (gNB) and backhaul link (MT) using cell broadcast
      Handling situations with high number or density of relays, e.g. vehicles mounted relays in traffic jam:
         Broadcast may include routing options via other relays
         Relay may provide information about:
         Neighbouring relays
         Quality of links (data rate, latency, jitter) to the neighbour and beyond (number of hops or end to end to first gNB).
         Routing options to access to the network
         Capabilities and capabilities of neighbours (if available)
         Number of (connected) UEs
         Ad hoc network flag (if relay is not aware of any route towards the network (RAN)

### Relay Node Capabilities and Associated Capability Signalling (Initial Setup)

Relay node capabilities have to be signalled towards the network gNB by the relay when registering to the network. Capabilities to be signalled to the network are e.g. but not limited to.
physical layer parameters like frequency ranges, carrier bandwidth, possible transmission parameters,
further capabilities like:
   multi-hop support,
   number of supported hops,
   number of supported simultaneous UEs,
   position, location in a multi-hop route,
   TDD frame structure,
   Supported relay operational modes,
   Multi-path support with either
      1 direct and 1 indirect path or
      1 direct path and 2 or more indirect paths or
      2 or more indirect paths
   An indirect path being
      A non-3GPP path or
      a 3GPP path not based on Sidelink

For future proof use of proposed novel features in relaying the capabilities of the relay should be further matched with capabilities of the UE and the gNB as link pairs and/or a concatenation thereof.

The UE shall signal its relaying capabilities to the network (as extension of the existing UE capability reporting during attachment to the network in 4G and 5G) and/or to the relay. UE relay mode support can be signalled:
Directly from UE to relay or
Indirectly: from UE to gNB, and forwarded by gNB to relay.
Direct forward from UE to gNB via relay in a transparent and/or preconfigured relay mode (default relay mode) and then forwarded from gNB to relay and all the way in reciprocal fashion.

Relay node capabilities and associated capability signalling of the UE include but are not limited to:
Relay node capabilities to UE, network and/or other relays (concatenation of relays or meshing)
Supported relaying modes of UE (single hop, multi hop, supported number of connected UEs, . . . ) (currently, SL relaying only supports a single remote UE, but not multiple UEs connected to a relaying UE)
Supported processing time/tolerated latency (because a relay, especially a multi-hop relay introduces latency; e.g. low latency LTE sTTI redefined the required latency of UEs for signal processing)
Supported frequency bands for relaying (similar to UL MIMO, which smartphones do not support in all frequency bands).
From relay to network and/or from relay to UE

According to an embodiment, the relay device is configured for signalling a capability information of the relay device to another device, e.g., a gNB, the capability information comprising:
a physical layer parameter like frequency ranges, carrier bandwidth, possible transmission parameters,
a capability to support multi-hop,
a number of supported hops,
a number of supported simultaneous UEs,
a position or location, e.g., of the relay device in a multi-hop route, e.g., a geolocation, and/or a relative location or distance
an orientation, a polarization, an polarization match, a directivity of receive or transmit beam pattern for the 1^{st} or 2^{nd} link of the relay
an implemented or supported TDD frame structure,
a supported relay mode,
a multi-path support such as
a direct and at least one indirect path to the other device; or
at least two indirect paths to the other device;
wherein an indirect path is a non-3GPP path or a 3GPP path not based on Sidelink;
a path property or path-segment property
a beam ID,
a frequency shift, and
a jitter

Further to signalling a capability, a relay device may signal an availability of such capability on a per-relay or per-link basis.

According to an embodiment, the relay device is adapted for signalling an availability information of the relay device to another device, e.g., a gNB, the availability information indicating a functionality of the relay device to provide for a capability in the wireless communication network, e.g., after being configured accordingly.

According to an embodiment, the relay device is to signal capability information and/or availability information on a device level, on link-level or on a group-of-link-level.

According to an embodiment, the relay device is to provide for at least one of a combiner of different path segments into a combined path segment; a splitter of a first path segment into at least two path segments; and a mesh into a particular direction of the wireless communication network.

According to an embodiment, the relay device is to provide for a path segment in the wireless communication network that provides for a redundant path or a path diversity for at least one end-to-end link of the wireless communication network.

According to an embodiment, the relay device is receiving a wireless receive signal to be relayed through a unidirectional or a bidirectional path segment; and/or wherein the relay device is transmitting a wireless transmit signal relaying a receive signal through a unidirectional or a bidirectional path segment.

According to an embodiment, the relay device is to operate a path segment based on an associated parameter that relates to at least one of a quality of service, a priority, a redundancy, and a latency of a relayed signal.

### Detection and Signalling of Relays (Discovery)

Detection and signalling of relays available and/or active in an E2E communication path include but are not limited to:

From network side:
Relay candidate discovery, e.g. proximity, location, reception/transmission range, reception conditions (note: forward and backward route can be different)

From UE Side (also for ado relaying without connection between gNB and UE)·
Relay candidate discovery, e.g. proximity, location, reception/transmission range, reception conditions (note: forward and backward route can be different)·
Detection of pre-configured Relay nodes
Providing Relay with UE communication needs (UE to relay)
   Data rate, QoS
   Latency requirements
   UE capabilities (waveform parameters, frequency bands, MIMO capabilities, . . . )

After detection the discovery process starts
Network controlled:
   Reading out the capabilities of relays
   Reading out communication needs of the UE
   Reading out the list of connected relays/devices per Relay
   Calculating communication/relay routes to fulfil communication needs
      Consider cost function
      Relay selection (per communication route).
      Multi-Hop path selection
      Resource assignment (Resource pools, Slot structure, relay role along a multi-hop trace
   Signalling the result to the Relays/UEs
      Per communication route/path.
Ad hoc mode—no configuration by network required or if no connection to the network is needed/possible.
   At least one of the involved nodes/devices (UE or relay) needs to fill the role of a E2E link manager or controller.
   The transition from discovery of relaying candidates to connection establishment might be floating, I.e. some of the steps above could be part of step “connection establishment”

A device in accordance with this aspect is configured for wirelessly communicating in a wireless communication network, e.g., as a user equipment, UE, the device configured for:
recognising a relay device in the wireless communication network and recognising a relay mode of the relay device according to which the relay device relays a wireless receive signal as a wireless transmit signal;
adapting a transmission of a wireless signal as the receive signal according to the relay mode; or adapting a reception of a wireless signal as the transmit signal according to the relay mode.

According to an embodiment, such the device is configured for:
performing a relay candidate discovery, e.g. based on one or more of a proximity, location, reception/transmission range, reception conditions; detection of a pre-configured relay device or relay capability; and signalling, to the relay device, information indicating a communication need, e.g., UE to relay, the communication need comprising at least one of:
   a need for network access;
   a need for internet access;
   a need for transmission of emergency message;
   a need to establish a communication link to a target device or target address;
   a data rate and/or QoS;
   a latency requirement; and
   a device capability such as a waveform parameter, a frequency band, a MIMO capability.

It is to be noted that the capability may optionally include signals/flags including e.g. positioning anchor, internet access point (now, always, sometimes), message storage/logging, forwarding (immediate, delayed). Such flags may help the UE to make decisions on selecting suitable candidates for establishing a relayed connection.

According to an embodiment the relay capability relates to one or more of a positioning anchor, an internet access point, a time of availability thereof, such as now, always, sometimes, e.g., at specific times, a message storage capability a logging capability, a forwarding capability such as immediate or delayed.

According to an embodiment the device is configured for discovering and/or connecting to the relay device in an Ad hoc mode.

According to an embodiment the device is configured for recognising a first relay device for a first path or a first direction of a first wireless signal of the device; and to connect to the first relay device; and, in parallel possibly simultaneously for recognising a second relay device for a second path or a second direction of a second wireless signal of the device; and to connect to the second relay device

According to an embodiment the device is to monitor an operation of a relay device described herein.

According to an embodiment the device is configured to: digitize a signals received from or transmitted to the relay device; and configured for monitoring possibly including logging an information such as a KPI and/or an event related to links to neighbouring nodes and or a further node one or more hops away.

According to an embodiment the device is configured for reporting a report based on the monitoring automatically or on demand.

According to an embodiment the device is configured for establishing a first connection to a first relay unit; and to discover a second relay unit that is connected to the same or another basestation; and to establish a second connection to the second relay unit to obtain an improved link to the basestation or a target device (e.g. a cloud service in the internet) when compared to the first connection; and to release the first connection.

According to an embodiment the first relay unit is formed by a first set of relay devices comprising at least one relay device; and wherein the second relay is formed by a second set of relay devices comprising at least one relay device

According to an embodiment the device is configured to signal a relaying capability information related to the device to a relay device connected with the device and/or to a basestation, e.g., to allow forwarding of the relaying capability information to the relay device.

According to an embodiment the device is configured to signalling a relay capability information that includes one or more of:
a relay node capability to UE, network and/or other relays, e.g., a concatenation of relays or meshing;
a supported relaying mode of the device, e.g., single hop, multi hop, supported number of connected devices such as UEs,
a supported processing time/tolerated latency;
a supported frequency band for relaying; and
information indicating a difference of a parameter between directions from a relay device to the network on the one hand and from the relay to a UE on the other hand.

When considering a network, the wireless communication network may be adapted for performing a relay candidate discovery, e.g. based on one or more of a proximity, location, reception/transmission range, reception conditions.

According to an embodiment, the wireless communication network is adapted for a detection of the relay device and a discovery procedure of the relay device based on the detection, the discovery procedure comprising one or more of:
reading out, e.g., receiving a capability signal, the capabilities of relays;
reading out, e.g., by receiving a signal from the device, a communication need of the device, e.g., a UE
reading out a list of connected relays/devices per Relay
calculating communication/relay routes to fulfil the communication needs, e.g., by
   considering a cost function
   performing a relay selection, e.g., per communication route
   performing a multi-hop path selection
   performing a resource assignment such as a resource pool, a slot structure, a relay role along a multi-hop trace
signalling the result to the Relays/UEs e.g., per path, i.e., a communication route or path segment

When referring to relay devices, e.g., in connection with the discovery phase, a relay device according to an embodiment may configured for signalling the capability information responsive to receiving a discovery message.

According to an embodiment the relay device is configured for including the capability information into a signal received from another device responsive to a discovery message received by the other device; wherein the relay device is adapted for forwarding the obtained signal within the wireless communication network.

According to an embodiment the relay device is configured for signalling a capability information of the relay device responsive to receiving a discovery message from another device in the wireless communication network, wherein the relay device is configured for skipping signalling the capability information based on a connection state of the relay device, e.g., having connectivity above or below a connectivity threshold.

### Relaying Procedure and Related Signalling (Connection Establishment)

Relaying procedure and related signalling include but are not limited to:
Resource assignment
   At UE to relay link (s=>ad hoc network), relay to relay links, relay to BS link (this may be identical to relay-relay link). The resources depend on the fact if we use the same or different frequency for the relay-to-relay link(s) and the relay to UE/BS link(s).
   Relaying frequencies reuse: Partial or full frequency reuse of adjacent relaying links or within a region of the relay links or a relay network can be supported.
Relaying network layout/topology discovery=>the detection part was described in the previous section. The procedure combines information of each relay, BS and UE in the network to build up a layout/routing topology of the network. In case of node mobility, the velocity of different participants needs to be taken into account. A further important aspect is the knowledge distributing about the network layout/topology within the network. This information can be shared entirely or in parts and within the entire network or in close proximity or the relay links. Means to distribute such information include for example broadcast, multicast, group cast or unicast message, which can be localized, e.g. in range or number of hops. Such knowledge distribution signalling can be performed by one, some or all devices involved in the relaying links, in close proximity or which become aware about the existence of relay links through reception of such messages. Furthermore, the distribution of such knowledge/information can be constraint, e.g. by limiting the addressee range to be within a certain device subgroup.
Routing assignment and announcement:
   Depending on the layout/topology, mesh can be supported as well:
      flooded mesh may be used (broadcast-based approach). The procedure should satisfy that the most far away relay in the right direction reports successful reception before doing an active relay forwarding.
      routed mesh may be used in single route or multi-route approaches. The use depends on the QoS requirements that shall be met. Routing setup procedure relies on the successful discovery of the relaying link options and their configuration.
Relay detection/identification procedure and signalling
Relay candidate identification and signalling:
   Blind: use a “ARP” process to find the target UE/closest BS, receive answers with possible routes (routes need a link qualification indicator (processing may be done by a gNB, so gNB eventually knows of all relays and can do a pre-processing of routes. Also gNB could create a digital twin of the relaying network
   Known Location: relays in the targeted direction towards destination
   Omniscient (for example due to gNB): already know the best candidates also with the least relaying workload:
      Relay location prediction.
      Relay Ownership based selection
Relay candidate selection and signalling:
   Candidate relay configuration.
      Capability and feature exchange and matching with UE and gNB
      Relay activation/deactivation (may also be enforced by the gNB)
UE configuration for transmission with relay
Communication between gNB and UE via relay
Communication between UE and UE via relay
Relay Synchronisation
   E.g. for wakeup to receive configuration information
Relay cluster configuration (Support for cooperative relaying concepts)

The related signalling includes but is not limited to:
Relay specific RS, beacons or pseudo-IDs to be shared between network entities including gNBs, UEs and/or relay(s)
   May be also a wakeup signal from the UE that forces sleeping relays to identify themselves.
Network to UE/gNB signalling for configuration to detect and identify relays and their capabilities
Network to UE/gNB signalling on relay detection measurement procedure
   Measure and process, analyse, logging and reporting.
Relay candidate negotiation between UE, gNB and relay (network controlled or directly driven by UE or coordinated by gNB).
Signalling to UE and relay to configure relay mode, (de)-activation/deactivation.
Synchronization signal for ad hoc relaying networks that are not GPS synchronized (indoor).
Inter relay network communication signal, which may be different to a normal gNB UE link). May be more like IAB signal relaying.

Prediction signalling for moving relays (information on current location and estimated location in some seconds) to even allow a short-term usage of the moving relay (with fast moving relays a store and forward relaying may be done to the next gNB).

With reference to embodiments relating to a network, a wireless communication network according to an embodiment is configured for organising, on a network side, a relaying frequency reuse.

According to an embodiment, the wireless communication network is configured for combining information of each relay device, and end-devices of a link such as basestations and/or UEs, in the network; and for determining a layout topology or routing topology of the network.

According to an embodiment, the wireless communication network is configured for determining the layout topology or routing topology of the network based on a mobility of at least some of the relay device and/or the end-devices.

According to an embodiment, the wireless communication network is configured for distributing, at least in parts, the determined layout topology within the network.

According to an embodiment, the layout topology comprises a mesh-structure.

In order to enable a “routing instance” to make informed decisions, the remote and relay UEs can inform other parts of the network, e.g. other relays, UEs or the network (e.g. gNB, core network), about their current status or certain properties. These can be—in addition to the capabilities of the device (see section Relay node capabilities and associated capability signalling (initial setup))—measured data, performance levels, power saving states and others, e.g.:
Battery status
   Remaining battery level
   Battery temperature
   Performance class
   Current energy drain, e.g. in mA
   Ongoing charge procedure and parameters, e.g. current and voltage
Current Load
   Number of connected UEs, e.g. via Sidelink or non-3GPP wireless (or wired) connection.
      Number and/or list of Remote UEs.
      Number and/or list of Relay UEs
   Uplink and downlink data rate, MCS
   HARQ status, e.g. number of Retransmissions, faulty packets, etc.
   Buffer status for up- and downlink
   CPU or processing load
   Load on specific encoding/decoding/support modules/chips, e.g. for audio/video processing or other specific algorithms
Priority
   Priority flag, could also be controlled by network
   Preferred applications
   Restrictions on the HOP-level in a multi-hop setup
Access Restrictions
   Block-lists of
      UEs
      Applications
      Traffic types
      Geo-Location
   Security requirements.
      Minimum encryption levels/methods.
      List of supported encryption levels/methods
   Power Saving features of other UEs, if available
RSSI Readings
Mobility
   Current speed
   Current direction
   Stationarity

According to an embodiment, a relay device is provided that is configured for signalling a status information of the relay device to another device, the status information indicating a status of the relay device.

The status information comprises at least one of:
a battery status;
a load status;
a priority of traffic or applications providing the traffic;
access information relating to an access to a relay service;
access restriction information relating to a restriction of access to a relay service;
a reference signal received power, RSRP;
an received signal strength indicator, RSSI;
a parameter or flag recognised by the relay and indicating at least one of:
   a capability of further relays;
   a communication needs of a device using the relay device, e.g., a UE;
   a list of connected relays and/or devices per relay;
a mobility information indicating a mobility of the device.

### Path Discovery, Selection, and Construction

In at least some embodiments, path, branch and route mean basically the same thing a path is one possible connection between a source and a target/destination. A route is the same thing—one option out of multiple paths. A Branch as a single path, e.g. from the relay UE until the remote UE. Most of the time they are interchangeably but can be used specifically to point out variants in features.

The basic building procedure may comprise:
Discovery of relays candidates and/or path candidates
   Discovery of path segments
   Rating of path segments (ordering w.r.t. KPI/QoS; alternative path candidates)
   Selection of path segments
Path/Relay selection
   Based on QoS requirements or
   Based on preconfigured thresholds
Path construction
   Signalling
   Configuration
   Further signalling and configuration for next hop
E2E session establishment
   For one or multiple paths

There might be multiple possible paths or variations of an E2E connection path from a source UE to the base station or target UE. Instead of assigning for each transmission a list of path segments (including properties, source, target and other information) in every transmission, the source UE, target UR, relay UE or base station can assign ‘branch IDs’ or ‘path IDs’ to each of the paths that are discovered.

The relay nodes store the path or branch ID in order to send data via the associated branch. The branch ID can be indicated in the header of the data packet.

The source UE or the base station can decide on which branch or path to send a packet based on the properties of the branch or path or path segments, which can for example be:
QoS parameters
   Per HOP or for the whole branch (e.g. via average, min, max of single HOP QoS parameters)
   E2E link quality indication (QoS indication)
Latency
Jitter
HOP Count
Data rate limitations/estimates for up- and downlink
   Link-direction asymmetry, i.e. difference in up- and downlink KPIs, e.g. (direction-related assessment of link quality)
      SNR
      Data rate
      Modulation
      Interference.
Mobility (of involved UEs)
Throughput
A link metric used specifically for Sidelink
A link metric used for NTN communication
Measurement data available at the UEs
Headroom/margin w.r.t. throughput, latency TX or RX power, other QoS parameters

A device in accordance with this aspect, which is combinable with other embodiments without limitation, may be configured for wirelessly communicating in a wireless communication network, e.g., as a user equipment, UE, or a base station, the device configured for selecting at least a selected path segment of a path from a plurality of paths between the device as a source device and a sink device based on a property of the path; and transmitting a signal along the selected path.

According to an embodiment, the device is configured to include, into the signal, path information indicating the selected path or path segment to indicate at least a part of the path to a relay device relaying the signal towards the sink device.

According to an embodiment, the path information comprises a branch-ID indicating a branch or segment of the path between two hops of the path; or comprises a path ID indicating the path.

According to an embodiment, the device is configured is configured for selecting the path or path segment based on one of:
a quality requirement of the signal;
a level of quality, e.g., QoS provided by at least a part of the path or segment thereof;
a number of HOPs of the path or segment thereof;
a supported throughput in at least one direction of at least a part of the path;
a data rate supported by a node forming a node of the path;
a mobility of a node forming a node of the path;
a link metric associated with the path used specifically for Sidelink
a link metric used for non-terrestrial networks, NTN, communication
measurement data available at the device
a headroom/margin of a quality or control parameter.

According to an embodiment, the device is configured is configured for transmitting a discovery message to request information indicating at least a path or a path segment of the wireless communication network that is supported by a receiving node.

According to an embodiment, the device is configured is configured for recognising a relay device in the wireless communication network and for recognising a relay mode of the relay device according to which the relay device relays a wireless receive signal as a wireless transmit signal; wherein the device is configured for adapting a transmission of a wireless signal as the receive signal according to the relay mode; or adapting a reception of a wireless signal as the transmit signal according to the relay mode.

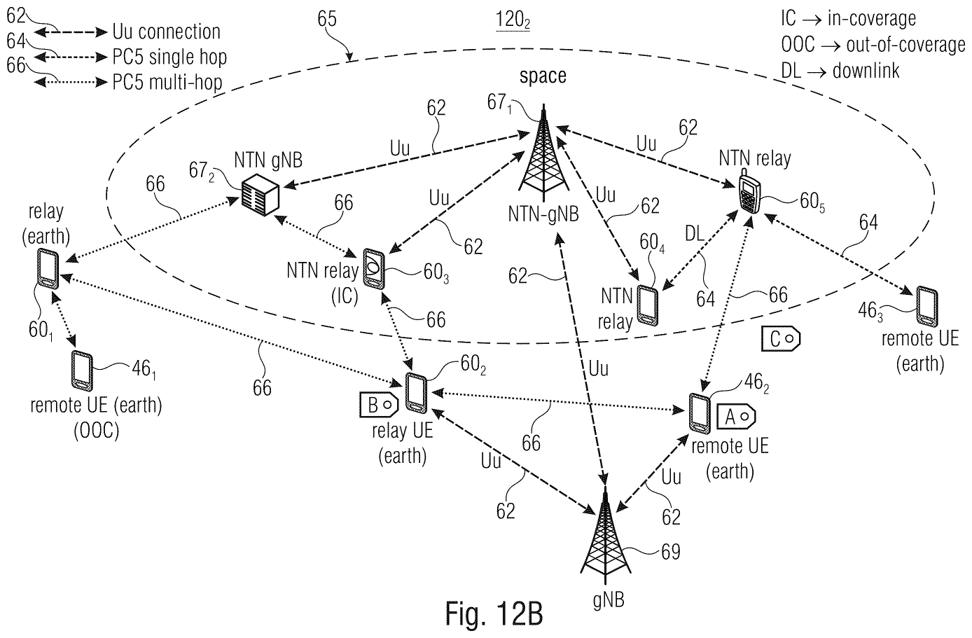

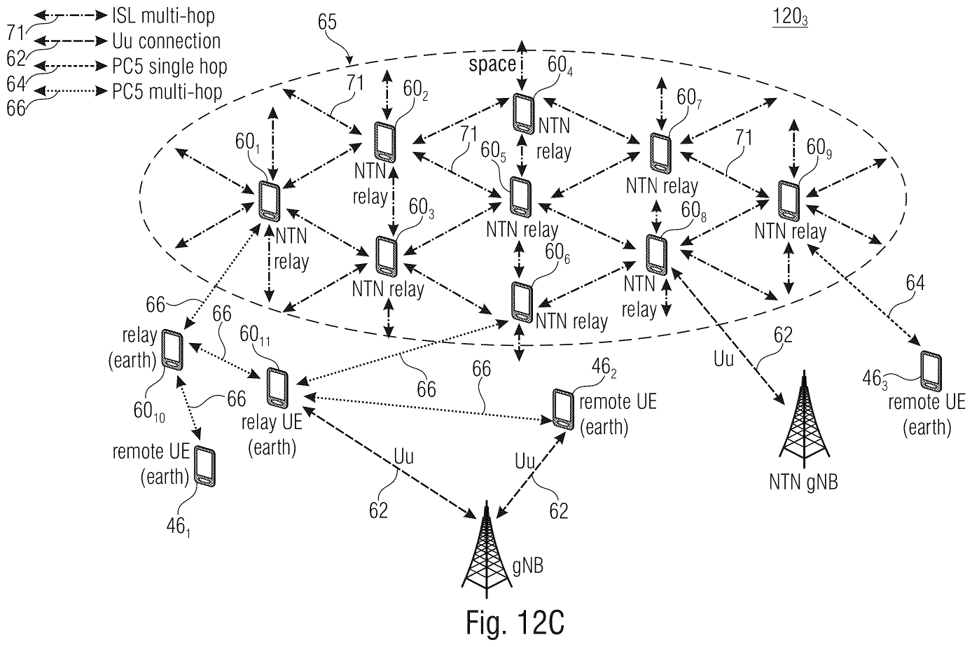

With reference to FIG. 12a showing a schematic block diagram of a wireless communication network 120₁ according to an embodiment, there is shown the concept of different paths in a wireless communication network.

Different UEs as 46₁ to 46₈ are located in the wireless communication network 120₁, some of the UEs being located within the coverage area 200, i.e., they may be in coverage, IC, and some of them outside thereof, i.e., out of coverage, OOC. UEs 46₁ to 46₈ may be operated, at least temporarily as a relay device described herein such as relay device 60, 70 and/or 80.

To different UEs such as remote UEs 46₁, 46₅ and 46₄ there may be provided paths 56₁, 56₂ and 56₃, each path having one or more path segments 58, wherein each path segment may be established by at least one of a Uu connection 62, a PC 5 single hop connection 64 or a hob of a PC 5 multi-hop 66. As may be seen, e.g. with regard to path 56₁ and 56₂, a UE such as UE 46₆ may be reached via different paths. It may therefore be of benefit when selecting at least a path segment towards a specific target, wherein such a selection may be implemented based on varying conditions such as varying positions, load scenarios, quality requirements or the like.

Embodiments, thus, relate to distributing information about links, paths or path segments within the network to a deciding entity, wherein such a deciding entity may be a central controller, may be located at a base station such as gNB 48₁, at a relay device, at a device being a source for a signal to be transmitted and/or a device being a sync of such a signal.

As may be seen from FIG. 12a, a device such as a relay device may operate a single path segment, see UE 46₁, may operate two path segments of a same or different paths, se UE 46₂ or UE 46₉ or may operate more than a single path and an increased number of path segments, see UE 46₆ or UE 46₄.

In other words, during the discovery phase a relay UE may answer discovery messages and include further information, alter, add or fuse (combine) path properties, beam IDs, frequency shifts, jitter, geolocation, relative location or distance. When sending the answer back the multi-hop chain, the same principle applies to the response message as for the discovery message. The gNodeB (base station) at the end then has a response with a branch ID and associated properties.

The path ID can be used by the remote UE to send the message on a specific path that matches the QoS requirements and/or supported feature set. The gNodeB can also use the path ID to schedule the downlink transmission back to the remote UE.

This way, the relay UEs do only need limited intelligence to do the routing, which only based on the discovery outcome and the resulting path ID/destination pairs.

### Procedure:

Remote UE A sends out discovery message. The discovery message is received by relay UE B, C and D. B and C send out a discovery message as well to find a path to the base station (if they don't already have a Uu connection/can establish a Uu connection). Relay UE D already has multiple uplink-heavy remote UEs to relay and does therefore not answer.

Finally two (or more) paths are established and the response message will go back the path until it reaches UE A that now has two relay/path candidates.

On another bearer for another service, the gNodeB is looking for UE A and tries to discover the UE via connected relay UEs. Relays B and C can reach UE A, but so can Relay D which is now answering the discovery, because there is downlink capacity. The gNodeB has the option to choose the ‘best’ connection out of three, whereas the remote UE only has two options.

Alternative routing options can be monitored but do not have to be active. They can be used as fallback in case of RLF on the other route. Also, conditional handover or re-configuration is possible in case the properties of one path do no longer meet the requirements.

FIG. 12b shows a schematic block diagram of a wireless communication network 1202 according to an embodiment. FIG. 12b shows a possible realization of a relay network that comprises both ground segments and space segments. Furthermore, this illustrates space-borne gNBs connected to UEs on the ground via NTN relays. For example, relays devices 60₁ and 60₂ may be configured for relaying signals along paths as described in connection with FIG. 12a. Relay devices 60₁ and/or 60₂ may be located on earth implemented as stationary devices or mobile devices, e.g., a UE 46 of FIG. 12a. Each relay device 60 of wireless communication network 120₂ may be adapted as relay 70 and/or 80.

Relay devices 60₃, 60₄ and 60₅ may be located in space 65, e.g., being part of a satellite, a space station or a space ship. The wireless communication network 120₂ may comprise one or more spaceborne base stations such as NTN gNBs 67₁ and 67₂ that may communicate with each other, e.g., using Uu connections 62 and/or communication with a base station, gNB, 69, e.g., a base station of wireless communication network 100, for example, using a Uu connection 62. Relays 60₃ to 60₅ may utilise PC5 connections, e.g., as a multi-hop connection or a single-hop connection. Relays 60₃ to 60₅ may provide service for one or more UEs 46₁ to 46₃, e.g., using a PC5 connection to assist a terrestrial base station 69 or a spaceborne base station 67 with providing service by providing additional connections or data streams or by providing a substitute, e.g., for UEs that are OOC.

FIG. 12c shows a schematic block diagram of a wireless communication network 120₃ according to an embodiment. FIG. 12c shows a possible realization of a relay network that comprises both ground segments and space segments as described in connection with FIG. 12b. In wireless communication network 120₃ space-borne relay devices 60₁ to 60₉ may be connected to UEs and gNBs on the ground, e.g., using a PC5 connection and/or a Uu connection 62. Space-borne relay devices 60₁ to 60₉ may communicate with each other and with other devices vie inter satellite links, ISL, 71. Moreover, ground-based UEs 46₁ to 46₃ may connect to gNBs of a terrestrial network via relays of the ground and/or—as shown for remote UE 46₃—via a relay device of the space segment. In each of the wireless communication networks, there is provided a solution for relaying signals between devices, such as UEs and/or base stations, wherein the relaying connection may comprise one or more hops and may be located on the ground, on earth respectively, may be operated partially as a TN and partially as a NTN or may be operated completely as an NTN, e.g., relaying signals between spaceborne devices.

### Distributed HARQ

HARQ may be done with increased granularity when compared to for a complete path, up to on every HOP if sufficient data is already available and re-transmission can be done on a per-HOP basis instead of E2E. Of multi-path is used in combination with multi-hop there is also the possibility that a ‘distributed HARQ’ can be performed by having multiple versions of the same data via multiple paths.

If the same content of the PDCP packet arrives via multiple MAC packets, an ID may be used to mark the PDCP packet in the MAC packets. For example, PDCP Duplication may be used.

The invention offers the following benefits:
Reduced latency
Increased data rate
Improved reliability
Range extension.
Resilient routing
Coverage infill
Concealed routing-less vulnerable to intrusion/attacks
Support of network coding
Energy saving-distributed nodes activation/deactivation
Interference management
Lower packet jitter on higher layers
Enables multi-operator (aggregation) shared relay nodes.
Multi-access conversion (TDD-FDD, Frequency range, FRa↔FRb)

Relay devices described herein further relate, in some embodiments, to a relay device, configured for receiving the wireless receive signal and/or for transmitting the wireless transmit signal as an optical/photonic signal, e.g. laser beam, free-space optics, infrared (IR), visible light communication (VLC) or a radio frequency signal, e.g. HF, VHF, UHF, micro-wave, millimetre-wave, (sub-)THz.

According to an embodiment, the relay device is configured for relaying the wireless receive signal as a first wireless receive signal along a first path of a wireless communication network; and configured for relaying a second wireless receive signal along a different second path of the same or a different wireless communication network, the first path and the second path maintained simultaneously or sequentially.

According to an embodiment, the relay device is configured for relaying signals along the first path in a first operation mode and for relaying signals along the second path in a different second operation mode.

According to an embodiment, the relay device is configured for providing a retransmission of the wireless transmit signal on a HOP basis, e.g., based on a HARQ procedure. As a HOP one may understand a relaying device or entity that transmits or retransmits a signal to provide for a further source of a signal and a further reception of a signal.

According to an embodiment, the relay device is configured for relaying the wireless receive signal along different paths or path segments in the wireless communication network.

According to an embodiment, the relay device is configured for selecting at least one selected path from a plurality of paths between the relay device and a sink device or a further relay device based on a property of the path; and transmitting a signal along the selected path; or configured for selecting at least one selected path segment from a plurality of path segments between the relay device and a sink device or a further relay device based on a property of the path segment; and transmitting a signal along the selected path segment. For example, beyond a single selected path there may be selected a further route to be used in parallel or as a fallback option.

According to an embodiment, the relay device is configured to select the selected path or path segment based on a decision of the relay device or based on a decision received from a deciding entity. A device requiring relay services may, according to an embodiment, be adapted in a same manner.

Embodiments further relate to aspects of a wireless communication network. According to an embodiment, a wireless communication network comprises at least one relay device described herein.

According to an embodiment, the wireless communication network comprises a plurality of relay devices configured for jointly relaying a signal in the wireless communication network via a plurality of hops.

According to an embodiment, the wireless communication network comprises a plurality of relay devices configured for jointly relaying a signal via alternative routes in the wireless communication network.

According to an embodiment, the wireless communication network is configured for relaying a signal between a first device and a second device via the relay device; wherein the wireless communication network is configured to adapt an operation of the first device, the second device and/or the relay device according to the respective capability of another device.

According to an embodiment, the wireless communication network is adapted for a detection or identification of the relay device as a relay candidate of a set of relay candidate devices for a future relaying of a signal, the detection being based one or more of:
a blind detection
a known location of the relay device
an omniscient detection

According to an embodiment, based on the detection, the wireless communication network, e.g., a relay control entity, is configured for selecting a relay device from the set of relay candidate devices for a use of the relay device in at least one route of the wireless communication network; and to configure the selected relay candidate devices accordingly.

According to an embodiment, based on the detection, the wireless communication network, e.g., a relay control entity, is configured for activating and/or deactivating at least one relay device.

According to an embodiment, based on the detection, the wireless communication network, e.g., a relay control entity, is configured for configuring at least one relay device.

According to an embodiment, based on the detection, the wireless communication network, e.g., a relay control entity, is configured for synchronising a set of relay devices of the wireless communication network.

According to an embodiment, based on the detection, the wireless communication network, e.g., a relay control entity, is configured for clustering a set of relay devices of the wireless communication network.

According to an embodiment, to operate the at least one relay device, the wireless communication network is adapted for a signalling at least one of:
relay specific RS, beacons or pseudo-IDs to be shared between network entities including gNBs, UEs and/or at least one relay;
a wakeup signal from the UE that forces sleeping relays to identify themselves;
network to UE/gNB signalling for configuration to detect and identify relays and their capabilities;
network to UE/gNB signalling on relay detection measurement procedure;
   Measure and process, analyse, logging and reporting;
relay candidate negotiation between UE, gNB and relay (network controlled or directly driven by UE or coordinated by gNB);
signalling to UE and relay to configure relay mode, (de)-activation/deactivation;
synchronization signal for ad-hoc relaying networks that are, e.g., not GPS synchronized such as indoor;
inter relay network communication signal, which may be different to a normal gNB UE link, e.g., similar to IAB signal relaying; and
prediction signalling for moving relays (information on current location and estimated location in some seconds) to even allow a short-term usage of the moving relay (with fast moving relays a store and forward relaying may be done to the next gNB).

According to an embodiment, the wireless communication network is adapted to transmit a discovery message to a relay device and to receive a capability information responsive to the discovery message to obtain information about a capability of the relay device and/or about an identifier identifying at least a segment of a path provided by the relay device

According to an embodiment, the wireless communication network, e.g., a source device or a base station is configured for controlling different relays along a same path or path segment to provide for a multi-hop relaying.

According to an embodiment, the wireless communication network is adapted to control the relay devices into a same or different relay modes.

According to an embodiment, the wireless communication network is adapted to control the relay devices based on a relay capability of the relay devices.

According to an embodiment, the wireless communication network comprises a path using radio frequency, RF, link and/or a path using a cable-less media, e.g., for transmitting optical signals.

Features according to the first aspect that may form advantageous embodiments for the invention are formulated below:

### Features of the First Aspect

Implementation 1. A relay device configured for relaying a wireless receive signal as a wireless transmit signal;
wherein the relay device is configured for a plurality of relay modes; and is adapted for changing an operation of the relay device to at least one of the plurality of relay modes responsive to a control signal.

Implementation 2. The relay device of implementation 1, wherein the plurality of relay modes comprises at least a subset of:
an amplify and forward mode;
a band switch amplify and forward mode;
a decode and forward mode;
a store and forward mode.

Implementation 3. The relay device of implementation 1 or 2, wherein the relay device is adapted to operate in a wireless communication network; and is configured for receiving the wireless receive signal from a user equipment of the wireless communication network; and/or for transmitting the wireless transmit signal to a user equipment of the wireless communication network.

Implementation 4. The relay device according to one of previous implementations, configured for receiving a control signal indicating a relay mode or a combination of relay modes; and for operating according to the control signal.

Implementation 5. The relay device according to one of previous implementations, comprising an antenna unit configured for beamforming; wherein the relay device is adapted to receive and/or transmit wireless signals using a beamforming technique and using the antenna unit.

Implementation 6. The relay device according to one of previous implementations, comprising an antenna unit and an actuator; wherein the actuator is configured for changing an orientation of the antenna unit to change a direction and/or polarisation of a signal received or transmitted with the antenna unit with reference to a further device.

Implementation 7. The relay device according to one of previous implementations, comprising a control unit; configured for controlling an operation of the relay device.

Implementation 8. The relay device according to implementation 7, wherein the control unit is configured for controlling the relay device:
autonomously;
sequentially;
adaptively;
programmatically; and
any full or partial combinations thereof.

Implementation 9. The relay device according to one of previous implementations, wherein the relay device is implemented as a UE, a gNB, an RU, a DU, a CU, an IAB-node such as an IAB-DU or an IAB-MT), a repeater, a relay-node, a RIS or any other node or device which supports reception and transmission of wireless signals.

Implementation 10. The relay device according to one of previous implementations, wherein the relay device is configured for receiving a request for relaying a signal from a first device such as a user equipment, UE, or another relay device to a second device such as a basestation or another relay device;
wherein the relay device is configured to negotiate a parameter of a first connection between the relay device and the first device with the first device; and/or
configured to negotiate a parameter of a second connection between the relay device and the second device with the second device to establish at least a part of a relayed connection between the first device and the second device.

Implementation 11. The relay device according to one of previous implementations, wherein the relay device is configured for receiving a connection information from the wireless communication network, e.g., a deciding entity thereof, the connection information indicating a parameter of a connection of the relay device to another device; wherein the relay device is configured for controlling the connection based on the connection information.

Implementation 12. The relay device according to one of previous implementations, wherein the relay device is configured for providing, to the wireless communication network, at least one of an input, a parameter, a report and a feedback message to provide information to a deciding entity of the wireless communication network for a decision about a parameter of a connection of the relay device.

Implementation 13. The relay device according to one of previous implementations, wherein the relay device is configured for signalling to the wireless communication network a configurability information indicating that the relay device will operate according to a connection information received from the wireless communication network that indicates a requested parameter of a connection of the relay device; and/or indicating that the relay device will forward connection information to a device indicated in the connection information.

Implementation 14. The relay device according to one of previous implementations, wherein the relay device is configured for signalling a capability information of the relay device to another device, e.g., a gNB, the capability information comprising:
a physical layer parameter like frequency ranges, carrier bandwidth, possible transmission parameters,
a capability to support multi-hop,
a number of supported hops,
a number of supported simultaneous UEs,
a position or location in a multi-hop route, e.g., a geolocation, and/or a relative location or distance
an orientation, a polarization, an polarization match, a directivity of receive or transmit beampattern for the 1^{st} or 2^{nd} link of the relay
an implemented or supported TDD frame structure,
a supported relay mode,
a multi-path support such as
a direct and at least one indirect path to the other device; or
at least two indirect paths to the other device;
wherein an indirect path is a non-3GPP path or a 3GPP path not based on Sidelink;
a path property or path-segment property
a beam ID,
a frequency shift, and
a jitter

Implementation 15. The relay device of implementation 14, wherein the relay device is configured for signalling the capability information responsive to receiving a discovery message.

Implementation 16. The relay device of implementation 14 or 15, wherein the relay device is configured for including the capability information into a signal received from another device responsive to a discovery message received by the other device; wherein the relay device is adapted for forwarding the obtained signal within the wireless communication network.

Implementation 17. The relay device according to any one of the preceding implementations, wherein the relay device is adapted for signalling an availability information of the relay device to another device, e.g., a gNB, the availability information indicating a functionality of the relay device to provide for a capability in the wireless communication network, e.g., after being configured accordingly.

Implementation 18. The relay device according to any one of the previous implementations, wherein the relay device is to signal capability information and/or availability information on a device level, on link-level or on a group-of-link-level.

Implementation 19. The relay device according to any one of the previous implementations, wherein the relay device is to provide for at least one of a combiner of different path segments into a combined path segment; a splitter of a first path segment into at least two path segments; and a mesh into a particular direction of the wireless communication network.

Implementation 20. The relay device according to any one of the previous implementations, wherein the relay device is to provide for a path segment in the wireless communication network that provides for a redundant path or a path diversity for at least one end-to-end link of the wireless communication network.

Implementation 21. The relay device according to any one of the previous implementations, wherein the relay device is configured for receiving a wireless receive signal to be relayed through a unidirectional or a bidirectional path segment; and/or wherein the relay device is configured for transmitting a wireless transmit signal relaying a receive signal through a unidirectional or a bidirectional path segment.

Implementation 22. The relay device according to any one of the previous implementations, wherein the relay device is to operate a path segment based on an associated parameter that relates to at least one of a quality of service, a priority, a redundancy, and a latency of a relayed signal.

Implementation 23. The relay device of one of previous implementations, being configured for signalling a capability information of the relay device responsive to receiving a discovery message from another device in the wireless communication network, wherein the relay device is configured for skipping signalling the capability information based on a connection state of the relay device, e.g., having connectivity above or below a connectivity threshold.

Implementation 24. The relay device according to one of previous implementations, wherein the relay device is configured for signalling a status information of the relay device to another device, the status information indicating a status of the relay device.

Implementation 25. The relay device of implementation 24, where the status information comprises at least one of:
a battery status;
a load status;
a priority of traffic or applications providing the traffic;
access information relating to an access to a relay service;
access restriction information relating to a restriction of access to a relay service;
a reference signal received power, RSRP;
an received signal strength indicator, RSSI;
a parameter or flag recognised by the relay and indicating at least one of:
a capability of further relays;
a communication needs of a device using the relay device, e.g., a UE;
a list of connected relays and/or devices per relay;
a mobility information indicating a mobility of the relay device.

Implementation 26. The relay device according to one of previous implementations, configured for receiving the wireless receive signal and/or for transmitting the wireless transmit signal as an optical/photonic signal, e.g. laser beam, free-space optics, infrared (IR), visible light communication (VLC) or a radio frequency signal, e.g. HF, VHF, UHF, micro-wave, millimeter-wave, (sub-) THz.

Implementation 27. The relay device according to one of previous implementations, configured for relaying the wireless receive signal as a first wireless receive signal along a first path of a wireless communication network; and configured for relaying a second wireless receive signal along a different second path of the same or a different wireless communication network, the first path and the second path maintained simultaneously or sequentially.

Implementation 28. The relay device of implementation 27, wherein the relay device is configured for relaying signals along the first path in a first operation mode and for relaying signals along the second path in a different second operation mode.

Implementation 29. The relay device according to one of previous implementations, wherein the relay device is configured for providing a retransmission of the wireless transmit signal on a HOP basis, e.g., based on a HARQ procedure.

Implementation 30. The relay device according to one of previous implementations, wherein the relay device is configured for relaying the wireless receive signal along different paths or path segments in the wireless communication network.

Implementation 31. The relay device according to one of previous implementations, configured for selecting at least one selected path from a plurality of paths between the relay device and a sink device or a further relay device based on a property of the path; and transmitting a signal along the selected path; or
configured for selecting at least one selected path segment from a plurality of path segments between the relay device and a sink device or a further relay device based on a property of the path segment; and transmitting a signal along the selected path segment.

Implementation 32. The relay device of implementation 31, wherein the relay device is to select the selected path or path segment based on a decision of the relay device or based on a decision received from a deciding entity.

Implementation 33 The relay device according to one of previous implementations, configured for establishing a Uu connection with a user equipment of the wireless communication network and for transmitting the wireless transmit signal to user equipment or receiving the wireless receive signal from the user equipment

Implementation 34. The relay device according to implementation 33, wherein the Uu connection is a first Uu connection, the relay device being configured for establishing a second Uu connection with a further device such as a base station, a relay device or a user equipment, wherein the transceiver is configured for receiving the wireless receive signal and transmitting the wireless transmit signal using the first and the second Uu connection.

Implementation 35. The relay device according to one of previous implementations, configured for receiving the wireless receive signal using a first PC5 connection established with a first device and for transmitting the wireless transmit signal using a second PC5 connection established with a second device.

Implementation 36. The relay device according to implementation 35, wherein the first device is a relay device or a user equipment; and wherein the second device is a relay device or a user equipment.

Implementation 37. The relay device according to one of previous implementations, wherein in one of the relay modes the relay device is configured for simultaneously relaying signals in uplink and downlink.

Implementation 38. The relay device according to one of previous implementations, wherein in one of the relay modes the relay device is configured for simultaneously relaying signals only in one of uplink and downlink, e.g., as a part of a multi-TRP configuration.

Implementation 39. The relay device according to one of previous implementations, configured for receiving, e.g., from a base station, a information indicating a configuration of resources of a sidelink; and from broadcasting, groupcasting or unicasting a resource pool configuration based on the information indicating a configuration of resources of a sidelink.

Implementation 40. The relay device according to one of previous implementations, configured for monitoring a link property such as capacity, load, throughput, of a first link used for receiving the wireless receive signal or of a second link used for transmitting the wireless transmit signal and for providing a report indicating the property.

Implementation 41. The relay device according to one of previous implementations, configured for receiving the wireless receive signal from a first wireless communication network and to transmit the wireless transmit signal to a different second wireless communication network;

Implementation 42. The relay device according to implementation 41, wherein the relay device implements a bridge between the first and second wireless communication network.

Implementation 43. The relay device according to one of previous implementations, configured for receiving at least one of:
a relay wake up message;
a go-to-sleep message;
a paging message; and
a configuration message; and
for operating accordingly.

Implementation 44. The relay device according to one of previous implementations, configured for transmitting at least one of:
a relay wake up message;
a go-to-sleep message;
a paging message; and
a configuration message.

Implementation 45. The relay device according to one of previous implementations, being a user equipment, UE, for operating in a wireless communication network and for at least temporarily operating as a relay device.

Implementation 46. The relay device according to one of previous implementations, configured for using at least one of:
a non-3GPP connection, e.g., using Bluetooth, WiFi or LiFi, and
a 3GPP connection.
for receiving the wireless receive signal and/or for transmitting the wireless transmit signal.

Implementation 47. The relay device according to one of previous implementations, wherein the relay device is configured for providing at least a part of an access and mobility management function, AMF, and a location management function, LMF, for at least one device, e.g., in case of a missing backhaul link.

Implementation 48. A device configured for wirelessly communicating in a wireless communication network, e.g., as a user equipment, UE, the device configured for:
recognising a relay device in the wireless communication network and recognising a relay mode of the relay device according to which the relay device relays a wireless receive signal as a wireless transmit signal;
adapting a transmission of a wireless signal as the receive signal according to the relay mode; or adapting a reception of a wireless signal as the transmit signal according to the relay mode.

Implementation 49. The device of implementation 48, wherein the device is configured for:
performing a relay candidate discovery, e.g. based on one or more of a proximity, location, reception/transmission range, reception conditions;
detection of a pre-configured relay device or relay capability;
signalling, to the relay device, information indicating a communication need, e.g., UE to relay, the communication need comprising at least one of:
   a need for network access;
   a need for internet access;
   a need for transmission of emergency message;
   a need to establish a communication link to a target device or target address;
   a data rate and/or QoS;
   a latency requirement; and
   a device capability such as a waveform parameter, a frequency band, a MIMO capability.

Implementation 50. The device of implementation 49, wherein the relay capability relates to one or more of a positioning anchor, an internet access point, a time of availability thereof, a message storage capability a logging capability, a forwarding capability.

Implementation 51. The device of one of implementations 48 to 50, configured for recognising the relay device based on at least one of information indicating a configuration of resources of a sidelink or a resource pool configuration.

Implementation 52. The device of one of implementations 48 to 51 configured for discovering and/or connecting to the relay device in an Ad hoc mode

Implementation 53. The device of one of implementations 48 to 52, wherein the device is configured for recognising a first relay device for a first path or a first direction of a first wireless signal of the device; and to connect to the first relay device; and, in parallel, for recognising a second relay device for a second path or a second direction of a second wireless signal of the device; and to connect to the second relay device

Implementation 54. The device of one of implementations 48 to 53, wherein the device is to monitor an operation of a relay device according to one of implementations 1 to 47.

Implementation 55. The device according to implementation 48, wherein the device is configured to:
digitize a signals received from or transmitted to the relay device; and configured for monitoring an information such as a KPI and/or an event related to links to neighbouring nodes and or a further node one or more hops away.

Implementation 56. The device of implementation 39, configured for reporting a report based on the monitoring automatically or on demand.

Implementation 57. The device of one of implementations 48 to 56, configured for establishing a first connection to a first relay unit; and to discover a second relay unit that is connected to the same or another basestation; and to establish a second connection to the second relay unit to obtain an improved link to the basestation or a target device (e.g. a cloud service in the internet) when compared to the first connection; and to release the first connection.

Implementation 58. The device of implementation 57, wherein the first relay unit is formed by a first set of relay devices comprising at least one relay device; and wherein the second relay is formed by a second set of relay devices comprising at least one relay device

Implementation 59. The device of one of implementations 48 to 58, configured to signal a relaying capability information related to the device to a relay device connected with the device and/or to a basestation, e.g., to allow forwarding of the relaying capability information to the relay device.

Implementation 60. The device of one of implementations 48 to 59, wherein the device is configured to signalling a relay capability information that includes one or more of:
a relay node capability to UE, network and/or other relays, e.g., a concatenation of relays or meshing;
a supported relaying mode of the device, e.g., single hop, multi hop, supported number of connected devices such as UEs,
a supported processing time/tolerated latency;
a supported frequency band for relaying; and
information indicating a difference of a parameter between a direction from a relay device to the network on the one hand and from the relay to a UE on the other hand.

Implementation 61. The device according to one of implementations 48 to 60, configured for selecting at least a selected path segment of a path from a plurality of paths between the device and a sink device based on a property of the path; and transmitting a signal along the selected path.

Implementation 62. The device according to implementation 61, configured for selecting the selected path segment based on a report indicating a property such as capacity, load, throughput of a link providing the path segment.

Implementation 63. The device according to one of implementations 48 to 62, configured for establishing a Uu connection with the relay device.

Implementation 64. The device according to one of implementations 48 to 63, being provided with service by a first mobile network operator, MNO, wherein the relay device is provided with service by a second mobile network operator, MNO.

Implementation 65. A device configured for wirelessly communicating in a wireless communication network, e.g., as a user equipment, UE, or a base station, the device configured for:
selecting at least a selected path segment of a path from a plurality of paths between the device as a source device and a sink device based on a property of the path; and
transmitting a signal along the selected path.

Implementation 66. The device according to implementation 65, wherein the device is configured to include, into the signal, path information indicating the selected path or path segment to indicate at least a part of the path to a relay device relaying the signal towards the sink device.

Implementation 67. The device according to implementation 66, wherein the path information comprises a branch-ID indicating a branch or segment of the path between two hops of the path; or comprises a path ID indicating the path.

Implementation 68. The device according to one of implementations 65 to 67, wherein the device is configured for selecting the path or path segment based on one of:
a quality requirement of the signal;
a level of quality provided by at least a part of the path or segment thereof;
a number of HOPs of the path or segment thereof;
a supported throughput in at least one direction of at least a part of the path;
a data rate supported by a node forming a node of the path;
a mobility of a node forming a node of the path;
a link metric associated with the path used specifically for Sidelink
a link metric used for non-terrestrial networks, NTN, communication
measurement data available at the device
a headroom/margin of a quality or control parameter.

Implementation 69. The device according to one of implementations 65 to 68, wherein the device is configured for transmitting a discovery message to request information indicating at least a path or a path segment of the wireless communication network that is supported by a receiving node.

Implementation 70. The device of one of implementations 65 to 69, configured for recognising a relay device in the wireless communication network and for recognising a relay mode of the relay device according to which the relay device relays a wireless receive signal as a wireless transmit signal; wherein the device is configured for adapting a transmission of a wireless signal as the receive signal according to the relay mode; or adapting a reception of a wireless signal as the transmit signal according to the relay mode.

Implementation 71. A wireless communication network comprising at least one relay device according to one of implementations 1 to 47.

Implementation 72. The wireless communication network according to implementation 71, comprising a plurality of relay devices configured for jointly relaying a signal in the wireless communication network via a plurality of hops.

Implementation 73. The wireless communication network according to implementation 71 or 72, comprising a plurality of relay devices configured for jointly relaying a signal via alternative routes in the wireless communication network.

Implementation 74. The wireless communication network according to implementation 73, configured for operating the plurality of relay devices in a multi transmission-reception-point, TRP, configuration for jointly receiving a message from a device or for jointly transmitting a message to the device.

Implementation 75. The wireless communication network according to one of implementations 71 to 74, configured for relaying a signal between a first device and a second device via the relay device; wherein the wireless communication network is configured to adapt an operation of the first device, the second device and/or the relay device according to the respective capability of another device.

Implementation 76. The wireless communication network according to one of implementations 71 to 75, wherein the wireless communication network is adapted for a detection or identification of the relay device as a relay candidate of a set of relay candidate devices for a future relaying of a signal, the detection being based one or more of:
a blind detection
a known location of the relay device
an omniscient detection

Implementation 77. The wireless communication network according to implementation 76, wherein, based on the detection, the wireless communication network, e.g., a relay control entity, is configured for selecting a relay device from the set of relay candidate devices for a use of the relay device in at least one route of the wireless communication network; and to configure the selected relay candidate devices accordingly.

Implementation 78. The wireless communication network according to one of implementations 71 to 77, wherein, based on the detection, the wireless communication network, e.g., a relay control entity, is configured for activating and/or deactivating at least one relay device.

Implementation 79. The wireless communication network according to one of implementations 71 to 78, wherein, based on the detection, the wireless communication network, e.g., a relay control entity, is configured for configuring at least one relay device.

Implementation 80. The wireless communication network according to one of implementations 71 to 59, wherein, based on the detection, the wireless communication network, e.g., a relay control entity, is configured for synchronising a set of relay devices of the wireless communication network.

Implementation 81. The wireless communication network according to one of implementations 71 to 80, wherein, based on the detection, the wireless communication network, e.g., a relay control entity, is configured for clustering a set of relay devices of the wireless communication network.

Implementation 82. The wireless communication network according to one of implementations 71 to 81, wherein, to operate the at least one relay device, the wireless communication network is adapted for a signalling at least one of:
relay specific RS, beacons or pseudo-IDs to be shared between network entities including gNBs, UEs and/or at least one relay;
a wakeup signal from the UE that forces sleeping relays to identify themselves;
network to UE/gNB signalling for configuration to detect and identify relays and their capabilities;
network to UE/gNB signalling on relay detection measurement procedure;
Measure and process, analyse, logging and reporting;
relay candidate negotiation between UE, gNB and relay (network controlled or directly driven by UE or coordinated by gNB);
signalling to UE and relay to configure relay mode, (de)-activation/deactivation;
synchronization signal for ad-hoc relaying networks that are, e.g., not GPS synchronized such as indoor;
inter relay network communication signal, which may be different to a normal gNB UE link, e.g., similar to IAB signal relaying; and
prediction signalling for moving relays (information on current location and estimated location in some seconds) to even allow a short-term usage of the moving relay (with fast moving relays a store and forward relaying may be done to the next gNB).

Implementation 83. The wireless communication network according to one of implementations 71 to 82, wherein the wireless communication network is adapted for performing a relay candidate discovery, e.g. based on one or more of a proximity, location, reception/transmission range, reception conditions.

Implementation 84. The wireless communication network according to one of implementations 71 to 83, wherein the wireless communication network is adapted for a detection of the relay device and a discovery procedure of the relay device based on the detection, the discovery procedure comprising one or more of:
reading out, e.g., receiving a capability signal, the capabilities of relays;
reading out, e.g., by receiving a signal from the device, a communication need of the device, e.g., a UE
reading out a list of connected relays/devices per Relay
calculating communication/relay routes to fulfil the communication needs, e.g., by considering a cost function
performing a relay selection, e.g., per communication route
performing a multi-hop path selection
performing a resource assignment such as a resource pool, a slot structure, a relay role along a multi-hop trace
signalling the result to the Relays/UEs e.g., per path or path segment

Implementation 85. The wireless communication network according to one of implementations 71 to 84, configured for organising, on a network side, a relaying frequency reuse.

Implementation 86. The wireless communication network according to one of implementations 71 to 85, configured for combining information of each relay device, and end-devices of a link such as basestations and/or UEs, in the network; and for determining a layout topology or routing topology of the network.

Implementation 87. The wireless communication network according implementation 86, configured for determining the layout topology or routing topology of the network based on a mobility of at least some of the relay device and/or the end-devices.

Implementation 88. The wireless communication network according implementation 86 or 87, configured for distributing, at least in parts, the determined layout topology within the network.

Implementation 89. The wireless communication network according to one of implementations 86 to 88, wherein the layout topology comprises a mesh-structure

Implementation 90. The wireless communication network of one of implementations 71 to 79, adapted to transmit a discovery message to a relay device and to receive a capability information responsive to the discovery message to obtain information about a capability of the relay device and/or about an identifier identifying at least a segment of a path provided by the relay device

Implementation 91. The wireless communication network of one of implementations 71 to 90, wherein the wireless communication network, e.g., a source device or a base station is configured for controlling different relays along a same path or path segment to provide for a multi-hop relaying.

Implementation 92. The wireless communication network of implementation 91, wherein the wireless communication network is adapted to control the relay devices into a same or different relay modes.

Implementation 93. The wireless communication network of implementation 91 or 92, wherein the wireless communication network is adapted to control the relay devices based on a relay capability of the relay devices.

Implementation 94. The wireless communication network according to one of implementations 71 to 93, comprising a path using radio frequency, RF, link and/or a path using a cable-less media, e.g., for transmitting optical signals.

Implementation 95. The wireless communication network according to one of implementations 71 to 94 adapted to evaluate a report indicating a property such as capacity, load, throughput, of a link providing a path segment for relaying a message of the wireless receive signal and for selecting a route of the receive signal through the wireless communication network based on the report, e.g., in a centralised, decentralised, partially autonomous or autonomous manner.

Implementation 96. A method for operating a relay device configured for a plurality of relay modes so as to relay a wireless receive signal as a wireless transmit signal, the method comprising:
changing an operation of the relay device to at least one of the plurality of relay modes responsive to a control signal.

Implementation 97. A method for operating a device for wirelessly communicating in a wireless communication network, the method comprising:
recognising a relay device in the wireless communication network and recognising a relay mode of the relay device according to which the relay device relays a wireless receive signal as a wireless transmit signal; and
adapting a transmission of a wireless signal as the receive signal according to the relay mode; or adapting a reception of a wireless signal as the transmit signal according to the relay mode.

Implementation 98. A device configured for wirelessly communicating in a wireless communication network, e.g., as a user equipment, UE, or a base station, the device configured for:
selecting at least a selected path segment of a path from a plurality of paths between the device as a source device and a sink device based on a property of the path; and
transmitting a signal along the selected path.

Implementation 99. A computer readable digital storage medium having stored thereupon a computer program having a program code for performing, when running on a computer, a method according to one of implementations 96 to 98.

Some embodiments of the present invention in particular relate to wireless communication provided between a terrestrial unit like an IoT device or in particular a user equipment, or a base station on the one side and a spaceborne transceiver like a satellite, s space station or spaceship on the other side. Instead or as an alternative to a satellite an uncrewed aerial vehicle, UAV, may be used.

In view of the above-identified drawbacks of limitations as well at the spaceborne side and at the terrestrial side, communication between devices may benefit from using a transceiver or relay device. Different modes of relaying a signal between terrestrial devices are known, e.g., an amplify and forward mode, a band switch amplify and forward mode, a digitise and forward mode or a store and forward mode. Embodiments of the present invention relate to relay devices for providing at least a path or a multipath component between devices. Some embodiments relate to relaying signals between flying transceivers, in particular spaceborne transceivers such as satellites/UAV and terrestrial transceivers, amongst them mobile and immobile transceivers, in particular but not limited user equipment, UE.

Relaying for cellular technologies is currently defined as centrally-coordinated, terrestrial relaying, in which the base station (BS) defines resources that are used by the relay for the relaying of the signal. This is done in a decode-and-forward or amplify-and-forward manner. The relay is either used as an alternative transmission path or as a range extender for the BS (integrated access and backhaul (IAB) or sidelink). In IAB the BS is called a donor node as it reserves some of its resources to be used by the relay for the purpose of relaying. [TS 138 174 V16.7.0]

Currently the, relevant topic discussed in 3GPP standardisation is that of sidelink relaying which is a type of device-to-device relaying supporting only one device at a time.

Non-terrestrial network, NTN, standard does not support relaying up to Rel-17 and Rel-18. Due to restricted spectrum resources, a coexistence of NTN and terrestrial networks is not yet considered in frequency range 1 (FR1). Regardless of this however, Mediatek has proposed the investigation of spectrum coexistence with an initial focus on FR1 [RWS-230110]. In frequency range 2 (FR2), at least a limited coexistence in FR2 is considered possible.

The contribution by the satellite industry does not propose relaying for Rel-19 [RWS-230048], but either gNB on board of a satellite, or at least gNB-DU on board with CU-CP on ground.

3GPP does not consider MIMO over satellite, but selects the polarization (RHCP, LHCP). This is currently being considered by 5GAA (=single input single output, SISO, operation of a NTN terminal).

In IEEE, relaying is considered in IEEE 802.11p which represents a CSMA based relaying of broadcast messages.

In the case of geostationary earth orbiter, GEO, satellites, communication to satellites is either ensured by large terminals, and in the best-case nomadic terminals, fitted with highly directive antennas. These either employ no form of MIMO at all or, when they do, use different polarizations to establish a MIMO link to the satellite. The benefit which could be achieved by this sort of MIMO was analysed in the ESA project MIMOSA. The MIMO channel for this transmission is limited to 2×2 MIMO, with limited MIMO gain.

In case of LEO and MEO satellites massive MIMO has been proposed for the downlink to enhance the throughput data rate [1].

Reference [2] also handles the subject but aims at optimizing the network throughput.

References [3], [4], [5] analyse the MIMO gain which is achievable by a certain satellite constellation.

Reference [6] assumes a GEO satellite as a relay for LEO satellites.

References [7] and [8] introduce relay links to LEO satellites from High Altitude Platforms, but target BS to high altitude platform (HAP) communication.

The idea is to enable an additional layer in the discussed xG-NTN-3D constellations, a distributed terrestrial repeater/aggregator layer which is capable of serving as a distributed smart antenna array that also has the potential of combining satellite and terrestrial communications.

Some embodiments of the second aspect relate to two main technical aspects and their combination:
1. Relay with a capability to provide a duplex translation between TDD and FDD, e.g. to relay a terrestrial link between a UE and a relay operated in TDD to a satellite link between the relay and a gNB via a satellite or UAV operating in FDD.
2. Relay or a multitude of (distributed) relays to provide an adaptation or translation functionality for spatial degrees of freedom (MIMO) and bandwidth to be used e.g., between indoor and outdoor radio resources, when e.g. the spatial degrees of freedom are limited on one of the two links (e.g. indoor link vs. outdoor link or first vs. second hop). This solution enables cell free operation of the ground segment (relay-UE link) which is, in addition, MNO independent. In contrast to that a simple indoor to outdoor relaying would not be able to maximize or optimize the spatial stream performance and might suffer from impairments such as the keyhole effect. Additionally, a layer 3 relaying would cause excess delay due to the necessity to decode and would be provider specific.
3. Combinations of 1 and 2: Example is given by a remote local manufacturing or building site operating on 5G-NR devices (TDD) without NTN capabilities. Locally-installed relays which are able to handle TDD towards the UEs on ground and handling FDD satellite or UAV links towards the network side. A particular difference to SOTA layer 3 relays is that a transparent translation of TDD to FDD resources is performed allowing a significant reduction of latency and relaying without the need for decoding. Furthermore, a distribution of relay nodes may provide macro diversity on the TDD link and therefore higher order MIMO layers for a particular UE or a group of UEs.

For example, a relay device presented herein may be adapted for relaying between a terrestrial and a non-terrestrial communication link. The aspects described above represented in the finding underlying the present invention that wireless communication may benefit from changing a signal representation of a relayed signal when relaying the signal.

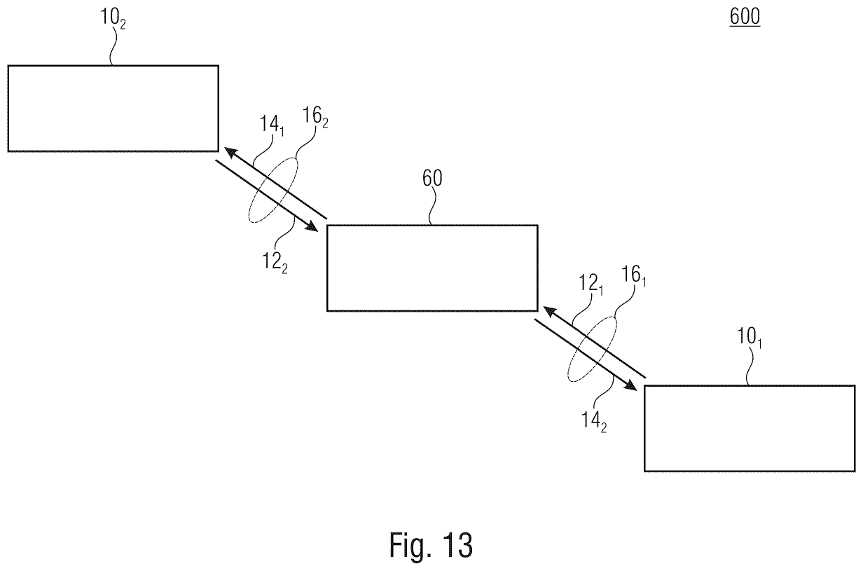

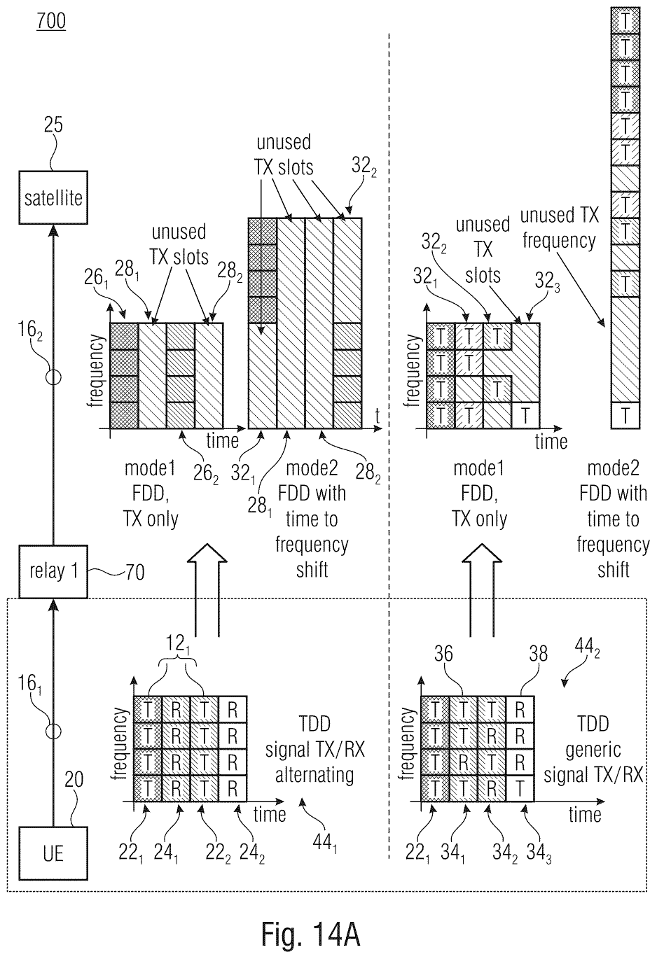

According to an embodiment, a relay device such as a relay device shown in FIG. 13 is provided. In FIG. 13, a part of a wireless communication network 600 is shown. A transceiver, e.g., a relay device 60 according to an embodiment is configured for relaying a wireless receive signal 12₁ as a wireless transmit signal 141. For example, the wireless receive signal 12₁ may be received from a device 10₁ and the wireless transmit signal 141 may be transmitted to a device 10₂. Alternatively or in addition, the relay device 122 may receive a wireless receive signal 122 from device 10₂ and may transmit, based on the wireless receive signal 122 a wireless transmit signal 142 to the device 10₁ or to a different device. When compared to the wireless receive signal 121, the wireless transmit signal 141 may comprise a different signal domain representation and/or the wireless transmit signal 142 may comprise a different signal domain representation when compared to the wireless receive signal 122.

The transceiver/relay device 60 is configured for mapping the wireless receive signal 12₁ from the first signal domain representation to the second signal domain representation of the wireless transmit signal 141 when relaying the wireless receive 121. For relaying the wireless receive signal 122, the relay device 60 may operate accordingly. The wireless receive signals 121 and 122 may each be received in different domains including a spectral domain, a temporal domain, a spatial domain and/or a polarization domain. Such a consideration or representation may also include several of the mentioned domains, i.e., a combination thereof. A swapping or a mapping from the signal domain representation of the wireless receive signal 12₁ or 122 to the signal representation of the wireless transmit signal 14₁, 14₂ respectively may lead to the effect that the wireless transmit signal has a different appearance when transmitted and viewed or represented in these domains. This may be understood that it is possible but not necessary that the relay device maps the receive signal 12₁ from a single domain such as spectral, temporal, spatial and polarization and/or other representation domains to a single different domain. It is preferred that the signal domain representation between the wireless receive signal and the resulting wireless transmit signal is changed across at least two, three or even all four of the mentioned domains. According to an embodiment, the first signal representation and the second signal representation differ from each other in at least two of:
a time domain (e.g. delay, repetition, store and forward);
a delay domain (e.g. cyclic delay diversity, delay precoding in orthogonal time frequency space, OTFS);
a frequency domain (e.g. frequency translation);
a Doppler domain (e.g. Doppler precoding in OTFS);
a power domain (e.g. amplification through repeaters);
an energy domain (e.g. distribution of signal power over time and frequency);
a code domain (e.g. different spreading and scrambling sequences, fountain codes or code rates the Code domain may include different code rate as well, i.e. different Modulation and/or Coding schemes MCS index);
an orbital angular momentum domain;
a spatial domain (e.g. patterns, beam formers, sectors, directions);
a coverage domain (e.g. indoors, outdoors); and
a polarisation domain (e.g. linear to linear, linear to circular, circular to linear).

This may also allow that some representations may remain unchanged, not excluding that all representations may be changed when relaying a signal. That is, the receive signal can be viewed in different domains including spectral, temporal, spatial and polarisation. The swapping or mapping effectively changes the signal such that it will have a different appearance when transmitted and viewed in these domains. This may be understood as not mapping a signal from one single domain a different single domain. Instead, according to an embodiments, the relay device may change the signal representation across at least two domains. Therefore, in view of the overall list of representations the received signal may be mapped/transferred to a transmit signal such that its representation in those domains is the same or different.

The devices 10₁ and 10₂ may be wireless transmitters or transceivers. Each of the wireless transceivers 10₁ and 10₂ may be implemented independently as a terrestrial or non-terrestrial device. For example, the relay device 60 may relay signals between two terrestrial devices 10₁ and 10₂ such as a UE or between two non-terrestrial devices such as satellites or UAVs. In a preferred embodiment, the relay device 60 is adapted to relay signals between a non-terrestrial device and a terrestrial device such as a UE. That is, according to an example, one of the devices 10₁ is a terrestrial UE and the other device from the group of devices 10₁ and 10₂ may be a spaceborne transceiver.

A direction along which the relay device 60 is capable of relaying signal may be unidirectional or bidirectional of higher order. For example, a link 16₁ between the relay device 60 and the device 10₁ may be a unidirectional or a bidirectional link. A link 16₂ between the relay device 60 and the device 10₂ may be, independently from a unidirectional or bidirectional implementation of link 16₁, unidirectional or bidirectional. In case of both links 16₁ and 16₂ being bidirectional, a bidirectional communication between devices 10₁ and 10₂ may be supported by relay device 60. That is, the relay device 60 may provide for an unidirectional or bidirectional link between devices 10₁ and 10₂. According to an example, the relay device may provide the communication between the devices 10₁ and 10₂, at least in an uplink direction or a downlink direction between the device 10₁ and 10₂, unidirectional, wherein an implementation of both may allow for a bidirectional communication.

According to an embodiment, the relay device 60 is configured for performing, by the relaying provided by relay device 60, a mapping between a first duplex scheme of the first link between device 10₁ and the relay device 60 and a second duplex scheme of the link 60₂ between device 10₂ and the relay device 60. Device 10₂ may be a single device but may also comprise a group of devices, e.g., for implementing a groupcast, a multicast or a broadcast scenario. As a duplexing, there may be understood a mapping onto shared resources, e.g., in the time/frequency domain to separate uplink and downlink resources. For example, the relay device 60 may be adapted to translate or remap between different duplex schemes implemented in links 16₁ and 16₂, e.g., to conserve a throughput and/or a latency or other quality parameters. Alternatively or in addition, the relay device 60 may puncture a link and add the redundancy information on the other link.

According to an example, the relay device 60 may be configured for mapping between a time division duplex, TDD, scheme of a time domain and a frequency division duplex, FDD, a scheme of a frequency domain when relaying the wireless receive signal. For example, the relay device 60 may be configured for operating one of the links 16₁ and 16₂ to a terrestrial UE in TDD and another link between the relay device and a satellite or a UAV in FDD. That is, when relaying the receive signal, e.g., receive signal 12₁, same may be mapped to a TDD scheme and the relay device 60 may transmit the wireless transmit signal 14₁ according to the FDD scheme. Alternatively, the relay device 60 may be configured for receiving the wireless receive signal 12₁ as a signal according to the FDD scheme and for transmitting the wireless transmit signal 14₁ according to the TDD scheme. Along the opposing direction from device 10₂ towards the device 10₁, a similar approach may be implemented.

Beyond those single-domain adaptations, the relay device 16 may be configured for mapping between a time division duplex, TDD, scheme of a time domain and a space division duplex, SDD, of a spatial domain when relaying the wireless receive signal. Alternatively or in addition, the relay device 16 may be configured for mapping between the FDD scheme and the SDD scheme when relaying the wireless receive signal 12₁ and/or 12₂.

According to an example, the relay device 60 may be configured for receiving the wireless receive signal 12₁ and/or 12₂ as a signal according to the SDD scheme and for transmitting the wireless transmit signal 14₁, 14₂ respectively according to the FDD scheme.

NTN Relaying Node with MIMO Capability

### Simple Relay Principle

An illustrative and possible simple approach for obtaining a solution for the underlying technical problem may be considered as a single repeater such as relay device 60, which can be used or operated to highlight part of the principle. This may relate to an operation according to an amplify-and-forward repeater, a digitize-and-store/forward repeater or a decode-and-store/forward repeater. The latter may be more or less similar to an intermediate/remote base station, which simply transfers the terrestrial communication to the satellite/UAV communication path.

The relay device 60 may provide on the first hand a power benefit. The UE only needs to reach the relay device 60, which may have less or even no power source limitations and may take care of the communication to the other end, e.g., the satellite or UAV. Additionally, the relay device 60 may adapt the protocol such that it is complying with NTN requirements, e.g., requiring decode and forward or at least digitize and forward. Therefore, according to an embodiment, the relay device 60, e.g., as a repeater may act as a fixed position UE, which provides UE-UE relaying to the mobile node. This may resemble the satellite/UAV or the feeder station to act similarly to an IAB-donor node. This may impact the system in such a way, that increasing the number of UEs could consume the resources of the satellite/UAV system. Each UE would thus require the resources both on the UE-relay link and on the relay-satellite or relay-UAV link. This may be addressed by including a frequency shift, so that the time-frequency resources of the UE-relay link, e.g., link 16₁ and the relay-satellite/UAV paths, e.g., link 16₂ are independent of each other. For example, based on an assumed higher altitude position of the relays and the satellites/UAVs, the issue of interference of the relay-satellite/UAVs link with terrestrial communication can be reduced via beamforming. For example, with higher altitude relays the antennas patterns of the relay may act as a separator between the terrestrial system and the satellite system, assuming that the terrestrial Tx signal is not powerful enough to reach the satellite and other way around that the satellite signal is not strong enough to affect the terrestrial UEs.

As indicated above, when referring to a satellite in connection with embodiments, in particular in connection with a communication path making benefit from relaying, as an alternative or in addition, an UAV may be used as it may provide for similar characteristics, at least in parts, e.g., in view of a high possibility to provide unblocked LOS paths and the like.

Based thereon, another improvement provided by embodiments utilizes the FDD configuration of satellite transmissions. Typically the communication to a satellite follows an FDD scheme as a TDD scheme would involve unwantedly long waiting times due to the significant transmission latency introduced by the long transmission distance. Therefore, according to an embodiment, the relay device 60 may be capable of converting a TDD scheme to an FDD scheme. With this, it becomes possible to frequency shift and aggregate the transmission signals on the relay-to-satellite link and vice versa, providing that there is a duplex translation between TDD and FDD.

Depending on the Tx/Rx ratio, the TDD/FDD conversion and aggregation can be done in different ways. With a 50/50 ratio, the RX-timeslots could be used either for transmission of TX-timeslots or for the transmission of additional redundancy. This may also take a second polarization of the satellite link into account. So assuming that the bandwidth is maintained, a redundancy factor of 4 could be achieved for Tx. Assuming that the Tx/Rx ratio is not 50/50, a maximum bandwidth on the satellite side would be defined and, depending on the ratio, the transmission redundancy can be defined to fill the available transmission slots.

That is, a relay device according to an embodiment, may be configured for adapting a ratio between a first amount of wireless transmit signals that are transmitted based on a second amount of wireless receive signals. For example, the relay device may be configured for providing a predefined, e.g., maximum bandwidth for transmitting the wireless transmit signals and for using available further slots of the TDD scheme for a transmission redundancy associated with the wireless transmit signal.

According to an embodiment, the relay device may be configured for using a receive, RX time slot of the TDD scheme for a transmission of a TX time slot of the TDD scheme or for transmitting redundancy information for the wireless transmit signal. Such transmission may be directed to a transmitter of the receive signal or may be used differently. For example, other signals and/or signals to other nodes may be transmitted such as a redundancy version of the message to be provided to the final receiver using the UL slot of that device for providing the copy. This is based on the finding that, e.g., when referring to FDD and when compared to TDD, some resources of the TDD might be available for other purposes. Beside a redundancy version also type of information associated with the receive signal or a former or previous receive signal may be transmitted, e.g., a redundant copy of at least parts of the wireless transmit signal including full or partial redundancy.

Additionally or as an alternative to this, the relay device 60 may be configured to encapsulate the transmission data, i.e., payload of a receive signal to be forwarded to a satellite, into a satellite link specific protocol. This could be done even if only digitize and forward is used, possibly avoiding a decoding.

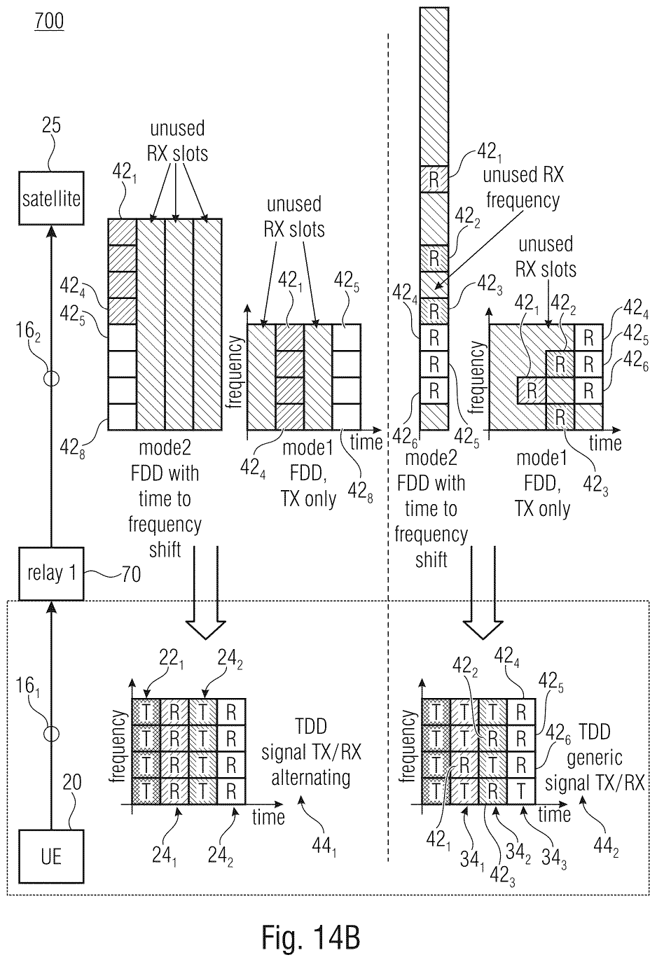

FIG. 14a shows a schematic block diagram of at least a part of a wireless communication network 700 comprising a transceiver/relay device 70 according to an embodiment that may be in accordance with relay device 60 but that has at least some further capabilities, e.g., including storing, aggregation/condensing, compression and/or mapping from time frequency resources from the TDD access link 16₁ to time frequency resources on the FDD satellite link 16₂. Link 16₁ may be an uplink between a UE 20, e.g., one of the devices 10₁ and 10₂ and link 16₂ may be a link between the relay device 70 and a satellite 25, e.g., the other one of devices 10₁ and 10₂. The UE 20 may use a TDD scheme according to which TX slots 22₁, 22₂, . . . may be provided as well as RX slots 24₁, 24₂, . . . , the slots occupying the respective assigned frequency range. Wireless receive signal 12₁ of relay device 70 may occupy TX slots 22₁ and 22₂ used by the UE 20. Accordingly, RX slots 24₁ and 24₂ may remain unconsidered for a link 16₂ where, in Mode 1 FDD TX slots 26₁ and 26₂ may be occupied whilst slots 28₁ and 28₂ may remain unused. When considering Mode 2 FDD with a time to frequency shift completely unused slots 28₁ and 28₂ may be obtained as well as partially unused 32₁ and 32₂.

Further, in FIG. 14a there is shown an alternative to the slot-wise association of resources where not only a TX slot 22₁ is present but also one or more mixed slots 34₁ to 34₃ having TX parts 36 and RX parts 38, wherein, for the uplink, only the TX parts 36 contribute to the load, leading to at least partially unused slots 32₁ to 32₃ in Mode 1 and also to unused resources in Mode 2 FDD with the time to frequency shift.

In FIG. 14b there is shown a downlink scenario using the devices corresponding to FIG. 14a. Information 42₁ to 42₈ received via link 16₂ by relay device 70 may be mapped to the TDD scheme, at least the RX slots 24₁ and 24₂. Similarly, in Mode 1 FDD although receiving the information according to a different scheme, the relay device 70 may map the information according to link 16₁.

A similar approach may be implemented in the generic TDD scheme having the mixed slots 34₁ to 34₃.

In other words, FIGS. 14a and 14b show schematic diagrams representing a frequency shift for FDD and aggregation/delayed aggregation in a simple variant with single repeater.

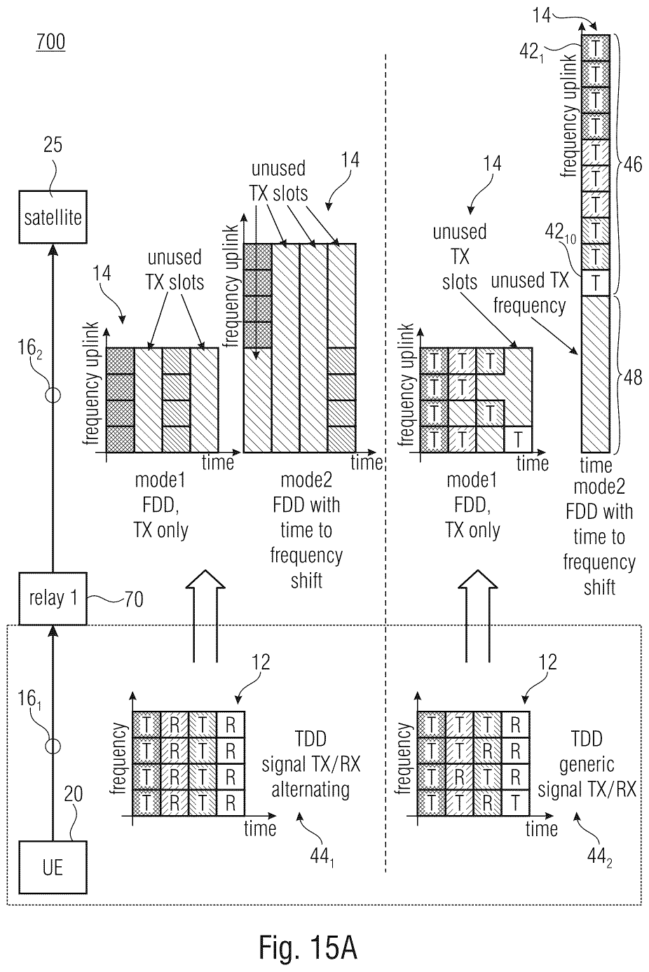

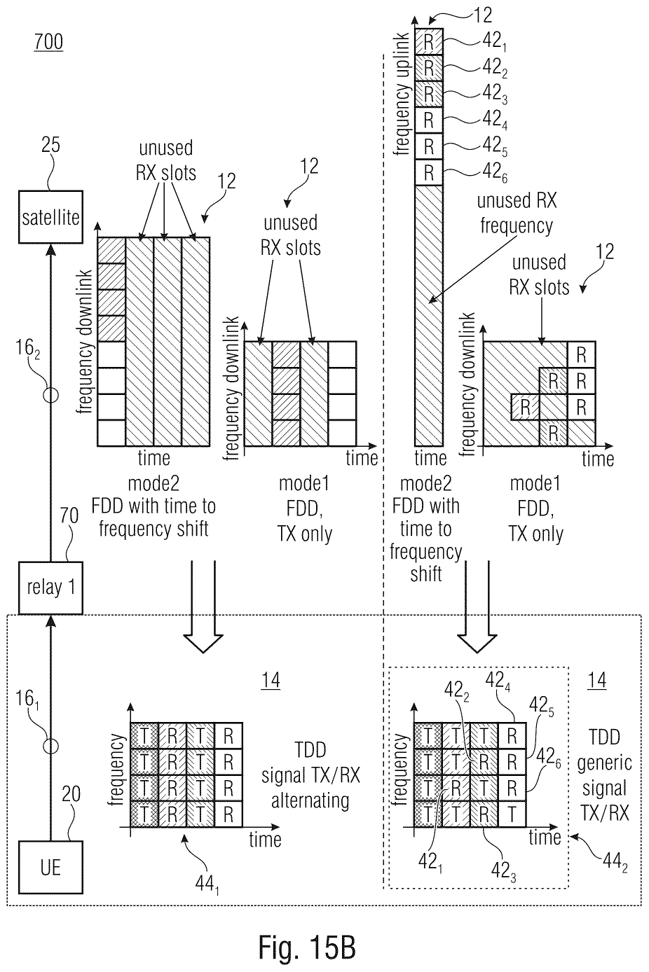

FIGS. 15a and 15b show an enhanced implementation of the wireless communication network 700 represented in FIGS. 14a and 14b, wherein FIG. 15a relates to the uplink scenario corresponding to FIG. 14a and FIG. 15b relates to the downlink scenario according to FIG. 147b. Referring to FIG. 15a, the UE may implement the TDD scheme 44₁ or the TDD scheme 44₂ that were described in connection with FIG. 14a. Especially in connection with the mixed slots 34 of TDD scheme 44₂, in Mode 2, the relay device 70 may be configured for mapping information 42₁ to 42₁₀ to a common frequency block 46 which may result in a comparatively large continuous block 48 of unused resources by relay device 70 which may allow for a high degree of freedom to use those unused resources for different purposes.

Referring now to FIG. 15b, such a result of information 42₁ to 42₆ may also be done in downlink, e.g., in Mode 2 FDD with time to frequency shift.

That is, the relay device 70 is illustrated to perform the mapping of the receive signal 12 to the transmit signal 14. Such a mapping may be managed via a given relay node which receives the corresponding data and control from a controlling entity such as a terrestrial network, TN, base station, e.g., a gNB. Therefore, the UE 20 may configure the relay node 70 or send a request to the network which takes over the configuration of the relay device 70 accordingly. This means there can be at least three ways of control, the UE-controlled relay device, the network controlled relay device or a cell controlled relay device, e.g., operating autonomously. Such a mode can be static or may be changed dynamically. For example, a relay device such as relay device 60 or 70 may operate in an autonomous mode of operation in absence of control via a base station. Alternatively or in addition, such a relay device may be configured to accept a control from a UE based on or dependent from a qualification or authorization of the base station or a network controlling entity. Other ways of switching between said operation modes may be implemented without deviating from the described embodiments.

As a result, a device such as the UE 20 may communicate with the relay device 70, according to one embodiment, only while the data link is managed in a transparent manner. The at least one relay node 70 of the wireless communication network 700 may be implemented in a fixed or mobile fashion, mounted to buildings, street furniture, uncrewed aerial vehicles, UAVs, autonomous guided vehicles, AGVs, or the like.

At least some discriminating aspects of such solutions when compared to known concepts is a TDD/FDD conversion on an amplify and forward, digitize and forward and store and/or forward basis to allow for the addition of an outer code for reliability enhancement combined with a synchronized playout of data through an unsynchronized data transmission network. Only the relays device may be required to know the resources and their time behaviour and the satellite network can be optimized regarding throughput. For this the whole relay network is synchronized via satellite (either directly or by use of an external clock such as a navigation system like GPS)

### Relay Operation

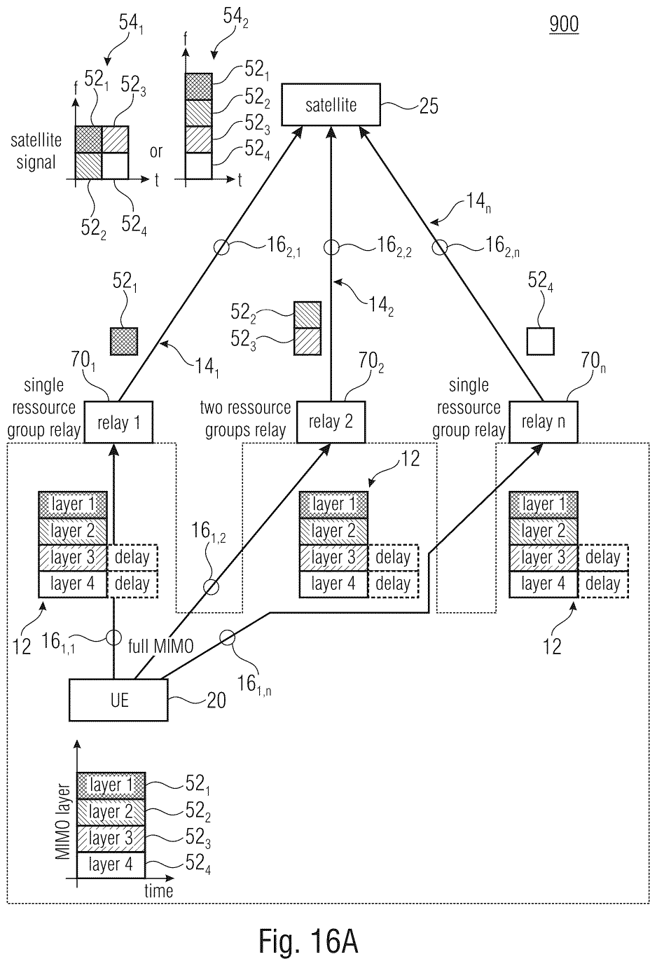

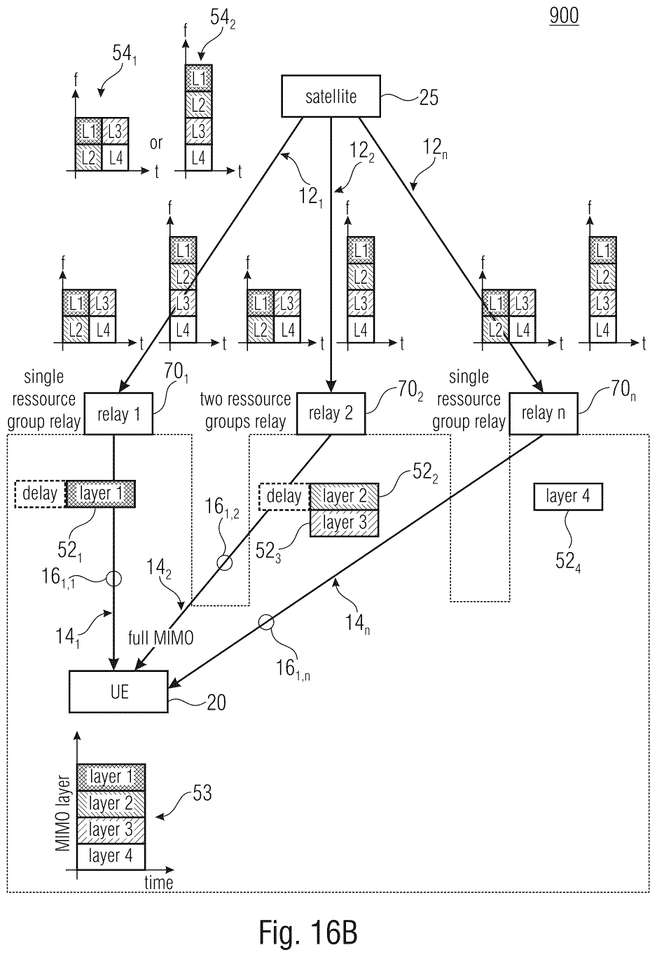

FIG. 16a-b illustrate a further improvement wherein the UE 20 is capable of making simultaneous use of multiple relays 70₁ to 70ₙ with n>1. This relies on the UE 20 being capable of configuring the relays 70₁ to 70ₙ or alternatively or in addition the gNB could also configure the relays 70₁ to 70ₙ. This could be initiated either by the UE 20 or by the not illustrated gNB (either directly or via the other partner in the communication). The relaying communication can include an also not illustrated direct UE/gNB link but this is not mandatory. Alternatively this link could even be realized via a terrestrial BS, e.g., using a split of control path and data path. Besides splitting data and control over the TN and NTN links, data which needs to be transmitted with lower delays than typically being available in NTN can be transmitted via TN.

In connection with FIGS. 16a-b, embodiments will be described according to which a relay device is presented where the receive signal 12 comprises payload data, wherein the relay device is adapted for relaying only or at least a selected part of the payload data. For example, UE 20 may use a full MIMO transmit strategy to transmit wireless receive signal 12 to the relay devices 70₁ to 70ₙ, e.g., using respective links 16₁, and by using MIMO layers 52₁ to 52ₙ, wherein, for example, four layers are presented, wherein the number four is not limiting in connection with the present embodiments. Relay 70₁ may be configured for selecting a single resource group, e.g., layer 52₁ for being forwarded with transmit signal 14₁ over link 16_{2,1}. A different relay such as relay device 70₂ may be configured for selecting different groups of resources and/or a different number of resources such as at least two layers 52₂ and 52₃ for being part of the transmit signal 14₂, possibly omitting the layers 52₁ and 52₄. A link 16_{2,2} between the relay device 70₂ and the satellite 25 may be used for transmitting transmit signal 14₂. Relay device 70ₙ may select layer 52₄ for being a part of a wireless transmit signal 14n transmitted over link 16_{2,n} to satellite 25.

The relay devices 70₁ to 70ₙ may operate in a coordinated manner such that the groups of resources 52₁ to 52₄ arrive at the satellite 25 according to a predefined signal scheme 54₁ or 54₂. That is, by use of the wireless transmit signals 14₁ to 14ₙ, a respective shift in time and/or frequency with respect to one another may be implemented.

Selection of the part may be based on a decision made at the relay device 70 and/or a configuration of the relay device based on a decision made at the configuring device. The selected part may be or may comprise
a part of the payload;
the complete payload;
an incremental replica of at least a part of the payload;
multiple redundant copies including full and partial redundancy;
Combinations of the above

In view of such a selection, it is possible to deriving a derivate from the selected part of the payload. For example, in knowledge of available resources at the link 16₂ the relay device may encode or additionally encode the payload data, e.g., to make the payload more robust for errors. Alternatively or in addition, incremental replicas may be derived and the respective subsequent increments may be transmitted in later signals, there occurring as a derivate of a former or previous receive signal. Accordingly, embodiments provide relate to a receive signal that comprises payload data; wherein the relay device is adapted to relaying a derivate of at least a part of the payload data. For example, the derivate comprises an encoded version of the payload, an incremental replica of at least a part of the payload and/or a copy of at least a part of the payload.

FIG. 16b shows a schematic block diagram of the wireless communication network 900 being illustrated in FIG. 169a for a downlink scenario whilst FIG. 16a relates to an uplink scenario. The relay devices 70₁ to 70ₙ may operate according to a predefined signal scheme 54₁ or 54₂ to select the respective portions of the receive signals 12₁ to 12ₙ such that selected portions, e.g., different layers 52 overlap at the UE according to MIMO scheme 53 to allow a proper decoding and/or reception of the overall signal. The relay devices 70₁ to 70ₙ may be adapted to select the selected part in either direction towards the UE 20 or the satellite 25 based on a transmission criterion such as a delay/latency requirement, a quality of service or a channel criterion, e.g., to select different parts for different frequency-selective channels that behave differently over the overall frequency range.

The relay devices 70₁ to 70₃ may be adapted to jointly operate in a synchronized manner, wherein at least one further relay forwards at least a part of a remaining part of the payload data.

The relay devices 70₁ to 70ₙ may be adapted for receiving the selection information, e.g., which part of the received signal and/or from which signal the relaying shall be performed and for selecting the selected part based on the selection information. Such a selection information may be received, for example from a base station or from a device transmitting the receive signal. Alternatively or in addition, the relay device may select the selected part based on autonomous operation, e.g., selecting the best part of the signal or the like.

For the terrestrial frequency band, the relays 70₁ to 70ₙ may incorporate any number of antennas to be able to fully receive the terrestrial MIMO signal. At least tow, a group or all participating relays may be synchronized and be configured in regard to resources on the UE-relay link 16₁ and also the relay-satellite 16₂ link. The relays may be utilized as follows.

In the uplink, see FIG. 16a, each relay device 70₁ to 70ₙ, referred to as rely device 70 may be configured to forward only certain resources of the overall stream (frequency, time resources). The relay device may frequency convert the user signal to a higher frequency, potentially by amplify and forward, digitize and forward or decode and forward. The relay device 70 may also store the received data for later transmission or to adapt it to a certain frequency/time-scheme (e.g. for 2×2 MIMO, 2 frequency blocks and 2 time slots for a single polarization satellite) or potentially multiple times.

The data received by a relay device 70 may also be applied with a different modulation and a different code for the satellite link 16₂ taking into account unused frequency/time resources in the satellite uplink band.

This data is transmitted at a different frequency/time resource in the satellite frequency band. Here the data may also contain resource blocks/spatial streams with information that is used to configure the relay device 70 but is not relayed to the satellite. This data is advantageously decodable by the relay when contained in the signal. A further relay device 70 may be configured to receive different resource blocks from the UE and will relay these similarly like the first relay device 70 but to a different frequency/polarization on the satellite frequency band. This may be synchronous to the received signal but may also diverge. By this a spatial and time separated information is transmitted in a frequency, time and polarization diverse way.

In the downlink, see FIG. 9b, each relay device 70 may be configured to forward only certain resources in frequency, polarization and/or time which are transmitted to the relay device 70 from the satellite 25, which may also include beamforming/spatial multiplexing towards the relay and the like. The relay device 70 then frequency converts the gNB signal to the UE's frequency, potentially by amplify and forward or by digitize and forward. The relay device 70 may also store the received data to transmit it later, potentially multiple times. The received data may also be decoded containing the UE transmit signal and potentially an additional control signal to the relay device 70 that is not forwarded to the UE 20, e.g., relaying playout time-instant information or the like. The UE signal 14₁ to 14ₙ then is transmitted at a different frequency/time resource in the UE frequency band. A further relay device 70 may be configured to receive different resource blocks from the gNB via satellite 25 and will relay these similarly like the first relay converting it to the same frequency and transmitting at the same time. Through this, spatially-separated information is generated from a frequency diverse distributed signal. That is, according to an embodiment, a relay device may be configured for relaying according to at least one of: an amplify and forward relaying; a digitize and forward relaying; and a store and forward relaying.

As another benefit, relay device 70 may be used to increase the MIMO-rank by adding “deterministic multi-path” signals instead of the line-of-sight, LOS-dominated direct link from the NTN to the UE 20. Position information of relay nodes, transmit direction-of-arrival—DoA, other transmit key performance indicators, KPIs (powers, TDD/FDD grid, . . . ) may be obtained from the location management function, LMF, other higher layer functions or from gNB. In other words, FIG. 16a-b show an example of an embodied spatial stream to frequency conversion with full MIMO. At least one MIMO layer of the UE 20 is allocated to each of the NTN-capable relays 70₁ to 70ₙ in uplink, see FIG. 16a and downlink, see FIG. 16b. As indicated by the label “delay”, at least some parts some parts of a signal, especially in link 16₁ between the UE and the relay may be subject to or tolerant for a delay. For example, delay label may be understood that the respective layer is potentially delayed, e.g., due to a store and forward relaying and to be transmitted at a later point in time.

For example, signal scheme 54₁ may show the partly delayed transmitted signal for layers 52₃ and 52₄, while signal scheme 54₂ may show the not delayed, only frequency converted signal. On the receive path shown in FIG. 16b the label delay may be understood as to align the layers so they are all transmitted at the same time. It should be understood that such a delay may also be inserted intentionally. For example, the relay device may be aware, e.g., by signal decoding or instructions received, about parts of the signal that may allow additional delay or may cope with additional delay. In case of a scenario where limited resources on the link of the wireless transmit signal the relay may select urgent parts of the signal to be transmitted immediately or at least prior to parts, e.g., layers 52₃ and 54₄ that may be delayed, e.g., based on loosened time requirements.

### Enhanced MIMO Relay

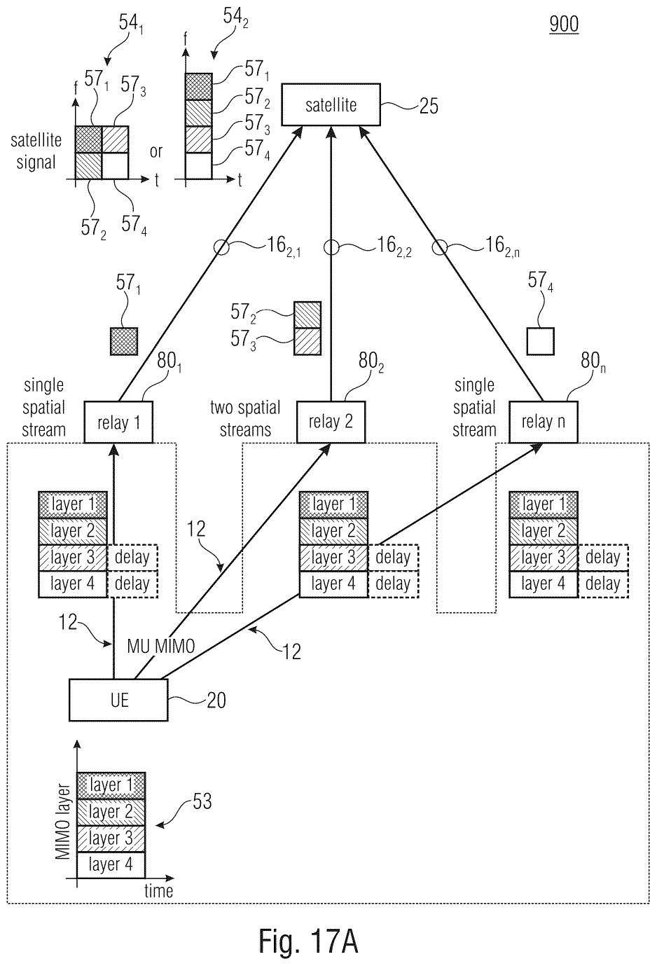

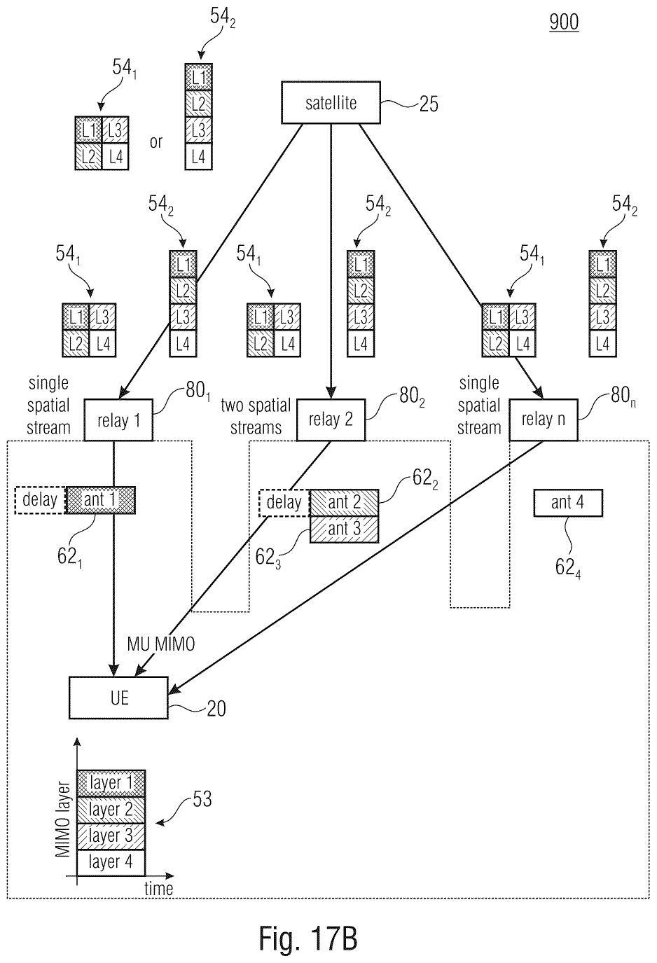

FIG. 17a-b illustrate a further variant in which the MIMO capabilities of the overall system 900 are enhanced by allowing a distributed MIMO precoding over all the available transceivers/relay devices 80₁ to 80ₙ so that they act like a single MIMO antenna array for the UE 20, the layers may the be aggregated for the satellite 25. For example, by using macro diversity precoding the Eigenvalue matrix can be forced to have full rank and is able to avoid keyhole effects. In FIG. 17a, the relay devices 80₁ to 80ₙ may use different spatial streams, e.g., by using selected antenna ports or antennas (ANT) 62 and/or beams to transmit different layers (L).

The relay devices 80₁ to 80ₙ may be similar to the relay devices 60 and/or 70, wherein each of the relay devices may use a spatial stream for each part 57₁ to 57ₙ of the wireless receive signal 12 it relays. It is to be noted that although the relays 70 and/or the relays 80 may possibly receive the same signal and select a part thereof to be forwarded, e.g., by using respective time frequency resources in FIG. 16a-b and/or by using spatial resources as in FIG. 17a-b, the UE may instead or in addition provide for individual signals to different relays. Although such a transmission of separated signals may be intransparent for the UE it may nevertheless allow to increase throughput to or from the satellite.

Yet another variant is shown in FIG. 17a-b in accordance with embodiments is to utilize the relays in a Multiuser MIMO like way. By this each relay 80 possibly receives not all spatial streams or layers but only a subset that are based, e.g., on orthogonal Eigenspace weights. These streams are treated as in the full MIMO example of FIG. 16a-b and are forwarded to the satellite 25, e.g., in an FDD manner or received from the satellite 25 in this way.

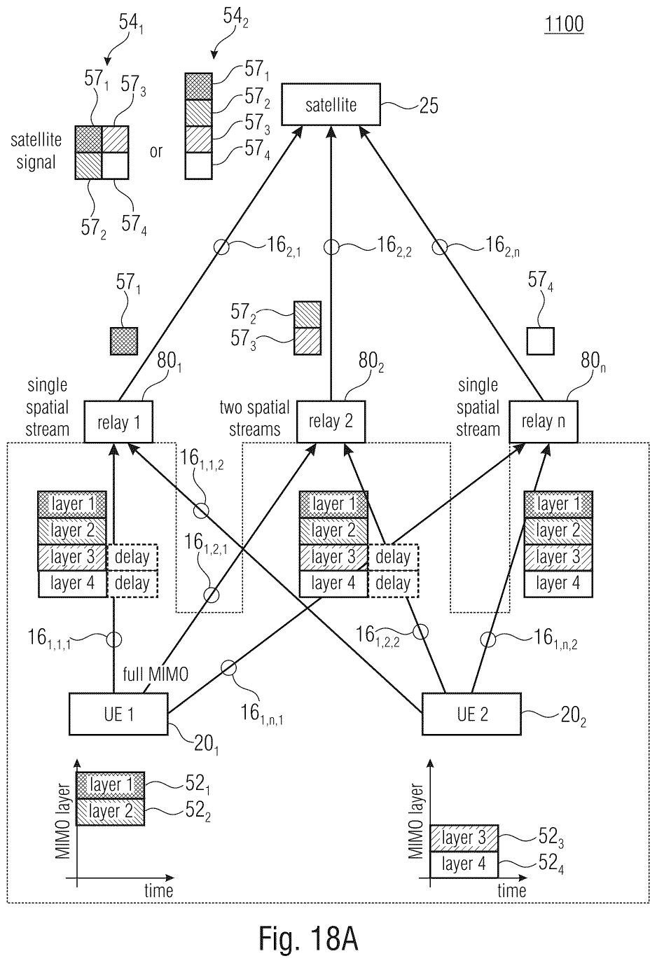

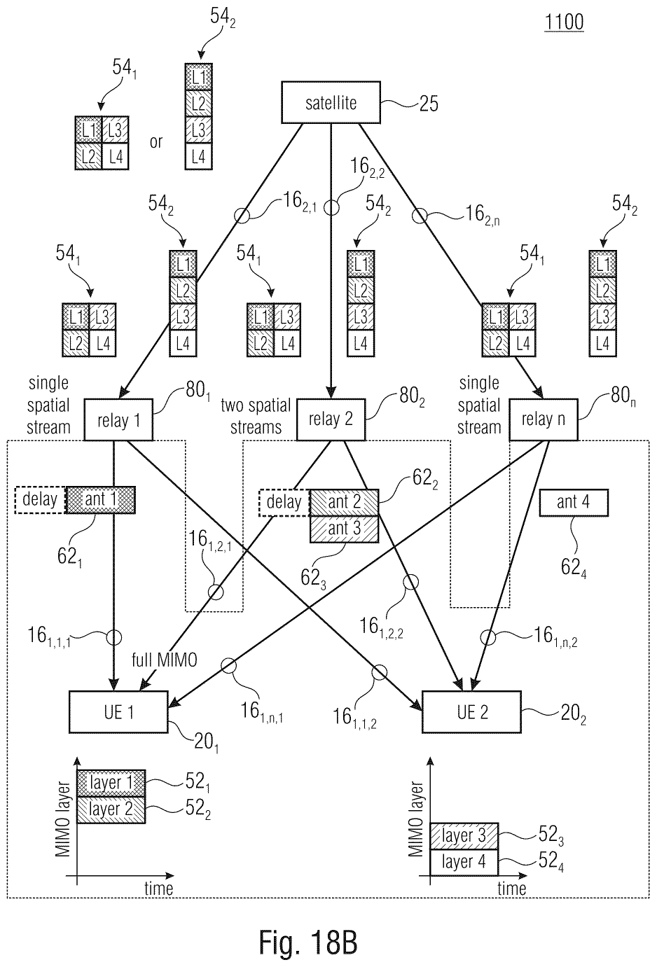

As may be seen from FIG. 18a in the uplink and from FIG. 18b in the downlink, a relay device 80 may be configured for also not relaying a signal. For example, relay 80₁ may decide to not forward 52₃ and/or 52₄ used by a further UE 20₂, e.g., as the signal is associated with a too long delay and/or an amplitude below a threshold or a different criterion. Alternatively or in addition, relay 80ₙ may decide or be controlled to not forward layers 52₁ and/or 52₂ used by UE 20₁ for the same or a different reason. Relay 80₂ that may be aware of both transmissions from UE 20₁ and 20₂ may select layers 52₂ and 52₃ from different UEs to be commonly forwarded whilst dismissing parts 52₁ and/or 52₄ based on the joint operation.

In FIG. 18b a singular decision or control may be implemented for the relay devices 80₁ to 80ₙ to use respective antennas or antenna ports to provide for the parts 52₁ and 52₂ on the one hand and 52₃ and 52₄ on the other hand at the respective UE 20₁ and 20₂ whilst possibly avoiding interference by other parts.

This variant can be utilized to enable relays to transmit data from two different UEs at the same time. In uplink, each relay sees all resources associated with it and transmits the configured resources. In downlink, see FIG. 18b, each UE 20₁ and 20₂ may receive all resources but uses only the ones associated with it. The benefit of this solution is that spatial separation can be introduced on the UE-relay link 16₁ and relay-satellite links 16_{2,1} to 16_{2,n} enhancing the MIMO capabilities of the overall system.

At least some of the discriminating aspects of this solution when compared to known systems are: Relaying of signals from multiple UEs 20; with i>1 through a single relay 80 allowing a fully distributed layer of relays 80₁ to 80ₙ which may also be mobile and are able to provide full MIMO capabilities transparently over a satellite link. The MIMO configuration may be centrally optimized for end to end communication or only on the ground segment.

### Relay Node Configuration

A relay node configuration of a relay 60, 70 and/or 80 may include but is not limited to:
Available resources on UE-relay link 16₁ and relay-satellite link 16₂ (may be updated, e.g., based on a trigger, regularly or on demand).
UE-relay association (which UE may use a certain relay, including white and blacklisting)
Relay-satellite/UAV association (which satellites may be received/transmitted to, including satellite position/time information, e.g. based on system information block SIB19 (5G NR) and SIB31 (LTE))
A relay-satellite/UAV network association.
An operational area, coverage area or connectivity area (e.g. geo-fencing for mobile relays) and their basic configuration (e.g. list of frequency bands for different countries).
an opportunity/availability for communication of the link.
An operational parameter such as one or more of a list of frequency bands, allowed transmission powers, MIMO Modes and the like.
A synchronization source such as GPS, local sync source, further relay with master clock and the like.
A relay software version or availability such as an update over the air

Some, a set or all of the information may be transmitted to a relay according to an embodiment with a configuration signal which may be an independent or dedicated signal at least in parts incorporated in a signals such as a signal to be forwarded or that configured a cell in which the UE is operated. A relay device according to an embodiment may be configured for receiving a configuration signal indicating some or all of the configuration parameters for the relay node configuration and for operating accordingly. Such a signal may be received, for example, from a base station such as a gNB, from the UE and/or a supervising entity such as a network controller or a central entity.

### Relay Node Capabilities and Associated Capability Signalling

Relay node capabilities and associated capability signalling from the relay to the network to inform the network about the capability may include at least one of but not limited to:
A number of antennas and type of antennas;
A supported transmit power;
A supported number of frequency bands and associated bandwidths and subcarrier spacing;
A supported number of MIMO layers on UE side;
Information indicating electrical limits of the relay such as a battery status;
A synchronization state or capability such as an RRC state;
Available resources, e.g., for at least one of the supported links, e.g., terrestrial and/or satellite;
A mobility property or parameter, speed and/or position;
A temporal availability of the relay device;
A satellite signal quality, e.g., as part of CSI feedback;
A ground segment signal quality, e.g., as part of CSI feedback;
An owner, provider and/or operator of the relay device;
A relaying group having at least two relays, e.g., when using the group of relays commonly e.g., on a train or ship;
A supported processing time, e.g., relevant for TDD/FDD transfer;
a battery state or power indicator, e.g. remaining battery lifetime, battery charging information. For example in terms of a percentage, a recharge rate in case of solar and the like.

A relay according to an embodiment may have a relaying capability to relay signals. The relay device may be configured to transmit a capability information related to the relaying capability. A relay device according to an embodiment may be configured for transmitting a capability signal comprising information indicating some or all of the parameters mentioned in connection with the relay node capability. Such a signal may be received, for example, to a base station such as a gNB, from the UE and/or a supervising entity such as a network controller or a central entity. The wireless communication network may be configured for controlling a use, a usability or availability of one or more relay devices accordingly, e.g., to use a set of relay devices in a coordinated or synchronised manner. This may relate to a synchronised operation as described in connection with FIG. 16a-b, FIG. 17-b and/or FIG. 18a-b but also to a scenario where different relay devices are intentionally configured differently to provide different types of service and/to optimise for different criteria with different sets of relay nodes, the sets operating an overlapping or same coverage area or different coverage areas. Such a synchronised manner may relate to a tight synchronisation, e.g., as a precise as possible but also to a loose synchronisation, e.g., to allow a repetition or other transmission with a random delay of a predefined and known maximum.

### Detection and Signalling of Relays

Detection and signalling of relays available and/or active in an end-to-end, e2e, communication path may include one or more of but are not limited to:
Broadcast channel for relay detection (request by UE to detect inactive relays).
Beacon from relays for easy detection by UE, (e.g. kind of an notification/alert channel by the relay, containing at least part of the relay capabilities listed in chapter 4.3).
Relay location map provided via terr broadcast or direct satlink to UE, optionally including the temporal availability of the relays)

A device according to an embodiment, e.g., a UE, a relay device, a base station or a satellite may be configured for a detection signal indicating information associated with a recognised or detected relay device to other devices or the wireless communication network to enhance propagation of a respective knowledge. A relay device according to an embodiment may use the described detection mechanism to announce itself to the wireless communication network either directly or to be recognised by another device that reports about the detection of the relay device.

### Relaying Procedure and Related Signalling

Relaying procedure and related signalling, e.g., to control the relay device or a different device, may include at least one of but are not limited to:
Discovery process
   UE-relay, e.g. a user to network, U2N, and/or user to user, U2U, relay
   Relay-satellite or UAV
   Relay-Relay, e.g., in case of multi-hop
   The individual discovery processes can be independent
e2e Attachment/Detachment process UE-“one or multiple relays”-satellite including configurations like RRC configurations in 4G and 5G from network to UE,
Initialization of relaying link, e.g., configuration setup of Relay, like for network controlled repeaters according to work item description, WID, in RP-230175 and/or in Sidelink U2U Relaying or Sidelink U2N Relaying
SISO/MIMO to MU-MIMO configuration change
Optimization of MU-MIMO relaying
Continuous updates of capabilities and signalling of repeaters in case of mobile relays or stationary relays which are not available all the time

According to an embodiment, a wireless communication network such as network 600, 700, 900 and/or 1100 may comprise at least one relay device described herein; and a first and second device using the relay device for relaying a signal between the first device and the second device, e.g., devices 10₁ and 10₂ or devices 20 and 25. The wireless communication network may be adapted for at least one of:
a discovery process for discovering the relay device;
an attachment/detachment process of a relay device to a link operated by at least one of the first and second device;
an initialisation of a relaying operation of the relay device;
a change of configuration of the relay device;
an update procedure for updating the relay device.
Embodiments further provide for a base station configured for operating a link with a relay device described herein.
Embodiments further provide for a device such as a user equipment, configured for operating a link with a relay device described herein.
Embodiments provide a wireless communication system comprising such a base station and such a device in connection with a relay device described herein that is configured for relaying a signal between the base station and the device.

The wireless communication network may comprise a plurality of relay devices and may coordinate the plurality of relay devices for a joint operation for relaying signals to or from a common device. For example, the joint operation relates to controlling the plurality of relay devices to only forward a part of the receive signal; wherein the plurality of relay devices forwards a complete payload of the receive signal, see FIG. 17a-b and FIG. 18a-b. For example, the control data or other non-payload may be removed from the wireless transmit signal(s) as described above.

The invention provides advantages for multiple instances of a wireless communication network. For example, on a UE side, the UE may benefit from less power needed for satellite communication, e.g., as it only requires to reach the relay. The UE may be released from supporting NTN features as the relay may take care of some or even all parts of a satellite (NTN) protocol. Alternatively or in addition, a UE may not be required to have a mmWave (FR2) modem, even if a satellite link is in the frequency range as this is handled by the relay. Further, the UE may support FR2 communication or even higher frequencies by a dense deployment of relay nodes in the proximity of the UE.

The overall network may benefit from higher reliability and/or higher data rates. This may be based on the assumption that a satellite channel is almost always a LOS path. Alternatively or in addition, the relay can use more transmission power than a UE. Alternatively or in addition, a benefit may be made as a relay may be equipped with better antennas than a UE, e.g., due to cost criteria and electromagnetic compatibility, EMC, requirements. Alternatively or in addition, higher data rates may be supported due to higher transmission power and better antennas, leading to a better or even optimum MODCOD (modulation and coding) over satellite. Further, a higher order MIMO constellation may be transmitted over satellite that only has one antenna per polarization.

The overall network may further benefit in view of a simple distributed infrastructure. Relays may be operator independent. Devices may be resilient to failures of single units and the concept can be extended to a terrestrial relaying network.

It is to be noted that a UE-relay link although being descried in connection with some embodiments as employing TDD is not required to be operated accordingly. Alternatively or in addition, such a link may also be operated in FDD.

The invention may be used in wireless communication networks, for example, in specific scenarios such as a disaster recovery scenario where the optimization of a satellite only network is required as it may be easier to set up a bunch of relays than a base station, especially if no terrestrial backhaul is available. Embodiments of the present invention may further be used to offload data traffic to satellites in densely populated areas and/or for offloading of data for a campus large, potentially remote campus networks such as an oil rig and/or a cruise ship.

Depending on the implementation of the satellite network, parts of the management functionality are located in the relay or base station instead of a core network, e.g. an AMF or location/positioning services. The AMF might be required to be executed locally to support routing of traffic, while location services benefit from lower latency.

With regards to a device such as a UE described herein, e.g., the UE 20 of FIG. 16a-b, FIG. 17a-b, and/or FIG. 18a-b, a device according to an embodiment is configured for utilizing a wireless communication link that comprises a relay device for relaying a wireless signal towards or from the device, wherein the device is configured for providing a selection information indicating a part of a payload data to be forwarded by the relay device; and/or wherein the device is configured for receiving a plurality of relayed signals from a corresponding plurality of relay devices; the plurality of payload data being associated with a same signal source that has transmitted the plurality of payload data with a same signal.

With regard to the functionality of relaying described, e.g., in connection with relay devices, some of the described devices may receive a wireless signal, the wireless receive signal, and may actively form, generate and transmit a different wireless signal, the wireless transmit signal. Thus a different signal may be transmitted when compared to the received signal. However, the same or a modified message, e.g., modified in view of time-to-live, hop-count, origin of the signal and the like, is contained in the wireless transmit signal when compared to the wireless receive signal such that the concept of relying a signal is not necessarily linked to transmitting the same signal although not excluding such an option. Embodiments referring to relaying of a signal thus relate to receiving the wireless receive signal and to transmit transmitting the wireless transmit signal based thereon and with a same or modified message contained therein.

Further advantageous embodiments with regard to the operation of relays and possibilities to make use thereof are described below.

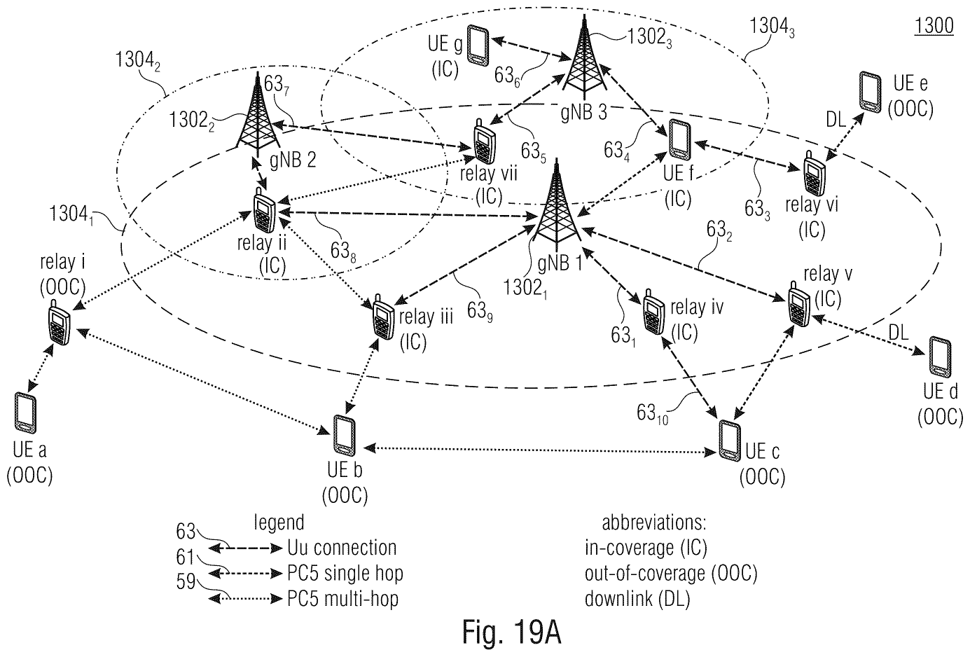

FIG. 19a shows a schematic block diagram of a wireless communication network 1300 according to an embodiment. Wireless communication network 1300 may comprise several base stations 13021, 13022 and 13023 providing service in different coverage areas 13041, 13042 and 13043, respectively. Devices such as UEs within one or more coverage areas 13041, 13042 and 13043, respectively, are considered to be in-coverage, IC. Relay devices i through vii may be in accordance with a relay device described herein, i.e., a relay device according to an embodiment.

With reference to FIG. 19a there is shown the concept of different paths in a wireless communication network.

Different UEs as are located in the wireless communication network 1300, some of the UEs being located within the coverage area 13041 to 13043, i.e., they may be in coverage, IC, and some of them outside thereof, i.e., out of coverage, OOC. UEs may be operated, at least temporarily as a relay device described herein such as relay device described herein.

To different UEs such as remote UEs UE a, UE b, UE c or UE d there may be provided paths, each path having one or more path segments, wherein each path segment may be established by at least one of a Uu connection 63, a PC5 single hop connection 61 or a hop of a PC5 multi-hop connection 59. As may be seen, e.g. with regard to UE c a UE may be reached via different paths. It may therefore be of benefit when selecting at least a path segment towards a specific target, wherein such a selection may be implemented based on varying conditions such as varying positions, load scenarios, quality requirements or the like.

Embodiments, thus, relate to distributing information about links, paths or path segments within the network to a deciding entity, wherein such a deciding entity may be a central controller, may be located at a base station such as gNB, at a relay device, at a device being a source for a signal to be transmitted and/or a device being a sync of such a signal.

As may be seen from FIG. 19a, a device such as a relay device may operate a single path segment, see relay iv₁, may operate two path segments of a same or different paths, see relay device v or relay device iii or may operate more than a single path and an increased number of path segments.

In other words, during the discovery phase a relay UE or relay device may answer discovery messages and include further information, alter, add or fuse (combine) path properties, beam IDs, frequency shifts, jitter, geolocation, relative location or distance. When sending the answer back the multi-hop chain, the same principle applies to the response message as for the discovery message. The gNodeB (base station) at the end then has a response with a branch ID and associated properties.

The path ID can be used by the remote UE to send the message on a specific path that matches the QoS requirements and/or supported feature set. The gNodeB can also use the path ID to schedule the downlink transmission back to the remote UE.

This way, the relay UEs do only need limited intelligence to do the routing, which only based on the discovery outcome and the resulting path ID/destination pairs.

### Procedure:

Remote a UE may send out discovery message. The discovery message is received by relay devices that send out a discovery message as well to find a path to the base station (if they don't already have a Uu connection/can establish a Uu connection). If a relay device already has multiple uplink-heavy remote UEs to relay it may decide to not transmitting an answer.

Finally two (or more) paths may be established and the response message will go back the path until it reaches the requesting UE that now has two relay/path candidates.

On another bearer for another service, the gNodeB is looking for a specific UE and tries to discover the UE via connected relay UEs. Some relays devices can reach the UE, but so can, e.g., a relay device which is now answering the discovery, because there is downlink capacity. The gNodeB has the option to choose the ‘best’ connection out of three, whereas the remote UE only has two options.

Alternative routing options can be monitored but do not have to be active. They can be used as fallback in case of RLF on the other route. Also, conditional handover or re-configuration is possible in case the properties of one path do no longer meet the requirements.

According to embodiments, a device maintaining a direct connection to a base station may use a Uu connection 63. A relay device relaying a wireless receive signal may use a single hop PC5 connection 61 or a PC5 multi-hop connection 59 for relaying. However, as shown, for example, for relay iv which may be a user equipment, UE or a different entity, may establish a Uu connection with a user equipment, e.g., UE c of the wireless communication network and for relaying the wireless receive signal to or from the user equipment UE c. Although using a Uu connection between relay iv and UE c may be used regardless whether UE c in-coverage or out-of-coverage, OOC, and regardless whether the signal is transmitted in uplink UL, or in downlink, DL, using a Uu connection 63₁₀ between relay iv and UE c may be of advantage when providing, at least in parts, a base station functionality for UE c by relay iv. For example, relay device iv may, in accordance with embodiments, provide at least a part of an access and mobility management function, AMF, and/or a location management function, LMF, for devices that are connected with the relay. Such a mechanism may be used, as an alternative or in addition, in a case where relay device iv misses a backhaul link. Alternatively or in addition, devices may benefit from such a mechanism when being operated as a receiver of the wireless transmit signal in a different network when compared to a source of the wireless receive signal.

In yet another advantageous modification, the relay device iv may use any 3GPP connection, or a non-3GPP connection such as a Bluetooth connection, a LiFi connection and/or a WIFI connection to connect to the gNB 1302₁ or UE c.

According to such an implementation, the relay device may maintain even two or more Uu connections to different devices, wherein one or more or even none of them may be a base station whilst the other is, for example, a UE or a different relay device. For example, relay i may, in some cases, decide to use Uu connections for UE a or UE b as well as for connecting to relay ii. This allows the relay device to establish two or more Uu connections and to maintain them simultaneously and for relaying wireless receive signals using two or more Uu connections.

In a different operation mode or in a different configuration/implementation a relay device according to an embodiment may be configured for receiving the wireless receive signal using a first PC5 connection established with a first device and for transmitting the wireless transmit signal, i.e., the relayed signal, using a second PC5 connection established with a second device, e.g., using a PC5 multi-hop connection 59.

The relay device according to an embodiment may establish the two or more PC5 connections with a relay device or a user equipment on the one hand and with a relay device or a user equipment at the other end. For example, the relay device may relay signals or messages between a user equipment and a relay device, between two relay devices or between two user equipment.

According to an embodiment, a relay device is provided that operates, at least in one relay mode, to simultaneously relay signals or messages in uplink and downlink. In yet another relay mode, a relay in accordance with an embodiment may be configured for simultaneously relaying signals or messages only in one of uplink and downlink, e.g., as part of a multi-TRP configuration. In such a multi-TRP configuration, different devices such as relays may commonly provide a downlink signal for a UE to avoid limitations due to blockage. In uplink for example, different relays may be used to provide for a high reliability of receiving signals.

In other words, FIG. 19a presents a simplified view of a mobile communications network comprised of base stations gNB 1, gNB 2 and gNB 3, user equipment terminals UE a-g and relays i-vii. Although the base stations may provide coverage to many UEs, for reasons of simplicity and visual clarity, the illustration shows only two UEs, i.e., UE f and UE g, as being in-coverage, IC, and 5 UEs UE a, UE b, UE c, UE d and UE e being out-of-coverage, OOC. As the network may include one or more relays, the coverage may be effectively extended so that communication links may be established between all UEs using one or more of the following types of connection: Uu, PC5 single-hop and PC5 multi-hop.

FIG. 19b is identical to FIG. 19a with the exception that examples of paths 561 to 567 from base stations to user equipment devices are shown.

The following may be noted:
not all paths are shown in FIG. 19b but a selection of possible paths;
paths can provide either unidirectional or bidirectional connectivity; and
one or more paths can either originate or terminate at a base station or a UE.

FIG. 19b is illustrates the following path examples:
Path 56₁—from gNB 1 to Relay ii using a Uu connection; and from Relay ii to Relay i to UE a using a PC5 multi-hop connection. The path is fully bidirectional.
Path 56₂—from gNB 1 to Relay iii using a Uu connection; and from Relay iii to UE b to UE c using a PC5 multi-hop connection. UE b acts as a relay. The path is fully bidirectional.
Path 56₃—from gNB 1 to Relay iv using a Uu connection; and from Relay iv to UE c using a PC5 single-hop connection. The path is fully bidirectional.
Path 56₄—from gNB 1 to Relay v using a Uu connection; and from Relay v to UE d using a PC5 single-hop connection. From Relay v to UE d, the path is unidirectional providing downlink only.
Path 56₅—from gNB 3 to UE f to Relay vi using a Uu connection; and from Relay vi to UE e using a single hop connection. UE f acts as a relay. From Relay vi to UE e, the path is unidirectional providing downlink only.
Path 56₆—from gNB 3 to Relay vii using a Uu connection; from Relay vii to Relay ii to Relay iii to UE b using a PC5 multi-hop connection. The path is fully bidirectional.
Path 56₇—from gNB 2 to Relay vii to gNB 3 using a wireless connection [Uu/sidelink], e.g. to establish an Xn interface. The path is fully bidirectional. As an option the path could be extended to connect UE f to gNB 2 via the other entities.

According to an embodiment, one or more relays may be configured for receiving, e.g., from a base station, information indicating a configuration of resources of a sidelink. Such relay devices may be broadcast, groupcast or unicast a resource pool configuration based on the information indicating a configuration of resources of a sidelink. For example, relay vi being IC may receive a signal information block, SIB, and may forward this information via PC5 in broadcast, groupcast or unicast to OOC UE(s), e.g., UEE.

In some embodiments relay devices may also allow to overcome disconnectivity due to an operation of different devices by different mobile network operators. For example, and when referring to FIG. 19a and FIG. 19b, a UE being OOC may discover or see a relay. The UE is, for example, provided with service by a first mobile network operator and the relay device is provided with service by a different second MNO.

Nevertheless, the relay may accept relaying signals and the UE may be adapted to communicate with the relay. This may allow to support a UE that wants to connect to the network via a relay. Usually a relay will not answer the request since it does not belong to the same network/MNO. According to embodiments, this issue is addressed by relaying such signals. One possible part of such a solution is configuring a relay possibly being IC, to receive a system information, SIB, and/or a configuration for a sidelink, SL, pool and to broadcast/groupcast/unicast the resource pool information 21, a group of or all UEs around the relay, e.g., using a sidelink connection, PC5.

This may allow to implement a shared relay being shared between different MNOs.

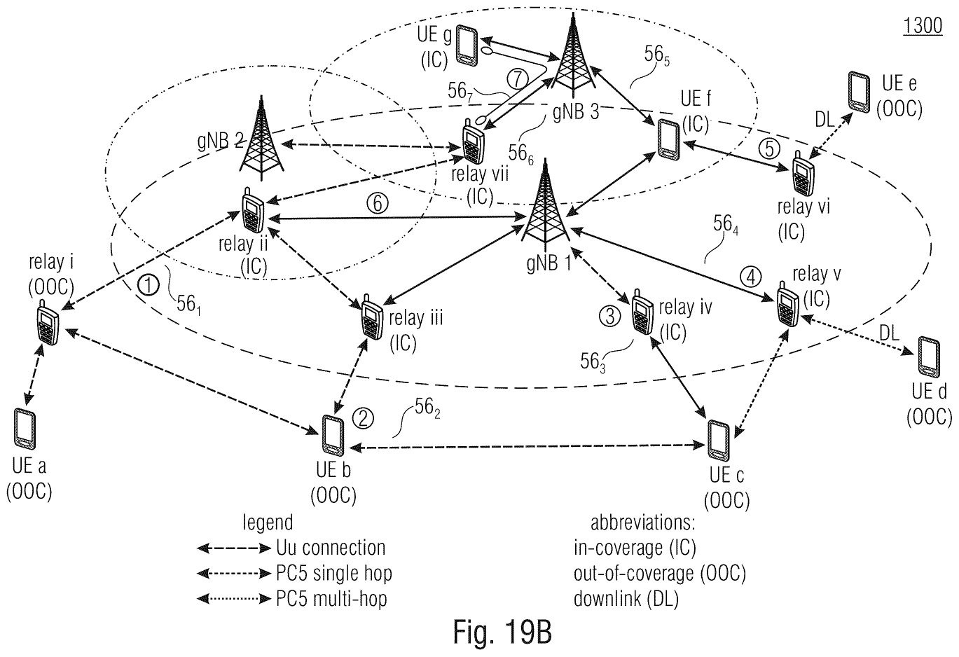

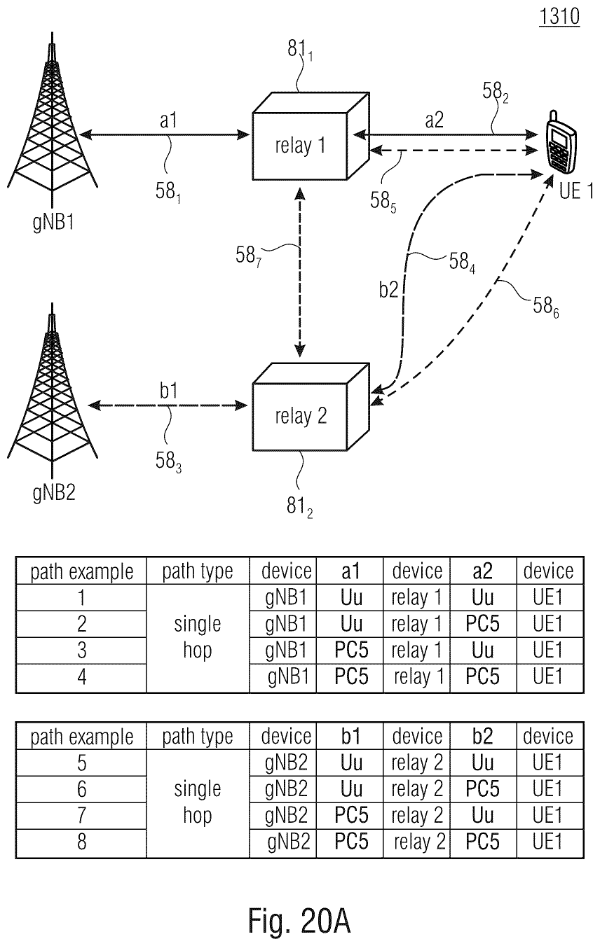

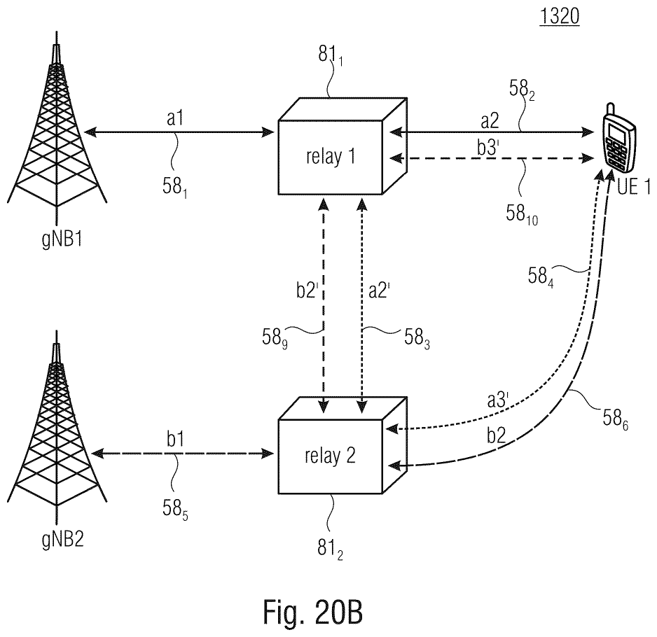

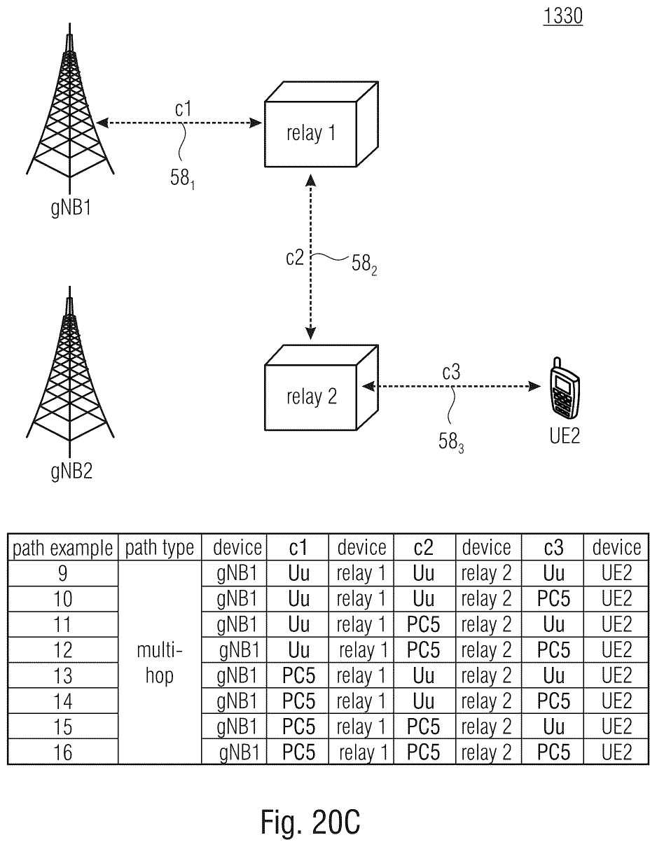

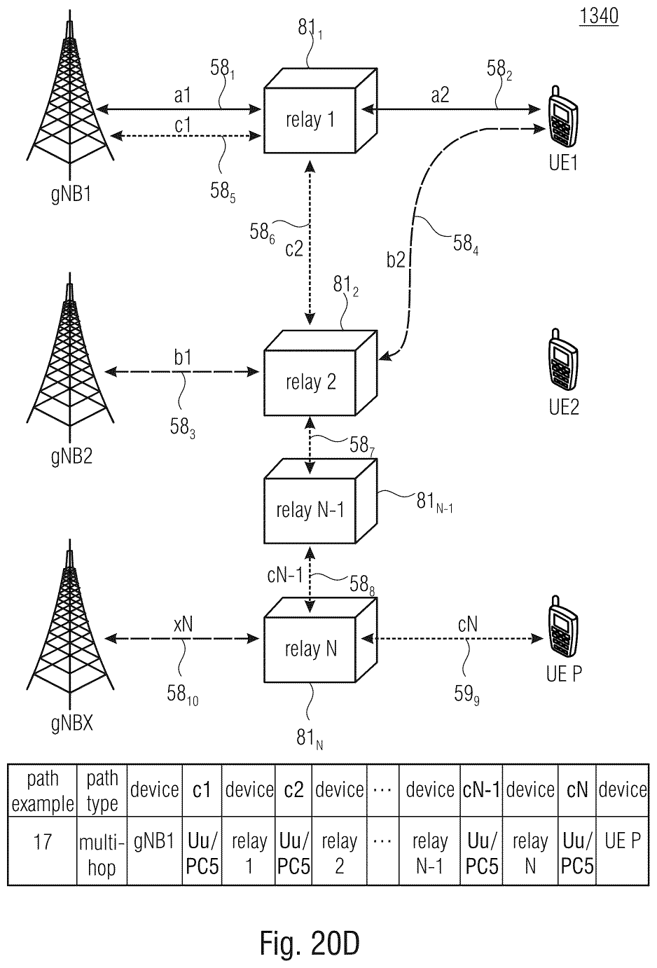

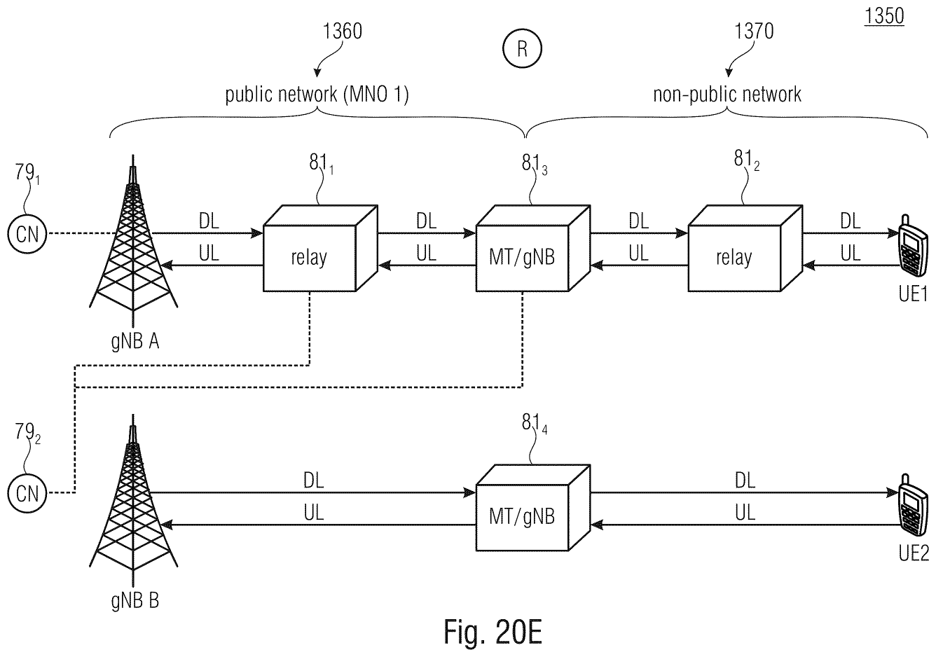

FIG. 20a shows a simplified illustration that shows examples of single-hop connections between two different base stations gNB₁ and gNB₂, two different relays relay 1 labeled as relay 811 and relay 2 labeled as relay device 812 and a UE₁. Relay device 1 and relay device 2 may be in accordance with an embodiment described herein.

FIGURE a further shows eight path examples of a single hop connection between gNB 1 and UE 1 using relay 1, between gNB₂ and UE 1 using relay 2 respectively. It may be seen that components 58₁ and 58₂ (A1 and A2) may be established as Uu connection or as PC5 connection each. Same is true for path segments 583 and 584.

A relay device in accordance with embodiments may also operate simultaneously, or time multiplexed in single-hop (solid lines of path segments 581, 582, 583 and 584) and/or in multi-hop mode forwarding the messages (dashed lines of path components 585, 586 or 587). Path component 587 may be assigned to gNB 1 or MNO 1 or assigned to gNB 2 or MNO 2.

UE can signal capability of supporting single-hop, multi-hop or combinations thereof. In accordance with embodiments,
Device (relay) may support:
   single-hop between
      a UE and a base station
      a UE and another UE
   multi-hop between
      a UE and another relaying device
      a UE and another UE
      another relaying device and further relaying device
      between a relaying device and a base station
   Uni-directional forwarding/relaying
   Bi-directional forwarding/relaying
   Routing capability on at least one of the forwarding links (device can route flows, traffic, packets, messages from one or multiple inputs to one or multiple outputs
   at least one forwarding mode, if multiple forwarding/relaying modes are supported, then:
      Device can be configured into one selected mode.
      Device can be configured to switch between modes.
      Device can be configured to operate multiple modes concurrently

Thus, the UE itself can support multi-hop as a UE-network, UE to NW, relay or a UE-UE/UE to relay.

FIG. 20b shows a simplified illustration of a wireless communication network 1320 deviating from wireless communication network 1310 of FIG. 20a and showing examples of both single-hop and multi-hop connections between two different base stations gNB₁ and gNB₂, two different relays relay 1 and relay 2 and UE₁.

FIG. 20c shows a schematic block diagram of a wireless communication network 1330 comprising base stations gNB₁ and gNB₂ in accordance with embodiments, relay 1 and relay 2 being in accordance with embodiments and UE₂ being in accordance with embodiments.

FIG. 20c further shows path examples 9-16 using different path components 58₁, 58₂ and 58₃ that may be associated with gNB₁ or gNB₂ each, the respective MNO, respectively.

In other words, FIG. 20c shows the potential multihop relaying path from gNB₁ via Relay1 and Relay2 to UE₂ and vice versa. The type of the actual interconnection link or path segment 58₁ between gNB and Relay1, 58₂ between Relay1 and Relay 2, and 58₃ between Relay 2 and UE can be of a different type as shown in the table of FIG. 20c. In this example the currently known and supported interfaces are Uu and PC5 but also future interfaces may be considered. It is shown that each link is able to support interfaces independent of each other. This also means that the capabilities of the links may be different resulting in a potential different setup/deployment of an overall scenario. Potentially depending on the use case a dynamic switching between the different interfaces may be possible and can result from the movement dynamics of the individual entities in the network.

FIG. 20d shows a simplified illustration of a wireless communication network 1340 according to an embodiment having base stations gNB1, gNB2, . . . , gNBX, several relay devices relay 1, relay 2, relay M−1, relay N and UEs UE₁, UE₂ and UEP in accordance with embodiments.

Further, a path example 17 is shown indicting that by way of a multi-hop connection different devices up to UE P may be reached whilst each of the respective path components 58₁ to 58₁₀ may be established and/or maintained as a Uu connection or a PC5 connection or a different connection, e.g., a Bluetooth connection or a WIFI connection or a different 3GPP connection.

In other words, The illustration in FIG. 20d shows an example of a combination of single- and multi-hop connections between the UEs and corresponding gNBs. A single-hop connection is established, for example, using path components 58₁ and 58₂, 58₃ and 58₄ respectively. In particular, the data to UE₁ can be transmitted from all the gNBs 1,2 and X by using the interfaces between the Relays 2, N−1 and N. To simplify the forwarding it may be beneficial to use same communication protocol in the whole forwarded path. This requires the exchange of capability information in the partial network. In a mixed protocol scenario e.g. PC5, Uu, Bluetooth etc., the relays would have to decode and then forward the information.

Also the network advantageously monitors the link capacity/load (e.g., a resource utilization, a CPU load, . . . ) in order to allow efficient forwarding of messages, e.g., by path selection, throughout the complete routing path.

FIG. 20e shows a schematic block of at least a part of a wireless communication scenario 1350 comprising a first wireless communication network 1360, e.g., a public network operated by MNO1, and a further wireless communication network 1370 being, for example, a different public network or non-public network.

Each of networks 1360 and 1370 may comprise a dedicated core network, CN, 79₁, 79₂, respectively.

Relay devices 81₃ and 81₄ may form a bridge between networks 1360 and 1370. Alternatively or in addition, the relay device 81₃ and 81₄ may be configured for providing at least a part of an access and mobility management function, AMF, and/or location management function, LMF, for one or more devices, e.g., for relay 81₂, UE₁, UE₂, respectively. For example, such operation may be provided for UE₁, UE₂ and/or relay 81₂, e.g., if they lack a separate or dedicated backhaul link.

Relay 811 may be controlled, for example, by core network 79₁ and/or 79₂. Alternatively or in addition, relay device 813 may be controlled by core network 79₁ and/or 79₂. Those relay devices may, thus, form a shared relay device.

A wireless receive signal received by relay device 81₃ or 81₄ from a first wireless communication network 1360 or 1370 may be transmitted to the other wireless communication network as the wireless transmit signal. Thereby, the relay device may implement a bridge between the wireless communication networks 1360 and 1370.

One or more of the relay devices 81₁ to 81₄ may be operated as so-called enhanced relay devices. For example, such devices may receive signals that are not only dedicated for relaying on a point-to-point manner.

For example, with reference to FIG. 20e the relay 81₃ and/or 81₄ (R) can be considered as a network separator or bridge. Two core networks 79₁ and 79₂ (CNs) are shown.

A relay 81₁ top 81₄ in may be a separate entity or combined with a mobile termination, MT, and/or a base station, gNB to form a device capable of relaying traffic.

For example, the MT/gNB block 84₄ in FIG. 20e in the lower part may be a combination of a UE and a base station, providing RAN access to UE 2. UE 1 can also access the lower CN 79₂ via a connection of the MT/gNB node 81₃ and an optional relay 81₂.

The top CN 79₁ and the bottom CN 79₂ of FIG. 20e are different CNs, i.e., not the same, and can be operated as full core networks or as virtual core networks within another core network providing flexibility to MNOs and non-public-network, NPN, providers.

While the CN 79₁ may manage the public network 1360, the core network 79₂ may manage the NPN network 1370. For the NPN part to be able to work properly, the CN 79₂ may be needed to be available for the MT/gNB device 81₃. Therefore two main options exist for the MT/gNB device:
Connection to the CN 79₂ via the MT or Relay 81₃ connected to the CN 79₁; and/or
Hosting CN 79₂ within the NPN 1370, e.g. at the MT/gNB 81₃ device without requiring the CN 79₁ to operate.

Shown is an example scenario with a relay device providing bridging capabilities between MNO1 and non-public network (NPN), e.g. a cruise ship or a factory. In these scenarios the NPN can host its on CN or CN can be forwarded through the MT/gNB.

The first network may form a “backhaul” or “anchor” path to (R) (the relay or bridge). Furthermore, the operation of the relay can comprise
Forwarding in one direction only, e.g. DL can be received at the UE1 but the UL needs to be relayed due to UL pathloss constraints.
Bidirectional Forwarding, i.e. both UL and DL directions.

An enhanced Relay node, may support functionalities like sending/receiving
a relay wake up signal (from UE, BS, other relays, . . . to potential relays (sending such a signal may wake up others, e.g., from a discontinuous reception mode, DRX))
a go to sleep signal/message
a paging signal/message
a configuration signal/message

For example, this may allow to inform the other UE(s) about a timing of messages, repetitions, physical layer properties, routing parameters, DRX configuration, QoS requirements/profiles; change of system information (from previous devices); forwarding of received configuration information.

The second network (NW) can be a different public network or a non-public NW, a private NW or a campus NW that uses Uu, sidelink, or other connections such as Bluetooth, Wi-Fi or Li-Fi connections. The relay device may use such connection for communication.

The configuration of the second network may be done by one or more of the following:
First network's CN 791
Second network's CN 792
Autonomously by gNB in the second network 1370

The routing from gNB A to UE 1 may be either:
Fully-transparent to one or both ends of the communication link; or
Partially-transparent as far as the relay (R).

Such aspects may be formulated as
A transceiver configured for establishing a Uu connection with a user equipment of the wireless communication network and for transmitting the wireless transmit signal to user equipment or receiving the wireless receive signal from the user equipment.
A transceiver, wherein the Uu connection is a first Uu connection, the transceiver being configured for establishing a second Uu connection with a further device such as a base station, a relay device or a user equipment, wherein the transceiver is configured for receiving the wireless receive signal and transmitting the wireless transmit signal using the first and the second Uu connection.
A transceiver, configured for receiving the wireless receive signal using a first PC5 connection established with a first device and for transmitting the wireless transmit signal using a second PC5 connection established with a second device.
A transceiver, wherein the first device is a relay device or a user equipment; and wherein the second device is a relay device or a user equipment.
A transceiver, wherein in a first operating mode the transceiver is configured for simultaneously relaying signals in uplink and downlink.
A transceiver, wherein in a second operating mode the transceiver is configured for simultaneously relaying signals only in one of uplink and downlink, e.g., as a part of a multi-TRP configuration.
A transceiver, configured for receiving, e.g., from a base station, information indicating a configuration of resources of a sidelink; and from broadcasting, groupcasting or unicasting a resource pool configuration based on the information indicating a configuration of resources of a sidelink.
A transceiver, configured for monitoring a link property such as capacity, load, throughput of a first link used for receiving the wireless receive signal or of a second link used for transmitting the wireless transmit signal and for providing a report indicating the property.
A transceiver, configured for receiving the wireless receive signal from a first wireless communication network and to transmit the wireless transmit signal to a different second wireless communication network;
A transceiver that implements a bridge between the first and second wireless communication network.
A transceiver, configured for receiving at least one of:
   a relay wake up message;
   a go-to-sleep message;
   a paging message; and
   a configuration message; and
   for operating accordingly.
A transceiver, configured for transmitting at least one of:
   a relay wake up message;
   a go-to-sleep message;
   a paging message; and
   a configuration message.
A transceiver, being a user equipment, UE, for operating in a wireless communication network and for at least temporarily operating as a relay device.
A transceiver, configured for using at least one of:
   a non-3GPP connection, e.g., using Bluetooth, WiFi or LiFi, and
   a 3GPP connection.
      for receiving the wireless receive signal and/or for transmitting the wireless transmit signal.
A transceiver, wherein the transceiver is configured for providing at least a part of an access and mobility management function, AMF, and/or a location management function, LMF, for at least one device, e.g., in case of a missing backhaul link.

A device such as a user equipment may advantageously be configured for recognising the transceiver based on at least one of information indicating a configuration of resources of a sidelink or a resource pool configuration.

Such a device may, as an alternative or in addition be configured for selecting a path segment to be used for signal relaying as a path segment provided by the transceiver and based on a report indicating a property such as capacity, load, throughput of a link providing the path segment.

Such a device may, as an alternative or in addition be configured for establishing a Uu connection with the transceiver.

Such a device may, as an alternative or in addition be provided with service by a first mobile network operator, MNO, wherein the transceiver is provided with service by a second mobile network operator, MNO.

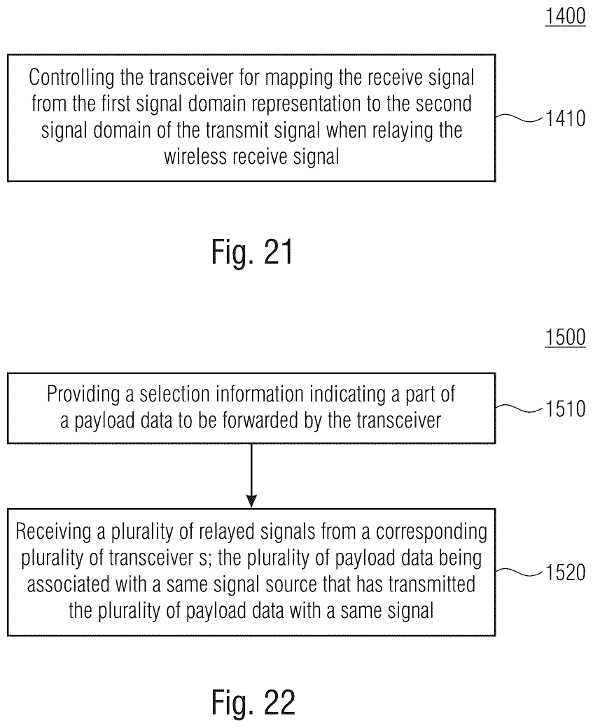

FIG. 21 shows a schematic flow chart 1400 of a method for operating a transceiver, according to an embodiment. A step 1410 comprises a step 1410 of controlling the transceiver for mapping the receive signal from the first signal domain representation to the second signal domain of the transmit signal when relaying the wireless receive signal.

FIG. 22 shows a schematic flow chart of a method 1500 according to an embodiment. A step 1510 comprises providing a selection information indicating a part of a payload data to be forwarded by the transceiver. A step 1520 that may be executed as an alternative to step 1510 or in addition to step 1510 comprises receiving a plurality of relayed signals from a corresponding plurality of transceiver s; the plurality of payload data being associated with a same signal source that has transmitted the plurality of payload data with a same signal.

FIG. 23 shows a schematic block diagram of a wireless communication network 2100 according to embodiments. Whilst communication network 2100 may comprise one or more basestations 48₁, 48₂ that may be adapted to provide service or connectivity in an area 1304₁, 1304₂ respectively.

Whilst communication network 2100 further comprises several UEs 46_{i,j}, wherein parameter i references to base station 48ᵢ and parameter j is a parameter for counting UEs associated to a same basestation. Note that a number of UEs and a number of basestations may be arbitrary. In the given example, basestation 48₁ may provide connectivity within an area 1304₁ and UEs 46₁, 46_{1,2}, 46_{1,3}, and 46_{1,4} may be associated with the basestation, e.g., as being operated by a same MNO or the like. Accordingly and by way a no-limiting example only, UEs 46_{2,1}, 46_{2,2}, 46_{2,3} and 46_{2,4} may be associated with basestation 482.

From a point of view of basestation 48₁, UEs 46_{1,3} and 46_{1,4} may be out of coverage, OOC, of basestation 48₁ and, for example, in coverage of basestation 48₂, e.g., within area 1304₂. Further, as an alternative or in addition, UEs 46_{2,3} and 46_{2,4} may be OOC with regard to basestation 48₂ and, optionally, in coverage of basestation 48₁, i.e., within area 1304₁.

To reach UEs 46_{1,3} and/or 46_{1,4} basestation 48₁ may utilize a relay device. As an alternative or in addition, to reach UEs 46_{2,3} and/or 46_{2,4}, basestation 48₂ may utilize a relay device.

Wireless communication network 2100 may rely on a reflector 2102 adapted to reflect wireless signals 2104₁, 2104₂ transmitted from basestation 48₁ or 48₂ or transmitted towards basestation 48₁, 48₂, respectively. The reflector 2102 may reflect the wireless signal along a path of the wireless signal 2104₁, 2104₂, respectively.

The reflector 2102 may be mounted to or may be part of a non-stationary or moving, e.g., flying device such as an aircraft, an airliner, an unmanned aerial vehicle, UAV, a balloon, a high altitude platform, HAP, a high altitude pseudo satellite, HAPS, a hybrid integration platform, HIP, a satellite or the like. Such devices may move with regard to the ground, i.e., areas 1304₁ and 1304₂ so that, from a first point of view, an area 1304₃ where relying between areas 1304₁ and 1304₂ is possible by use of the reflector 2102 is moving and, thus, only temporarily provides for a relying service. From a different point of view, area 1304₃ may be fixed on earth or at least with regard to areas 1304₁ and 1302₂ whilst flying device 2106 may move with regard to area 1304₃ and may only temporarily provide for relying service. However, wireless communication network 2100 may rely on several reflectors 2102 or several flying devices 2106 to increase temporal availability.

Alternatively, the non-stationary device may be a different moving or moveable device such as a vehicle, e.g., a car or a ship. The non-stationary device may, thus, be moving, flying, orbiting or driving device.

It is to be noted that the flying device 2106 and/or the reflector 2102 may be part of the wireless communication network 2100 but may also be devices outside the wireless communication network 2100 being utilized by devices of the network. For example, some aspects relate to a control unit such as a control unit 2108 configured for determining at least a segment of an available path in a wireless communication network, i.e., an operated or configurable path. Such a control unit 2108 may be configured for providing information to at least one relay device along the path segment for relying a wireless receive signal received by the relay device as a wireless transmit signal along the path segment. That is, the relay device such as a relay device described in connection with the first aspect, the second aspect or the third aspect may be informed about a required relaying, e.g., reflection, or may be directly controlled.

Such a control unit 2108 may form a part of, e.g., a basestation 48, a UE 46 or a different network entity.

The control unit 2108 may be adapted to provide information, e.g., to another control unit or to the relay device 2102, the information related to a requested operation mode of the relay device when relaying the wireless receiver signal. When referring, for example, to an active transmission of a relay device, this may relate to a requested transmit mode or the like. With reference to a RIS, this may relate to informing the RIS about a requested polarization, redirection angle, a location for a signal to be received or the like. Relay device 2102 may optionally implement a relay device according to the first aspect and/or the second aspect.

Such a control unit 2108 may be configured for controlling the at least one relay device 2102 along the path segment according to the determined path segment. That is, with reference to aspect 1 and aspect 2 described herein, there may selected a specific relay device to be used for relaying service and may be controlled or informed accordingly.

The control unit 2108 may form a part of the relay device, e.g., relay device 2102 or a basestation of the wireless communication network. Control unit 2108 may be configured for providing information about controlling an active or passive reflector along the path segment for relaying the wireless signal. That is, control unit 2108 may control the reflector or may provide information about the reflector to a different device that is thereby enabled to control the reflector properly.

Alternatively or in addition, the control unit 2108 may be configured for providing information about an availability of an active or passive reflector along the path segment for relaying the wireless receive signal.

As described herein, a control unit may be adapted for determining the path segment based on a capability of the path segment and/or a relay device operating in the path segment. For example, the control unit may determine that one of a plurality of path segments is more available than another e.g., based on a load condition, quality requirements or the like and may select one of the path segments based thereon. As an alternative or in addition, a relay device relaying a low number of devices or no devices may be preferred over a different relay device and the associated path segment(s) that already relay several devices.

Control unit 2108 may be configured for determining that a location of a reception device for receiving a relayed signal derived from the receive signal is out of coverage of a transmitter of the receive signal or an antecedent signal, derived signal or prior signal thereof from which the wireless receive signal is obtained, e.g., though transmission, processing or the like. The control unit 2108 may be adapted to determine the path segment to reach the reception device via the relay device. Considering, for example, several relay devices or reflectors, for example, the control unit 2108 may determine that UE 461,4 may be reached with basestation 481 via a specific reflector 2102 but not via a different path or path segment.

This is of particular relevance when considering a higher number of basestations and a higher number of areas in a wireless communication network.

According to an embodiment, the control unit 2108 is configured for providing e.g., to the relay device, a transmitter of the receive signal or to a receiver of the transmit signal information related to an adjustment of a timing advance, TA. For example, when considering the comparatively long travel distance to a flying device 2106, the timing advance requirements may exceed the regular operation of a wireless communication network cell especially a terrestrial cell.

For example, the control unit 2108 may be adapted to adjust the TA from a terrestrial TA to a non-terrestrial TA based on knowledge that the path segment comprises a non-terrestrial node.

Control unit 2108 may be configured for determining, e.g., based on signal reflections or a flight schedule, an availability of the pat segment based on a reflection, e.g., caused by a reconfigurable intelligent surface, RIS, and to inform a node effecting the received signal, e.g., a source node such as a basestation transmitting a signal towards a UE and/or a node for receiving the transferred signal such as the UE, about the availability of the path segment. That is, information about an availability of a relayed/reflected path segment, e.g., towards the reflector 2102 may be distributed in the wireless communication network.

Further embodiments relate to a device, e.g., a basestation or a different device, comprising control unit 2108, wherein the device is configured for communicating with a first number of first devices, UEs 46_{1,1}, 46_{1,2} or UEs 46_{2,1}, and 46_{2,2} and for further communicating with a second number of second devices UE 46_{1,3} and 46_{1,4}, UEs 46_{2,3} and UE 46_{2,4}, respectively being out of coverage of the device by using a reflector unit 2102 to reflect a wireless signal between the device, e.g., the basestation and at least one of the devices out of coverage. Such a device may be configured for providing different system information to devices in coverage and devices out of coverage.

Alternatively or in addition, the devices in coverage may form a first group and the devices out of coverage or at least a subset thereof may form a second group. The device may be configured for instructing the first group and the second group to use different timing advances, e.g., in view of terrestrial and non-terrestrial TAs. For example, this may relate to a group TA-offset e.g., for an uplink towards the device/basestation.

According to an embodiment, a first area such as area 1304₁ may be associated with first devices 46_{1,1}, 46_{1,2} and a second area 1304₂ or a part of area 1304₃ excluding area 1304₁ may be variably or invariably one of non-overlapping, partially-overlapping and fully-overlapping.

According to an embodiment, the device comprising the control unit may be configured for communicating with a third number of third devices being out of coverage of the device using a same or a different reflector unit to reflect a wireless signal between the device and at least one of the third number of third devices and the device. That is, in addition to area 1304₂, a further area such as an area to be reached via a further reflector may be reached with reflected devices.

According to an embodiment of the third aspect, a device is provided that comprises a reflector unit such as reflector 2102 for reflecting wireless signals. The device comprises a control unit for processing travel information related to a travel route of the device. The travel route may include, for example, a flight path or a flight schedule. The device comprises a wireless interface for transmitting a wireless signal and the control unit of the device is configured for causing the device to transmit the wireless signal with the wireless interface to indicate the travel information to thereby indicate an availability of the reflector unit for other devices to reflect a wireless signal of the other device. For example, in control unit 2112 of flying device 2106 may operate accordingly whilst the device comprising the control unit 2112 is not necessarily but advantageously a flying device.

The reflector unit 2102 may be configured for reflect imagining wireless signals along a reference direction 2114 and to maintain the reference direction 2114. For example, the reference direction 2114 may be a direction pointing from the reflector unit 2102 towards a constant spatial point such as the center of earth or a different reference point, i.e., a point on Earth or a point defined by an offset to another point. According to an embodiment, the reference direction may be a direction pointing from the reflector unit towards a constant area reference point at the surface of the Earth, e.g., fixed Earth coverage area, or moving Earth coverage area.

In other words, in area A, the basestation gNB A provides coverage to two devices, UE A1 and UE A2. The other two devices in area A, UE B3 and UE B4 are out-of-coverage of basestation gNB B and its area of coverage, area B.

In area B, the basestation gNB B provides coverage to two devices, UE B1 and UE B2. The other two devices in area B, UE A3 and UE A4, are out-of-coverage of basestation gNB A and its area of coverage, area A.

In area C, which includes both area A and area B, coverage is provided by a satellite equipped with a reconfigurable intelligent surface, RIS. The RIS may act as a relay and allows devices in area A to be connected to devices in area B and/or vice versa. In this sense, the RIS is relaying signals between the two areas. These areas can be non-overlapping, partially-overlapping or fully-overlapping.

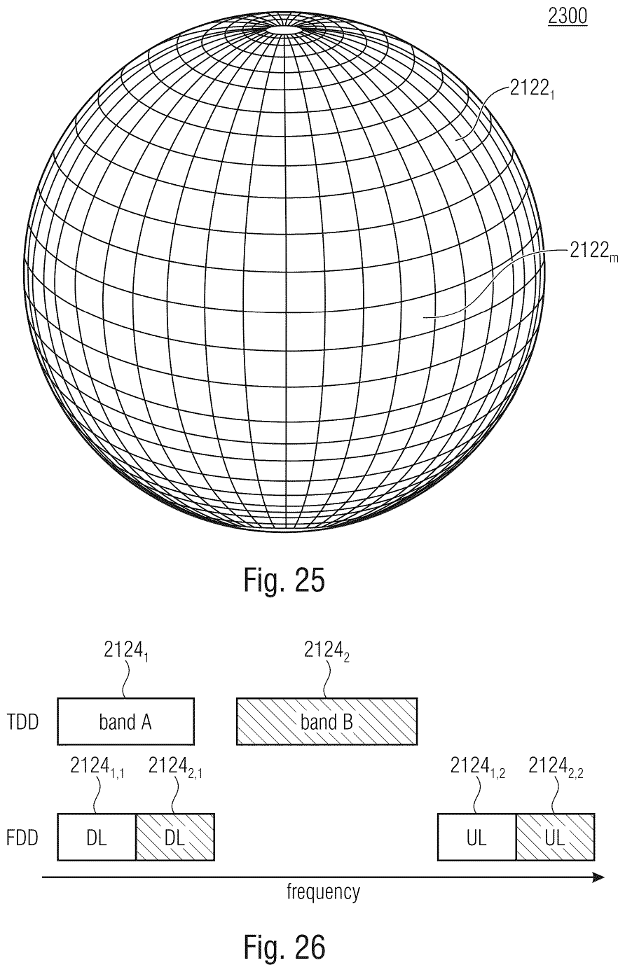

With reference to FIG. 1, the following may be noted:
gNB X serves local UEs in an area X because they are in-coverage, IC, of gNB X AND services remote UEs in an area Y using a reflector or RIS as a relay because the UEs are out-of-coverage, OOC of gNB X;
gNBs may provide different system information for local and remote UEs;
in uplink, local and remote UEs should use timing advances, TAs, with group TA-offset;
area A and B can be non-overlapping, partially-overlapping, or fully-overlapping; and
a multi-faceted RIS may allow for multi-point to multi-point connectivity, see FIG. 25.

In connection with such embodiments, a RIS may be mounted to a flying device such as a satellite. Embodiments of the third aspect further relate to determining that a device to be reached is local or remote and that, based thereon, adjustment of the communication is possible, e.g., by changing the TA and/or a direction of transmitting/receiving signals. For example, an adjustment of the timing advance may ensure communication. Further, embodiments based on the consideration that a satellite and/or a RIS may allow for an accidental provision of communication and embodiments allow to make use of this. Alternatively or in addition, a device such as a basestation may request a relay or a RIS for a certain operation. The satellite may operate accordingly, e.g., receiving a signal from the basestation and decoding it or being instructed by a relay station. For example, this may relate to illuminating a specific area or accepting signals from a specific area. Alternatively or in addition, a flying device such as a UAV may be instructed to fly a specific route or along specific wave points. The UAV may broadcast way points and/or a route to establish communication and to allow devices to make use of it. This is based on devices knowing the schedule of the flying device.

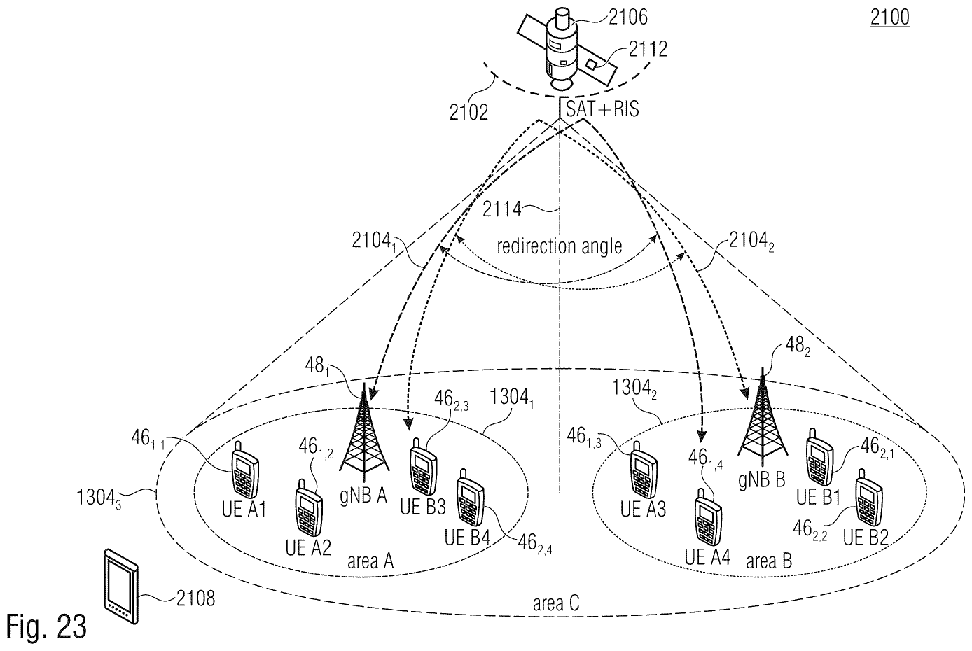

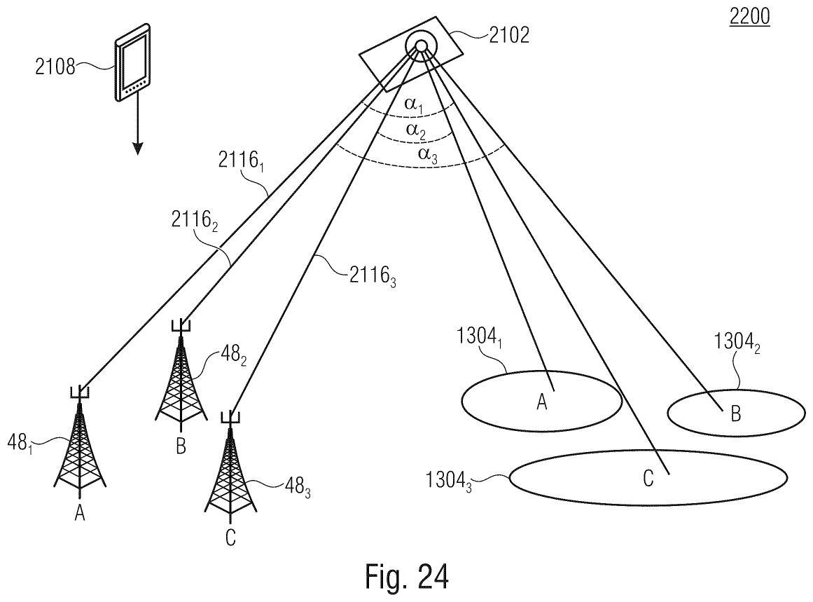

FIG. 24 shows a schematic block diagram of a wireless communication network 2200 to which a similar configuration applies when compared to the wireless communication network 2100 except for comprising at least a third basestation 48₃ that may reach area 1304₃ via reflection at the reflector device 2102. Further, basestations 48₁ and 48₂ may transmit two and/or receive from areas 1304₁, 1304₂ respectively signals that are reflected at the reflector device 2102. Preferably, areas 1304₁, 1304₂ and/or 1304₃ are related to an area essentially fixed or static on earth.

In other words, FIG. 24 shows the shared use of the reflector such as a RIS mounted, e.g., at a satellite, allowing several basestations, BSs to create a “reflected” coverage footprint on the surface on Earth. Due to variants/evolution of the distance from ground to satellite and a factor reflection angle at the RIS, the reflection parameters may be tracked and adapted continuously to allow for a quasi-static coverage footprint. Advantageously, the RIS provides for more than just a mirror-like RIS property. For example, a multi-faceted or a non-orthogonal RIS structure may be applied to compensate for a different angle A₁, A₂, and A₃ of incident and reflection for basestation 48₁ to area 1304₁, from basestation 48₂ to area 1304₂ and/or basestation 48₃ to area 1304₃ and the like.

FIG. 25 shows a schematic perspective view of a reflector unit 2300 according to an embodiment that may in parts or completely be used to implement reflector unit 2102. Reflector unit 2300 comprises a plurality of reflecting elements or facets, each facet adapted for a reflection of impinging wireless signals. It is possible but not necessary that an incoming or impinging wireless signal impinges on one of the facets 2122 only, wherein preferably the facets 2122 are inclined with respect to one another.

According to an embodiment, at least a subset of the multitude of facets 2122 comprises a reflection providing a directivity of 15 dB within a tolerance range, e.g., ±30%, ±20% or ±10%, e.g., relating to the input signal or the output, reflected signal.

A consideration thereof is that the two major components contributing to the pathloss from a gNB on Earth to a RIS in space are the free-space loss (FSPL) and the atmospheric loss (AL). A similar argument holds true for the pathloss from a RIS in space to a UE on Earth. Now since the FSPL is proportional to the square of the distance (between the device on Earth and the RIS in space), the total FSPL for the roundtrip (from Earth to space and back to Earth) would increase approximately 6 dB (the same frequency is used in both directions). Assuming that similar atmospheric conditions are encountered in both directions, the total AL will increase by approximately 3 dB. The RIS in space may therefore be required to be able to compensate for approximately 9 dB of loss due to the roundtrip plus the reflection loss of the RIS itself. Assuming that the latter is 20% efficient (thus creating a further system loss of 60 dB), the directivity of the RIS needs to be approximately 15 dB. At a KU-band frequency of 12 gHz, this may be provided by an antenna with an aperture of 1.571 mm², or a circle with a diameter of approximately 45 mm. According to an embodiment, a facet may, thus, comprise a reflective surface or an antenna structure.

Such a configuration allows for a device such as a basestation or a UE adapted for wirelessly transmitting a wireless signal that comprises a control unit configured for processing a schedule information, e.g., provided by a flying device or distributed by a device knowing about the travel route so that the control unit may process a schedule information related to a variable position of a reflector unit for reflecting wireless signals. The control unit may be configured for controlling the wireless interface to transmit the wireless signal based on the schedule information to cause a reflection of the wireless signal at the reflector unit. An illustrative example where the reflector is mounted to a flying device may be understood as a spatial component or path component being available at sometimes only and that it is not useful to transmit power along a direction where no reflector is, especially as a signal power towards space is considered to be high when compared to a terrestrial signal between a UE and a basestation. Thus, it may be of advantage that a UE as well as a basestation only transmit towards a reflector in the air or in space when knowing that the signal is going to be reflected or that it is likely to be reflected.

For example, the device may be configured for transmitting the wireless signal towards the reflector unit along a supplementary path supplementing a terrestrial path towards an intended receiver of the wireless signal. Alternatively or in addition, the device may be configured for transmitting the wireless signal towards the reflector unit along a substituting path substituting a terrestrial path towards an intended receiver of the wireless signal. That is, the temporarily available path segments towards the air or towards space may be used in addition or as a substitute for a terrestrial connection.

FIG. 26 shows a schematic illustration about a use of a frequency spectrum in a time division duplex, TDD, a frequency division duplex, FDD, respectively. For example, when referring again to FIGS. 23 and 24, area A may be associated with a frequency band A whilst area B may be associated with a frequency band B marked as 2124₁, 2124₂ respectively. As shown in FIG. 26, the frequency bands can be used for either TDD or FDD modes of operation to support downlink, DL and/or uplink, UL.

In other words, FIG. 26 is a pictorial representation of the spectral components associated with frequency bands A and B arranged in both an FDD and a TDD manner.

Further aspects of the present invention, e.g., in view of the first technical aspect relate to a relay device configured for relaying a wireless receive signal as a wireless transmit signal, wherein the relay device is configured for swapping between a Time Division Duplex, TDD, scheme and a Frequency Division Duplex, FDD, scheme when relaying the wireless receive signal.

According to an embodiment, such a relay device is configured for receiving the wireless receive signal as a signal according to the TDD scheme and for transmitting the wireless transmit signal according to the FDD scheme; or wherein the relay is configured for receiving the wireless receive signal as a signal according to the FDD scheme and for transmitting the wireless transmit signal according to the TDD scheme.

According to an embodiment, such a relay device is configured for relaying according to at least one of: an amplify and forward relaying; a digitize and forward relaying; and a store and forward relaying.

According to an embodiment, such a relay device is configured for aggregating a plurality of wireless receive signals into a set of at least one wireless transmit signal, the set comprising the wireless transmit signal.

Further aspects of the present invention, e.g., in view of the first technical aspect relate to a relay device, e.g., a device that may operate jointly with other devices] configured for relaying a plurality of wireless receive signals as at least one wireless transmit signal; wherein the relay device is configured for aggregating the plurality of wireless receive signals into the at least one wireless transmit signal.

According to an embodiment, such a relay device is adapted for a cell-free operation of a wireless communications network cell operated by a base station.

According to an embodiment, such a relay device is configured for swapping between a Time Division Duplex, TDD, scheme and a Frequency Division Duplex, FDD, scheme when relaying the wireless receive signal.

Features according to the second aspect that may form advantageous embodiments for the invention alone or in combination with the first aspect are formulated below:

### Features of the Second Aspect

Implementation 1. A transceiver configured for relaying a wireless receive signal in a first signal domain representation as a wireless transmit signal in a second signal domain representation;
wherein the transceiver is configured for mapping the receive signal from the first signal domain representation to the second signal domain representation of the transmit signal when relaying the wireless receive signal.

Implementation 2. The transceiver device of implementation 1, wherein the transceiver is a relay device.

Implementation 3. The transceiver of implementation 1 or 2, wherein the first signal domain representation and the second signal domain representation differ from each other in view of at least two of the following:
a time domain such as delay, repetition, store and forward;
a delay domain such as cyclic delay diversity, delay precoding in OTFS;
a frequency domain such as frequency translation;
a Doppler domain such as Doppler precoding in OTFS;
a power domain such as amplification through repeaters;
an energy domain such as distribution of signal power over time and frequency;
a code domain such as different spreading and scrambling sequences, fountain codes code rates;
an orbital angular momentum domain;
a spatial domain such as patterns, beam formers, sectors, directions;
a coverage domain such as indoors, outdoors; and
a polarisation domain such as linear to linear, linear to circular, circular to linear.

Implementation 4. The transceiver of one of previous implementations, configured for providing communication between a first device and a second device.

Implementation 5. The transceiver of implementation 4, configured for providing the communication by the relaying in at least an uplink direction or a downlink direction between the first device, the second device and the transceiver.

Implementation 6. The transceiver of any of the previous implementations, wherein the transceiver is configured performing, by the relaying, a mapping between a first duplex scheme of a first link between a first device and the transceiver and a second duplex scheme of a second link between at least one second device and the transceiver.

Implementation 7. The transceiver of any one of the previous implementations, configured for mapping between a Time Division Duplex, TDD, scheme of a time domain and a Frequency Division Duplex, FDD, scheme of a frequency domain when relaying the wireless receive signal.

Implementation 8. The transceiver of implementation 7, wherein the transceiver is configured for receiving the wireless receive signal as a signal according to the TDD scheme and for transmitting the wireless transmit signal according to the FDD scheme; or
wherein the transceiver is configured for receiving the wireless receive signal as a signal according to the FDD scheme and for transmitting the wireless transmit signal according to the TDD scheme.

Implementation 9. The transceiver of implementation 7 or 8, wherein the transceiver is configured for adapting a ratio between a first amount of wireless transmit signals transmitted based on a second amount of wireless receive signals.

Implementation 10. The transceiver of one of implementations 7 to 9, wherein the transceiver is configured for providing a predefined, e.g., maximum, bandwidth for transmitting the wireless transmit signals and for using available further slots of the TDD scheme for a transmission redundancy associated with the wireless transmit signal.

Implementation 11. The transceiver of one of implementations 7 to 10, wherein the transceiver is configured for using a receive, RX, timeslot of the TDD scheme for a transmission of a TX timeslot of the TDD scheme or for transmitting redundancy information for the wireless transmit signal.

Implementation 12. The transceiver of the previous implementations, configured for wirelessly receiving a configuration signal indicating configuration parameters for the transceiver relating to at least the mapping; wherein the transceiver is configured for operating accordingly.

Implementation 13. The transceiver of implementation 12, wherein the configuration signal comprises information indicating at least one of:
available resources on UE-relay link and relay-satellite link
UE-relay association
a relay-satellite association
a relay-UAV association
a relay-satellite network association
a relay-UAV network association
an operational/coverage/connectivity area
an opportunity/availability for communication of the link
an operational parameter such as one or more of a list of frequency bands, allowed transmission powers, MIMO Modes
a synchronization source such as GPS, local sync source, further relay with master clock; and
a relay software version or availability such as an update over the air

Implementation 14. The transceiver of the previous implementations, configured for mapping between a Time Division Duplex, TDD, scheme of a time domain and a Space Division Duplex, SDD, of a spatial domain when relaying the wireless receive signal.

Implementation 15. The transceiver of the previous implementations, configured for mapping between a Frequency Division Duplex, FDD, scheme of a frequency domain and a Space Division Duplex, SDD, of a spatial domain when relaying the wireless receive signal.

Implementation 16. The transceiver of implementation 15, wherein the transceiver is configured for receiving the wireless receive signal as a signal according to the SDD scheme and for transmitting the wireless transmit signal according to the FDD scheme.

Implementation 17. The transceiver of one of previous implementations, wherein the receive signal comprises payload data; wherein the transceiver is adapted to relaying only a selected part of the payload data.

Implementation 18. The transceiver of implementation 17, wherein the selected part is
a part of the payload
the complete payload
an incremental replica of at least a part of the payload
multiple redundant copies including full and partial redundancy.
Combinations of the above

Implementation 19. The transceiver of one of previous implementations, wherein the receive signal comprises payload data; wherein the transceiver is adapted to relaying a derivate of at least a part of the payload data.

Implementation 20. The transceiver of implementation 19, wherein the derivate comprises an encoded version of the payload, an incremental replica of at least a part of the payload and/or a copy of at least a part of the payload.

Implementation 21. The transceiver of one of implementations 17 to 20, wherein the transceiver is adapted to select the selected part based on a transmission criterion.

Implementation 22. The transceiver of one of implementations 17 to 21, wherein the transceiver is adapted to jointly operate with at least one further relay in a synchronized manner; wherein the at least one further relay forwards at least a part of a remaining part of the payload data.

Implementation 23. The transceiver of implementation 22, wherein the synchronized manner is a tight synchronisation or a loose synchronisation.

Implementation 24. The transceiver of one of implementations 17 to 23, wherein the transceiver is configured for receiving a selection information, e.g., from a base station or from a device transmitting the receive signal, and for selecting the selected part based on the selection information.

Implementation 25. The transceiver of one of previous implementations, wherein the transceiver is configured for relaying according to at least one of: an amplify and forward relaying; a digitize and forward relaying; and a store and forward relaying.

Implementation 26. The transceiver of one of previous implementations, being configured for relaying between a terrestrial and a non-terrestrial communication link.

Implementation 27.The transceiver of one of previous implementations having a relaying capability to relay signals; wherein the transceiver is configured to transmit a capability information related to the relaying capability.

Implementation 28. The transceiver of implementation 27, wherein the transceiver is configured to include, into the capability information, at least one of:
a number of antennas and/or a type of at least one antenna;
a supported transmit power;
a supported number of frequency bands and associated bandwidths and/or a subcarrier spacing;
a supported number of MIMO layers on at least one communication side, e.g., a UE side;
an electrical parameter of the transceiver such as a battery status;
a synchronization information indicating a synchronization state of the transceiver;
an available resources for receiving the receive signal and/or for transmitting the transmit signal, e.g., terrestrial and/or satellite;
a mobility property, speed and/or position;
a temporal availability of the transceiver;
a signal quality of at least one link on which the transceiver transmits or receives a signal;
an owner/provider/operator of the transceiver;
a relaying group, e.g., a part of which the transceiver is;
a supported processing time; and
a battery state or power indicator such as a remaining battery lifetime, battery charging information.

Implementation 29. The transceiver according to one of previous implementations, configured for establishing a Uu connection with a user equipment of the wireless communication network and for transmitting the wireless transmit signal to user equipment or receiving the wireless receive signal from the user equipment.

Implementation 30. The transceiver according to implementation 29, wherein the Uu connection is a first Uu connection, the transceiver being configured for establishing a second Uu connection with a further device such as a base station, a relay device or a user equipment, wherein the transceiver is configured for receiving the wireless receive signal and transmitting the wireless transmit signal using the first and the second Uu connection.

Implementation 31. The transceiver according to one of previous implementations, configured for receiving the wireless receive signal using a first PC5 connection established with a first device and for transmitting the wireless transmit signal using a second PC5 connection established with a second device.

Implementation 32. The transceiver according to implementation 31, wherein the first device is a relay device or a user equipment; and wherein the second device is a relay device or a user equipment.

Implementation 33. The transceiver according to one of previous implementations, wherein in a first operating mode the transceiver is configured for simultaneously relaying signals in uplink and downlink.

Implementation 34. The transceiver according to one of previous implementations, wherein in a second operating mode the transceiver is configured for simultaneously relaying signals only in one of uplink and downlink, e.g., as a part of a multi-TRP configuration.

Implementation 35. The transceiver according to one of previous implementations, configured for receiving, e.g., from a base station, information indicating a configuration of resources of a sidelink; and from broadcasting, groupcasting or unicasting a resource pool configuration based on the information indicating a configuration of resources of a sidelink.

Implementation 36. The transceiver according to one of previous implementations, configured for monitoring a link property such as capacity, load, throughput of a first link used for receiving the wireless receive signal or of a second link used for transmitting the wireless transmit signal and for providing a report indicating the property.

Implementation 37. The transceiver according to one of previous implementations, configured for receiving the wireless receive signal from a first wireless communication network and to transmit the wireless transmit signal to a different second wireless communication network;

Implementation 38. The transceiver according to implementation 37, wherein the transceiver implements a bridge between the first and second wireless communication network.

Implementation 39. The transceiver according to one of previous implementations, configured for receiving at least one of:
a relay wake up message;
a go-to-sleep message;
a paging message; and
a configuration message; and
for operating accordingly.

Implementation 40. The transceiver according to one of previous implementations, configured for transmitting at least one of:
a relay wake up message;
a go-to-sleep message;
a paging message; and
a configuration message.

Implementation 41. The transceiver according to one of previous implementations, being a user equipment, UE, for operating in a wireless communication network and for at least temporarily operating as a relay device.

Implementation 42. The transceiver according to one of previous implementations, configured for using at least one of:
a non-3GPP connection, e.g., using Bluetooth, WiFi or LiFi, and
a 3GPP connection.
   for receiving the wireless receive signal and/or for transmitting the wireless transmit signal.

Implementation 43. The transceiver according to one of previous implementations, wherein the transceiver is configured for providing at least a part of an access and mobility management function, AMF, and/or a location management function, LMF, for at least one device, e.g., in case of a missing backhaul link.

Implementation 44. A device configured for utilizing a wireless communication link that comprises a transceiver for relaying a wireless signal towards or from the device, wherein the device is configured for providing a selection information indicating a part of a payload data to be forwarded by the transceiver; and/or wherein the device is configured for receiving a plurality of relayed signals from a corresponding plurality of transceiver s; the plurality of payload data being associated with a same signal source that has transmitted the plurality of payload data with a same signal.

Implementation 45. A wireless communication network comprising:
at least one transceiver according to one of implementations 1 to 43; and
a first and second device using the transceiver for relaying a signal between the first device and the second device;
wherein the wireless communication network is adapted for at least one of:
a discovery process for discovering the transceiver;
an attachment/detachment process of a transceiver to a link operated by at least one of the first and second device;
an initialisation of a relaying operation of the transceiver;
a change of configuration of the transceiver;
an update procedure for updating the transceiver.

Implementation 46. The wireless communication network of implementation 45, wherein the transceiver is one of a plurality of transceiver s; wherein the wireless communication network is to coordinate the plurality of transceiver s for a joint operation for relaying signals to or from a common device.

Implementation 47. The wireless communication network of implementation 46, wherein the joint operation relates to controlling the plurality of transceiver s to only forward a part of the receive signal; wherein the plurality of transceiver s forwards a complete payload of the receive signal.

Implementation 48. The wireless communication network according to one of implementations 45 to 47, configured for operating a plurality of transceivers according to one of claims 1 to 43 in a multi transmission-reception-point, TRP, configuration for jointly receiving a message from a device or for jointly transmitting a message as part of the relaying.

Implementation 49. The wireless communication network according to one of implementations 45 to 48, adapted to evaluate a report indicating a property such as capacity, load, throughput, of a link providing a path segment for relaying a message of the wireless receive signal and for selecting a route of the receive signal through the wireless communication network based on the report, e.g., in a centralised, decentralised, partially autonomous or autonomous manner.

Implementation 50. A base station configured for operating a link with a transceiver according to one of implementations 1 to 43.

Implementation 51. A device such as a user equipment, configured for operating a link with a transceiver according to one of implementations 1 to 43.

Implementation 52. The device according to implementation 51, configured for recognising the transceiver based on at least one of information indicating a configuration of resources of a sidelink or a resource pool configuration.

Implementation 53 The device according to implementation 51 or 52, configured for selecting a path segment to be used for signal relaying as a path segment provided by the transceiver and based on a report indicating a property such as capacity, load, throughput, of a link providing the path segment.

Implementation 54. The device according to one of implementations 51 to 53, configured for establishing a Uu connection with the transceiver.

Implementation 55. The device according to one of implementations 51 to 54, being provided with service by a first mobile network operator, MNO, wherein the transceiver is provided with service by a second mobile network operator, MNO.

Implementation 56. A wireless communication system comprising:
a base station according to implementation 50;
a device according to one of implementations 51 to 55; and
a transceiver according to one of implementations 1 to 43 configured for relaying a signal between the base station and the device.

Implementation 57. A method for operating a transceiver for relaying a wireless receive signal in a first signal domain representation as a wireless transmit signal in a second signal domain representation, the method comprising:
controlling the transceiver for mapping the receive signal from the first signal domain representation to the second signal domain of the transmit signal when relaying the wireless receive signal.

Implementation 58. A method for operating a device for utilizing a wireless communication link that comprises a transceiver for relaying a wireless signal towards or from the device, the method comprising:
providing a selection information indicating a part of a payload data to be forwarded by the transceiver; and/or
receiving a plurality of relayed signals from a corresponding plurality of transceiver s; the plurality of payload data being associated with a same signal source that has transmitted the plurality of payload data with a same signal.

Implementation 59. A method for operating a wireless communication network, the method comprising:
operating at least one transceiver that is in accordance with one of implementations 1 to 43; and
operating a first and second device to use the transceiver for relaying a signal between the first device and the second device;
such that the wireless implements at least one of:
a discovery process for discovering the transceiver;
an attachment/detachment process of a transceiver to a link operated by at least one of the first and second device;
an initialisation of a relaying operation of the transceiver;
a change of configuration of the transceiver;
an update procedure for updating the transceiver.

Implementation 60. A method for operating a base station, the method comprising:
operating a link with a transceiver according to one of implementations 1 to 43.

Implementation 61. A method for operating a device such as a user equipment, the method comprising:
operating a link with a transceiver according to one of implementations 1 to 43.

Implementation 62. A method for operating a wireless communication system, the method comprising:
operating a base station in accordance with according to implementation 50;
operating a device in accordance with one of implementations 51 to 55; and
operating a transceiver for relaying a signal between the base station and the device.

Implementation 63. A computer readable digital storage medium having stored thereupon a computer program having a program code for performing, when running on a computer, a method according to one of implementations 57 to 62.

Embodiments of the present invention relate to mechanisms that allow to determine and selecting a path or route through a relay-based network. Such a relay based network may provide for a path in the network in which at least one hop between a transmitting node or source node and a receiving node or sink node is provided by a relay described herein. Whilst such an extension of coverage or forwarding may be a straight forward solution when only having, e.g., one possible path between the transmitting node and the receiving node, see, e.g., FIG. 9b of Aspect 1, the determination of one or more paths between the source and the sink may be more specific and of more benefit in a network providing a higher number of relays, e.g., in a mesh-like environment as described, for example, in connection with FIG. 10c, FIG. 10d or FIG. 12a-c of Aspect 1. Another example of route selection may relate to a decision whether to use an additional path between the source and the sink or not. When referring, for example, to FIG. 9g or FIG. 9h of Aspect 1, a decision whether to a) use only the direct link, a) only the relay-based link or a combination of both may provide for a high flexibility in message forwarding in the network.

Another aspect relating to path selection may refer to relaying different parts of the signal along different paths or segments in the network as described in Aspect 2 of the embodiments. For example, a relay may be aware, e.g., based on own measurements and/or decisions and/or based on a received control signal about splitting a payload of a single or a group of signals and to transmit the different parts along different paths. An example of such a criterion is given in Aspect 2 when referring to the delay label in FIG. 16a-18b of Aspect 2 where, for example, some parts of the payload require a faster transmission when compared to other parts such that a central entity of the network, a local controller, e.g., a base station and/or the relay device decides to transmit the more urgent part along a path capable of meeting the requirements, e.g., providing higher throughput, less hops and thus latency or the like. As a further example, the relay may transmit a payload that requires reliable transmission along one or more paths that lead to the sink and are associated with reliability parameters such as low bit error rate, high SNR and the like.

As a consequence, embodiments of the present invention are based on the finding that it is of benefit for the relay based network to be aware about paths and path segments in the network. Such parameters are not limited or restricted to an awareness about a presence of a path but may also relate to having knowledge at a deciding entity about the configurability of nodes along the path, e.g., a possible, an allowed or an available (e.g., during certain instances in time, as a granted access to an overall capacity of the link and the like) operation mode of a relay as well as possibilities to adjust such an operation mode as described in connection with Aspect 1. That is, embodiments are not limited to select a path but may also incorporate to identify a path that is adjustable according to local (e.g., between a single source and a single sink), regional (some neighboured sources and/or sinks) or global needs or optimisation criteria and to adjust a path accordingly, e.g., by activating and/or adjusting an operation mode of a relay device and/or activating and controlling at least one active reflector such as reconfigurable intelligent surfaces, RIS. In a wireless communication network, a RIS reflection may be considered a passive reflector, since it is not altering the signal, e.g., as it does not provide for amplification, subtraction or addition of signal components. However, according to an embodiment it is recognized that the controllability of the RIS may be of importance in the sense of controlling paths and or path segments, i.e., the segment or overall path may be established or altered by use of a RIS.

In view of this, a RIS may be considered, at least in parts as a relay or even a configurable relay. For example, a RIS device can function as a relay device in the sense of a connective device able to interconnect path segments and/or in view of its ability to change reflection directions in a controllable fashion along a RIS device to route/forward a signal to device A or to device B. Such devices A and/or B may be UEs, gNBs, further relays or combinations thereof.

Knowledge about the paths may be obtained, for example, by recognising a relay as described in connection with FIG. 11a-c of Aspect 1 or other measurement and reporting processes that allow to store information about relaying or reflecting devices and their capabilities or availabilities for providing a basis of decision about the at least one path to be selected. This includes an establishment of static paths or path segments as well as a generation of dynamic paths or path segments. As an alternative or in addition to recognising a relay as a device, embodiments also relate to recognizing the controllability and/or configurability of at least one path segment even without recognizing the “routing element” itself, i.e., to recognise the option or capability to establish a specific path segment. This is in particular true if such routing element is a RIS, which can allow to change inter-node connections being path segments and therefore can influence the path topology. The knowledge about such further connectivity options between nodes along an existing route/path or an alternative route/path may be used by the control unit and/or a relay device in the overall path selection process and/or overall or local path-segment selection process at the decision entity.

That is, the integral or distributed control unit may know or be aware that a path may be operated and usable or that it may be established by controlling one or more devices accordingly.

The selection of the at least one path from the available paths and/or from paths that may be established by controlling at least one device (relay, RIS, . . . ) accordingly may be a matter of selection at the source or at a node along the path comprising multiple hops, e.g., by controlling the devices accordingly. According to an embodiment, a relay may, as an alternative or in addition make a decision about a remaining path towards the sink, i.e., it may decide to deviate from the initial or intended overall path. Such a competence may be based on one or more criteria, e.g., an overload of at least one path segment of the remaining path, a link failure in at least one path segment of the remaining path, and/or a priority overrule of other signals along that are transmitted or scheduled to be transmitted along at least one path segment of the remaining path as well as a recognition that a different path segment is more suitable or promising in view of an overall strategy such as reliability, overall throughput, latency and the like. Such a situation may allow the relay device to deviate from the controlled path and to select one or multiple different paths or segments thereof.

According to an embodiment, there may be an end point of a path, e.g., a source or sink that may have alternatives in their first hop. A control unit in such a network may be configured to provide this information to at least one of these end points as well.

That is, the control scheme may control the selected entry, e.g., a single entity or the section between source and sink into two path options while the two path options are configured already, therefore no relay on the way has to be provided with specific routing information/configuration. As an alternative, a relay may be allowed to deviate form such configuration, e.g., based on own decisions or preconfigured options or measurements.

That is, the relay device may modify the controlled path.

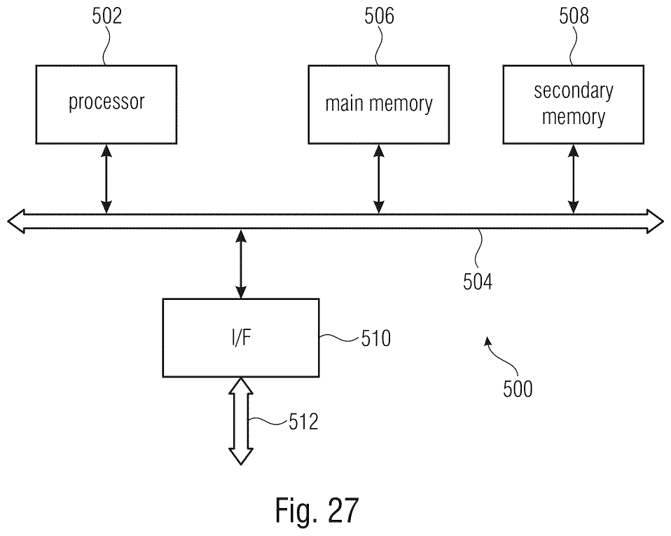

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 27 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

| | | Further |
|---|---|---|
| Abbreviation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| | strength | |
| CP | control plane | |
| CP1 | control plane 1 | |
| CP2 | control plane 2 | |
| CPRI | common public radio interface | |
| CSI | channel state information | |
| CSI-IM | CSI interference measurement | |
| CSI-RS | CSI reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIB | message information block | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| | | plane and control |
| | | plane protocol |
| | | terminations |
| | | towards the UE, |
| | | and connected |
| | | via the NG |
| | | interface to the |
| | | 5GC |
| NG-RAN | either a gNB or an NG-eNB | |
| NGSO | non-geostationary orbit | |
| NIC | network interface connection | |
| NR | new radio | |
| NR-U | NR unlicensed | NR operating in |
| | | unlicensed |
| | | frequency |
| | | spectrum |
| NTN | non-terrestrial network | |
| NZP-CSI-RS | non-zero-power CSI-RS | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PDCCH | physical downlink control channel | |
| PDSCH | physical downlink shared channel | |
| PER | packet error rate | |
| PHY | physical | |
| PLMN | public land mobile network | |
| PRACH | physical random access channel | |
| PUCCH | physical uplink control channel | |
| PUSCH | physical uplink shared channel | |
| PSBCH | physical sidelink broadcast channel | |
| PSCCH | physical sidelink control channel | |
| PSSCH | physical sidelink shared channel | |
| PSFCH | physical sidelink feedback channel | |
| QCL | quasi colocation | |
| RA | random access | |
| RACH | random access channel | |
| RAN | radio access network | |
| RAT | radio access technology | |
| RF | radio frequency | |
| RIM | radio access network information | |
| | management | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | srs resource indicator | |
| SS | synchronization signal | |
| SSB | synchronization signal block | |
| SSID | service set identifier | |
| SS-PBCH | sounding signal/physical broadcast | |
| | channel | |
| TAC | tracking area code | |
| TB | transmission block | |
| TCI | transmission configuration indication | |
| TDD | time division duplex | |
| TN | terrestrial network | |
| TRD | transmit/receive device | |
| TRP | transmission reference point/ | |
| | transmission reception point | |
| TSG | technical specification group | |
| UAV | uncrewed airborne vehicle | |
| UE | user equipment | |
| UL | uplink | |
| UP | user plane | |
| URLLC | ultra-reliable low latency | |
| | communication | |
| UTRAN | universal trunked radio access network | |
| Uu | UU interface/access link | |
| V2X | vehicle-to-everything | |
| VolP | voice over internet protocol | |
| vRAN | virtual ran | |
| WI | work item | |
| WLAN | wireless local area network | |
| ZP-CSI-RS | zero-power CSI-RS | |

### REFERENCES

[1] L. You, K. X. Li, J. Wang, X. Gao, X. G. Xia and B. Otterstenx, “LEO Satellite Communications with Massive MIMO,” ICC 2020-2020 IEEE International Conference on Communications (ICC), Dublin, Ireland, 2020, pp. 1-6, doi: 10.1109/ICC40277.2020.9149121]
[2] Distributed Massive MIMO for LEO Satellite Networks, arXiv:2211.00832 https://arxiv.org/abs/2211.00832
[3] Capacity Analysis and Optimization of Satellite MIMO System” written by Haijin Li, Jianbo Li, Yuxin Cheng, Jianjun Wu, published by International Journal of Communications, Network and System Sciences, Vol. 10 No. 5B, 2017 https://www.scirp.org/journal/paperinformation.aspx?paperid=76553
[4] Robust Downlink Transmission for 6G LEO-MIMO Systems Satellite https://www.hindawi.com/journals/wcmc/2022/6235241/[5] A Hybrid Beamforming Design for Massive MIMO LEO Satellite Communications https://doi.org/10.3389/frspt.2021.696464
[6] Z. Katona, “GEO data relay for low earth orbit satellites,” 2012 6th Advanced Satellite Multimedia Systems Conference (ASMS) and 12th Signal Processing for Space Communications Workshop (SPSC), Vigo, Spain, 2012, pp. 81-88, doi: 10.1109/ASMS-SPSC.2012.6333111 https://ieeexplore.ieee.org/document/6333111
[7] Optical High-Capacity Satellite Downlinks via High-Altitude Platform Relays https://elib.dlr.de/53611/1/2007_Paper_HAPs_Relais_for_FSO_Copyright.pdf
[8] Integrating LEO Satellite and UAV Relaying via Reinforcement Learning for Non-Terrestrial Networks, https://arxiv: 2005.12521v1

1. A control unit configured for controlling a transmitter device comprising a wireless interface to transmit a wireless signal with the wireless interface and towards a relay device to relay the wireless signal along a path of the wireless signal;
wherein the relay device is a part of a non-stationary/moving device.

2. The control unit of claim 1, being configured to receive/accept information about an availability of the relay device along at least a path segment of the path.

3. The control unit of claim 1, being configured for determining that a location of a reception device for receiving the wireless signal is out of coverage of the transmitter device; wherein the control unit is adapted to determine the path to reach the reception device via the relay device.

4. The control unit of one of claim 1, being configured for providing, e.g., to the relay device, the transmitter device or a receiver of the wireless signal, information related to an adjustment of a timing advance, TA.

5. The control unit of claim 4, adapted to adjust the TA from a terrestrial TA to a non-terrestrial TA based on knowledge that the path comprises a non-terrestrial node.

6. The control unit of one of claim 1, being configured for determining, e.g., based on Line of sight, LOS, signals, signal reflections or a flight schedule, an availability of the path based on a direct LOS or a reflection and to inform the relay device and/or the transmitter device about the availability of the path.

7. The control unit of claim 1, wherein the path is related to one of:
a U2U path, where the relay device relays between a first UE and a second UE,
a U2N path, where the relay device relays between a UE and a network node,
a relay path, where the relay device relays between a UE and a relay device,
a relay path, where the relay device relays between a first relay device and a second relay device, and
a relay path, where the relay device relays between a relay device and a network node.

8. The control unit according to claim 1, configured for instructing the transmitter to use a PC5 for transmitting the wireless signal towards the relay device, e.g., to allow the relay device for transmitting a wireless transmit signal using a Uu connection established with a second device.

9. The control unit of claim 1, adapted for controlling the transmitter device based on a predicted location of the relay device.

10. The control unit of claim 9, wherein the prediction relates to a predicted location of the relay device in some seconds.

12. A control unit configured for determining at least a segment of an available, e.g., operated or configurable, path in a wireless communication network and for providing information along the path segment about relaying a wireless receive signal received by the relay device as a wireless transmit signal along the path segment.

13. The control unit of claim 12, wherein the control unit is adapted to provide, information, e.g., to another control unit or to the relay device, information about a requested operation mode of the relay device when relaying the wireless receive signal.

14. The control unit of claim 12, configured for controlling the at least one relay device along the path segment according to the determined path segment.

15. The control unit of claim 12, being configured for providing information about controlling an active relay device or a passive reflector along the path segment for relaying the wireless receive signal.

16. The control unit of claim 12, being configured for providing information about an availability of an active relay device or a passive reflector along the path segment for relaying the wireless receive signal.

17. The control unit of claim 12, wherein the active relay device or the passive reflector is a part of a non-stationary device.

18. The control unit of claim 12, being adapted for determining the path segment based on a capability of the path segment and/or a relay device operating in the path segment.

19. The control unit of claim 12, being configured for determining that a location of a reception device for receiving a relayed signal derived from the receive signal is out of coverage of a transmitter of the receive signal or an antecedent/derived signal thereof;
wherein the control unit is adapted to determine the path segment to reach the reception device via the relay device.

20. The control unit of claim 12, being configured for providing, e.g., to the relay device, a transmitter of the receive signal or a receiver of the transmit signal, information related to an adjustment of a timing advance, TA.

21. The control unit of claim 12, being configured for determining, e.g., based on signal reflections or a flight schedule, an availability of the path segment based on a reflection, e.g., caused by a reconfigurable intelligent surface, RIS, and to inform a node effecting the receive signal and/or the transmit signal about the availability of the path segment.

22. A device, e.g., a base station, comprising a control unit according to one of previous claims, wherein the device is configured for communicating with a first number of first devices being in coverage of the device; and with a second number of second devices being out of coverage of the device by using a relay device to relay a wireless signal between the device and at least one of the second number of second devices and the device.

23. The device of claim 22, wherein the device is configured for providing different system information to the first devices and the second devices.

24. A device, comprising:
a wireless interface for wirelessly transmitting a wireless signal;
a control unit, configured for processing a schedule information related to a variable position of a relay device for relaying wireless signals;
wherein the control unit is configured for controlling the wireless interface to transmit the wireless signal based on the schedule information to cause a relay of the wireless signal at the relay device.

25. The device of claim 24, wherein the device is configured for transmitting the wireless signal towards the relay device along a supplementary path supplementing a terrestrial path towards an intended receiver of the wireless signal; and/or
wherein the device is configured for transmitting the wireless signal towards the relay device along a substituting path substituting a terrestrial path towards an intended receiver of the wireless signal.

26. The device of claim 24, wherein the relay device is a part of a flying device
